(19) United States
(12) Patent Application Publication
(10) Pub. No.: US 2008/0044603 A1
(43) Pub. Date: Feb. 21, 2008

(54) PLASTIC MULTI-PIECE CONTAINERS AND METHODS AND SYSTEMS OF MAKING SAME

(76) Inventors: Gerald A. Hutchinson, Coto De Caza, CA (US); Heinrich Feichtinger, Hinteregg (CH); Clarence Sequeira, New Milford, CT (US); Said Farha, Pleasantville, NY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/757,249

(22) Filed: Jun. 1, 2007

Related U.S. Application Data
(60) Provisional application No. 60/809,974, filed on Jun. 1, 2006.
(60) Provisional application No. 60/892,515, filed on Mar. 1, 2007.

(51) Int. Cl. B32B 3/30

(52) U.S. Cl. 428/35.7; 264/325; 425/404

(57) ABSTRACT

Plastic multi-piece containers for storing beverages and other foodstuff are disclosed. In addition, methods, devices and systems for making some or all components of such containers are disclosed. In some embodiments, the cup portion is manufactured using vacuum and/or pressure thermoforming methods. However, a cup portion of the container can be manufactured by any other suitable process, including, but not limited to, other forms of thermoforming, extrusion, compression molding, injection molding, blow molding and/or combinations thereof. The formed product can include one or more coupling structures for attachment of a closure member. A closure member can engage and/or couple to the cup portion to provide a water-tight and/or air-tight two-piece or multi-piece container. In some embodiments, a removable sealing member can be provided between the cup portion and a closure member.

### PRIORITY APPLICATION INFORMATION

This application claims priority under 35 U.S.C. §119(e) to U.S. Provisional Application No. 60/809,974 filed Jun. 1, 2006 and U.S. Provisional Application No. 60/892,515 filed Mar. 1, 2007, the disclosures of which are hereby incorporated by reference in their entireties.

### BACKGROUND OF THE INVENTION

1. Field of the Invention

This application is directed toward devices for containing liquid beverages, liquid foods, liquid food beverages and other foodstuffs, and systems, devices and methods of manufacturing and assembling same.

2. Description of the Related Art

Cups and other containers adapted to contain liquids, such as foods and beverages and the like, are well known. Beverage containers comprising mostly plastic are well known. Suitable plastic cups and cans include wall structures having sufficient strength and rigidity to maintain a desired shape. In several known methods of making cans from plastic materials, a tube or profile is formed, such as by extrusion. For example, the plastic material may be continuously extruded in the form of a tube which is cut into pieces of suitable length, and then capped at the top and bottom such as by fusion bonding to form a can. In cans which have two or more layers of plastic, the layers may be coextruded. In addition, the material forming the container or, at least the material of the inner surface of the container which is in contact with the food or beverage, preferably has the approval of the United States Food and Drug Administration (FDA) to be in contact with foods and/or beverages.

### SUMMARY OF THE INVENTION

This application is directed toward devices for containing liquid beverages, liquid foods, liquid food beverages and other foodstuff, and system and methods of manufacturing and assembling same. In some embodiments, the cup portion is manufactured using vacuum and/or pressure thermoforming methods. In other embodiments, the cup portion can be manufactured by any other suitable process, including, but not limited to, other forms of thermoforming, extrusion, compression molding, injection molding, blow molding, extrusion blow molding (EBM), stretch blow molding (SBM), injection stretch blow molding (ISBM) and/or combinations thereof. The formed product may include one or more coupling structures for attachment of a closure member. A closure member can be coupled to the cup portion to provide a water-tight and/or air-tight container. In some embodiments, a removable sealing member can be provided between the cup portion and a closure member.

Disclosed herein is a plastic container, as is suitable for containing beverages. In a preferred embodiment, the can includes two components, a cup and a cap or closure. In another embodiment it comprises three or more components: a deep-draw cup, preferably formed by thermoforming, extrusion or other suitable process, a closure that attaches to the open end and an easy open tab and/or more members. Much like conventional soda cans with a lid that is crimped on, in some embodiments a finish on the cup (e.g. flange, recess, protuberance) can be used to attach a lid with an easy open closure. The cup may comprise a single material, a blend, or be formed from a material having two or more layers.

In accordance with one embodiment, a container for storing a beverage or foodstuff comprises a cup portion and a closure portion. The cup portion includes a cup bottom, sidewalls having an upper portion ending at a top edge, the top edge defining an opening to an interior of the cup portion, and at least one coupling structure positioned along the upper portion of the sidewalls. The closure portion includes a lower closure portion configured to engage the coupling structure of the cup portion in order to secure the closure portion to the cup portion and an upper closure portion comprising at least one movable section. The movable section being configured to selectively expose and hide an aperture. In some embodiments, the cup portion comprises a thermoplastic or polymeric material. In some embodiments, the aperture provides access to the interior of the cup portion.

In some embodiments, a mold apparatus which is configured to thermoform a cup comprises a mold section having at least one mold surface. The mold surface defines a cavity and the mold section having one or more cavity fluid channels in fluid communication with the cavity. The mold apparatus further comprises a mandrel having a longitudinal axis and an exterior surface, the mandrel being configured to be moved at least partially within the cavity of the mold section along the longitudinal axis. The mandrel comprises an outer casing forming at least a portion of the exterior surface of the mandrel, the outer casing comprising at least one mandrel fluid channel and a groove, the groove being in fluid communication with the mandrel fluid channel and extending to the exterior surface of the mandrel, wherein the outer casing is configured to be selectively extended to a first distance within the cavity and a mandrel rod being positioned at least partially within the outer casing and being selectively movable relative to the outer casing in a direction generally parallel to the longitudinal axis, the mandrel rod being configured to be selectively extended to a second distance within the cavity, the second distance being greater than the first distance. In some embodiments, the mandrel rod is configured to urge a sheet positioned generally over the mold section at least partially into the cavity. Further, the the cavity fluid channel is configured to be selectively placed in fluid communication with a vacuum source. The groove is configured to be selectively placed in fluid communication with a vacuum source and a fluid supply source.

In some embodiments, a mold apparatus is configured to thermoform a sheet into a cup shape. The apparatus includes a mold section comprising at least one mold surface, the mold surface defining a cavity, the mold section comprising at least one cavity fluid channel in fluid communication with the cavity. The apparatus further comprises a mandrel having a longitudinal axis and an exterior surface, the mandrel being configured to move at least partially within the cavity of the mold section along the longitudinal axis, the mandrel comprising at least one mandrel fluid channel and a groove, the groove being in fluid communication with the mandrel fluid channel and extending to the exterior surface of the mandrel. In some embodiments, the mandrel comprises at least one depression extending inwardly away from the exterior surface of the mandrel, the depression being configured to produce a corresponding coupling structure on a thermoformed sheet. Further, the cavity fluid channel is configured to be selectively placed in fluid communication with a vacuum source, and the groove is configured to be selectively placed in fluid communication with a vacuum source and a fluid supply source.

In some embodiments, a method of thermoforming a sheet into a cup shape comprises providing a mold section having at least one mold cavity, the mold cavity comprising a mold surface, the mold section comprising a plurality of cavity fluid channels in fluid communication with the mold cavity. The method further comprises providing a mandrel having a longitudinal axis and an exterior surface, the mandrel being configured to be moved at least partially within the mold cavity in a direction generally parallel with the longitudinal axis. In some embodiments, the mandrel includes an outer casing forming at least a portion of the exterior surface of the mandrel, the outer casing comprising at least one mandrel fluid channel and a groove, the groove being in fluid communication with the mandrel fluid channel and extending to the exterior surface of the mandrel and a mandrel rod being positioned at least partially within the outer casing and being selectively movable relative to the outer casing in a direction generally parallel with the longitudinal axis. The methods further includes positioning a sheet configured to be thermoformed over the mold section, moving the mandrel rod toward the mold section to urge the sheet at least partially into the mold cavity, producing a vacuum in the cavity fluid channels to draw the sheet toward the mold surface, retracting the mandrel rod away from the mold section, moving the outer casing at least partially within the mold cavity, producing a vacuum in the groove of the outer casing to draw the thermoformed sheet at least partially toward the exterior surface of the mandrel and retracing the mandrel casing and the thermoformed sheet positioned thereon away from the mold section.

In some embodiments, a container for storing a beverage comprises a cup portion. The cup portion includes a cup bottom, a sidewall having an upper portion ending at a top edge, the top edge defining an opening to an interior of the cup portion and at least one coupling structure positioned along the upper portion of the sidewall. The cup portion comprises a polymeric material. The container further comprises a closure portion having a lower closure portion configured to engage the coupling structure of the cup portion in order to secure the closure portion to the cup portion and an upper closure portion comprising at least one movable section, the movable section configured to selectively expose and hide an aperture. In some embodiments, the aperture provides access to the interior of the cup portion.

In other embodiments, the container further comprises a removable seal member being positioned underneath the aperture. The seal member being a fluid barrier which prevents fluid communication between the aperture and the interior of the cup portion. In one embodiment, the seal member is a membrane configured to be compromised so that the aperture is in fluid communication with the interior of the cup portion. In another embodiment, the seal member is adhered to the top edge of the sidewalls.

In some embodiments, the cup portion is manufactured using a thermoforming process. In other embodiments, the cup portion comprises polyethylene terephthalate (PET), polypropylene and/or any other material. In still other embodiments, the cup portion comprises at least two layers. In some embodiments, the container is generally air-tight. In other embodiments, the cup portion comprises a generally cylindrical shape. In still other embodiments, the cup portion comprises a draft angle so that the cup portion comprises a generally frusto-conical shape.

In another embodiment, the coupling structure comprises a positive feature which projects outwardly from the sidewalls. In one embodiment, the coupling structure comprises a negative feature which projects inwardly from the sidewalls, toward the interior of the cup portion. In an alternative embodiment, the coupling structure is configured to selectively attach to and detach from the cup portion using a snap connection. In yet other embodiments, the coupling structure is fixedly attached to the cup portion.

In some embodiments, the lower closure portion and the upper closure portion are a unitary member. In other embodiments, the movable section is selected from a group consisting of caps, snap closures, removable film seals, lids and multi-piece closures. In still other embodiments, the closure member further comprises a cover, which is configured to be selectively positioned over the upper closure portion. In some embodiments, the cover is hingedly attached to the closure member.

In one embodiment, a container comprises a lower cup or can portion. The lower cup or can portion includes at least one coupling structure configured to attach the cup or can portion to a closure member. In addition, the container comprises a closure member configured to be secured to the cup or can portion. The closure member includes an opening through which a beverage or other material stored within the cavity of the can or cup portion can be accessed. In other embodiment, the container further comprises a sealing member configured to be placed between the closure member and at least a portion of the interior cavity of the container.

In some embodiments, a thermoforming apparatus includes a cavity mold section which comprises at least one fluid opening. In some embodiments, the fluid opening is in fluid communication with a fluid delivery or a vacuum source. The thermoforming apparatus further includes a mandrel portion configured to be received within the cavity mold section. In some embodiments the mandrel portion comprises an outer shell and an inner mandrel rod, the mandrel rod configured to selectively move a sheet into the cavity mold section. In some embodiments, the mandrel comprises at least one fluid opening. The fluid opening in the mandrel, in some embodiments, is in fluid communication with a fluid deliver or a vacuum source.

In some embodiments, at least one of the cavity section and the mandrel section comprises a high heat transfer material. In other embodiments, at least one of the cavity section and the mandrel section comprises one or more cooling channels configured to receive and convey a cryogenic or a non-cryogenic fluid therein. In other embodiments, the cavity mold section includes a positive or a negative feature which is configured to produce a corresponding coupling structure in a thermoformed cup or other product.

In some embodiments, a method of thermoforming a cup comprises positioning a polymeric sheet over a cavity mold section, lowering a mandrel rod of a mandrel portion towards the cavity of the cavity mold section such that the sheet is urged into the cavity of the cavity mold and creating a vacuum in one or more fluid channels of the cavity mold section so that that the sheet is urged towards a mold surface of the cavity mold section. In other embodiments, the method further comprises directing fluid from a fluid source through one or more fluid channels in the mandrel to pre-stretch the sheet prior to lowering the mandrel rod into the cavity of the cavity mold section.

In yet other embodiments, the method further comprises lowering a mandrel casing of the mandrel portion into the cavity of the cavity mold section and creating a vacuum along one or more fluid channels positioned along the exterior of the mandrel casing and removing the thermoformed item from the cavity by raising the mandrel portion out of the cavity. In other embodiments, the method further comprises removing the thermoformed product by lowering the mandrel rod and/or delivering a volume of air to the exterior channels of the mandrel casing. In some embodiments, at least one of the mandrel portion and the cavity mold section comprises a heat high transfer material or a hardened material. In other embodiments, at least one of the mandrel portion and the cavity mold section comprises one or more cooling channels.

One type of closure is that shown in the figures. The closure for this type of can may be large, having a diameter of preferably about 35-90 mm, including about 50-54 mm and seal over the flanged surface. Preferred closures serve dual purposes as a lid and a closure. The closure itself may include a spout. In one embodiment, the spout comprises a plastic, including a high-strength plastic such as HDPE and/or other plastics and materials as described elsewhere infra, and has a thin sealing member bonded to the spout on one side and the flanged section of the cup on the other side. In one embodiment, the thin sealing member includes an aluminum foil. In a preferred embodiment, the thin sealing member comprises more than one layer and includes one or more layers of plastic material, adhesive, paper, metal foils, or other materials. In one embodiment, the closure includes a pull tab or similar removable, moveable or displaceable portion to provide product integrity and easy dispensing once the tab or other structure is moved or pulled away. Alternatively, a low cost aluminum lid could be crimped on with a pull tab or a foil adhered onto an opening in the metal lid that can be removed to gain access to the contents.

The cup or can portion itself is preferably generally cylindrical or it may have a draft angle to the walls, preferably a small draft angle of less than about 5 degrees. The can may be made by any suitable process, including, but not limited to, extrusion, extrusion molding, extrusion blow molding, injection blow molding, and thermoforming. In certain preferred embodiments, thermoforming is used. In preferred thermoforming processes, the process may use a plug with vacuum assist to produce cans with a suitable material distribution. Thermoforming can produce cans at a very high production rate at a low cost. The containers could be formed, filled and packaged all in one location.

In one embodiment, a mold apparatus, which is configured to thermoform a plastic material, comprises a core and a cavity section. The cavity section defines an interior space and is configured to receive, at least partially, the core. The cavity section includes one or more interior channels which are in fluid communication with the interior space of the cavity section. In some embodiments, the core and/or the cavity section include a high heat transfer material.

In one embodiment a mold apparatus, which is configured to thermoform a plastic material, comprises a core having at least one interior channel and at least one opening at the core surface. The opening being in fluid communication with said channel, and the core comprising a high heat transfer material.

In another embodiment, a plastic mass or member, which is configured to be thermoformed into a bottle, comprises an upper cylindrical portion having a plurality of external threads and a neck flange and a lower cup-shaped portion having a volume of extruded plastic material. The cup-shaped portion includes a bottom wall. The volume of extruded plastic material may be thermoformed into a container. In yet another embodiment, a method of thermoforming a plastic item includes providing a plastic item between a core and a cavity section. The cavity section comprises a cavity and at least one interior channel in fluid communication with that cavity. The method further includes moving the core relative to the cavity section such that at least a portion of the plastic item is positioned between the core and the cavity section, removing a volume of fluid from the cavity through the channel and cooling at least a portion of the plastic item using a high heat transfer material.

### BRIEF DESCRIPTION OF THE DRAWINGS

These and other features, aspects and advantages of the various devices, systems and methods presented herein are described with reference to drawings of certain embodiments, which are intended to illustrate, but not to limit, such devices, systems and methods. The drawings include seventy-three (73) figures. It is to be understood that the attached drawings are for the purpose of illustrating concepts of the embodiments discussed herein and may not be to scale.

FIG. 1A illustrates a cross-sectional view of a multi-layer cup member having an outer layer with a coupling structure according to one embodiment;

FIG. 1B illustrates a cross-sectional of an embodiment of a container made form the cup member of FIG. 1A;

FIG. 1C illustrates an enlarged view of a portion of the container and closure of FIG. 1B taken along 1C;

FIG. 1D illustrates an enlarged view of a portion of the container and closure in accordance with another embodiment;

FIG. 1E illustrates an enlarged view of a portion of the container and closure in accordance with yet another embodiment;

FIG. 2A illustrates a cross-sectional view of a portion of cup having an upper portion without threads according to one embodiment;

FIG. 2B illustrates a cross-sectional view of a cup portion according to another embodiment;

FIG. 2C illustrates a cross-sectional view of a portion of a multi-piece cup according to one embodiment;

FIG. 3 illustrates a cross-sectional view of a cup in accordance with another embodiment;

FIG. 4 illustrates a cross-sectional view of a cup in accordance with another embodiment;

FIG. 5 illustrates an exploded view of one embodiment of a container comprising a cup portion, a closure portion and a seal;

FIG. 6 illustrates a top view of a seal according to one embodiment;

FIG. 7 illustrates a side partial cut away view of a cap according to one embodiment;

FIGS. 8A through 8E illustrate schematic views of time-sequential steps of a vacuum thermoforming process according to one embodiment;

FIGS. 9A through 9D illustrate schematic views of time-sequential steps of a vacuum thermoforming process comprising pre-stretching according to one embodiment;

FIGS. 10A through 10E illustrate schematic views of time-sequential steps of a vacuum thermoforming process according to another embodiment;

FIGS. 11A through 11E illustrate schematic views of time-sequential steps of a vacuum thermoforming process comprising pre-stretching according to another embodiment;

FIGS. 12A through 12E illustrate schematic views of time-sequential steps of a vacuum thermoforming process comprising a mandrel assist according to one embodiment;

FIG. 12F illustrates a detailed side view of a frontal portion of the mandrel illustrated in FIG. 12B;

FIGS. 13A through 13E illustrate schematic views of time-sequential steps of a vacuum thermoforming process comprising pre-stretching and a mandrel assist according to one embodiment;

FIGS. 14A through 14G illustrate side views of time-sequential steps of a vacuum thermoforming apparatus in operation according to one embodiment;

FIG. 15 illustrates a cavity section of a thermoforming apparatus according to one embodiment;

FIG. 16 illustrates a cavity section of a thermoforming apparatus according to another embodiment;

FIGS. 17A and 17B illustrate side views of a formed product being removed from a core or mandrel following thermoforming according to one embodiment;

FIGS. 18A through 18C illustrate side views illustrating time-sequential steps of a vacuum thermoforming apparatus in operation according to one embodiment;

FIG. 19 illustrates a side view of a vacuum thermoforming apparatus according to another embodiment;

FIG. 20 illustrates a cross-sectional view of a heater having individual heating zones according to one embodiment;

FIG. 21 illustrates a schematic view of a plastic sheet heated by the heater of FIG. 20;

FIG. 22 illustrates a cross-sectional view of a core or mandrel in accordance with a preferred embodiment;

FIG. 23 illustrates a cross-sectional view of a core according to one embodiment;

FIG. 24 illustrates a side view of a core and a cavity section of a thermoforming apparatus according to one embodiment;

FIG. 25 illustrates a side view of a core and a cavity section of a thermoforming apparatus according to another embodiment;

FIG. 26 illustrates a side view of a cavity section of a thermoforming apparatus according to one embodiment;

FIG. 27 illustrates a cross-sectional view of a core or mandrel according to one embodiment;

FIG. 28 illustrates a side view of a thermoforming system according to one embodiment;

FIG. 29 illustrates a top view of a thermoforming system comprising two stations according to one embodiment;

FIG. 30 illustrates a side view of a thermoforming system comprising a rotating core platen according to one embodiment;

FIG. 31 illustrates a top view of a thermoforming system comprising two stations according to another embodiment;

FIG. 32 illustrates a top view of a thermoforming system comprising four stations according to one embodiment; and

FIG. 33 illustrates a perspective view of a formable item comprising outer threads and a neck flange according to one embodiment.

### DETAILED DESCRIPTION OF THE PREFERRED EMBODIMENTS

This application is directed toward devices for containing liquid beverages, foods, food beverages and other foodstuffs, and system and methods of manufacturing and assembling same. In some embodiments, the cup portion is manufactured using vacuum and/or pressure thermoforming methods. However, a cup portion of the container can be manufactured by any other suitable process, including, but not limited to, other forms of thermoforming, extrusion, compression molding, injection molding, blow molding and/or combinations thereof. The formed product may include one or more coupling structures for attachment of a closure member. A closure member can engage and/or couple to the cup portion to provide a water-tight and/or air-tight two-piece or multi-piece container. In some embodiments, a removable sealing member can be provided between the cup portion and a closure member.

Although, the embodiments herein are directed toward the manufacture of beverage containers, it will be appreciated that the features and disclosure may be applicable to one or more other devices, system and/or methods, such as for example, the manufacture of other types of containers and other synthetic materials.

Multi-Piece Containers

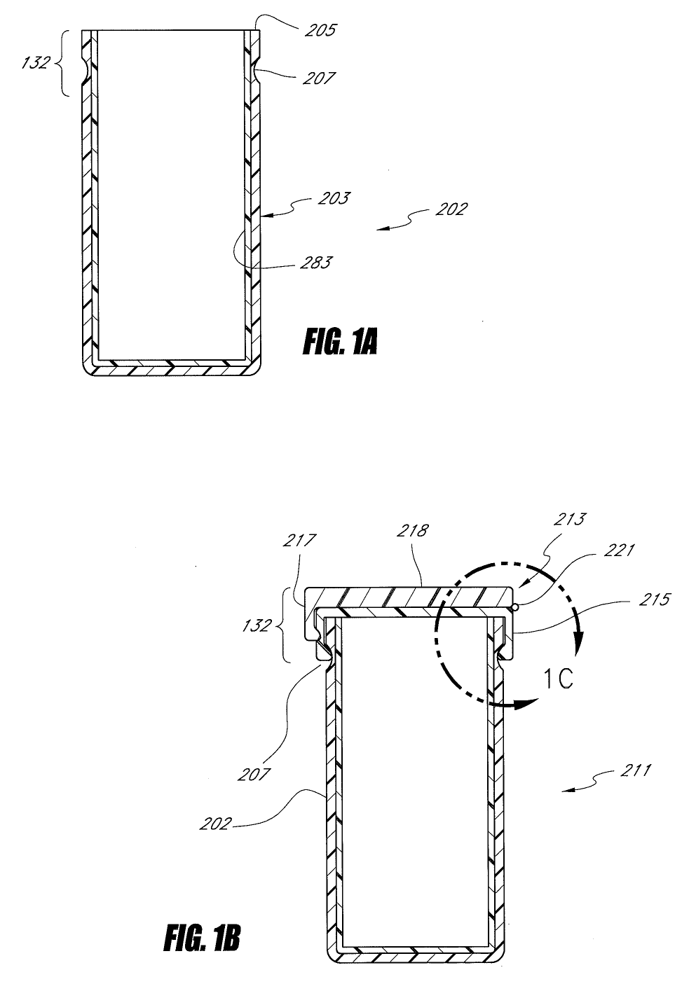

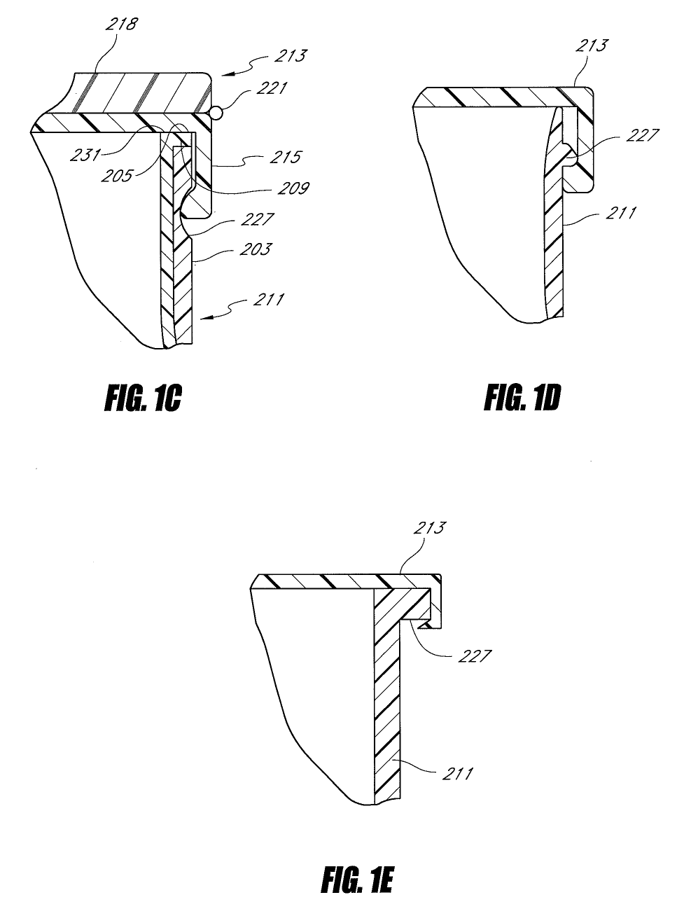

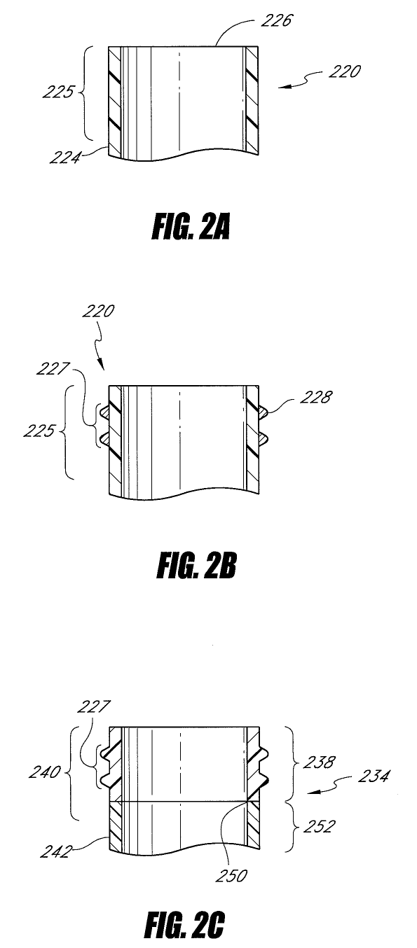

FIG. 1A illustrates a modified embodiment of a cup 202 or a can. The cup 202 has an upper portion 132 that defines a coupling structure 207 configured to receive a closure. As used herein, the term “coupling structure” is a broad term, and is used in accordance with its ordinary meaning and may include, without limitation a feature, such as a positive feature (e.g., a projection, protuberance, flange or the like) or negative feature (e.g., an indentation, recess or the like). As described in greater detail herein, a coupling structure can be advantageously configured to engage a closure member to hold the closure member in a desired position. The terms “cup,” “can” and “container” may be used interchangeably herein.

In FIG. 1A, the illustrated coupling structure 207 is in the form of a recess adapted to receive a portion of a closure device. The coupling structure 207 can extend about one or more portions of the cup 202. In other embodiments, the coupling structure 207 extends about the entire periphery or circumference of the cup 202. The coupling structure 207 can have a curved (e.g., semi-circular), polygonal, v-shaped, u-shaped, or any other cross-sectional profile. Although not illustrated in FIG. 1A, the structure 207 can be a protrusion, such as an annular protrusion. Optionally, the cup 202 can have a plurality of coupling structures 207 so that the closures of various configurations can be attached to a container made from the cup. The distance between an upper surface 205 of the cup 202 and the one or more coupling structures 207, as well as the shape of the structures 207, can vary. For example, such dimensions, shapes and other characteristics can be determined by the geometry of closure member used to seal and close the container made from the cup 202. Thus, the size, shape, dimensions, orientation, location and/or other characteristics of the coupling structure 207 can be different that discussed and illustrated herein.

FIG. 1B illustrates a container 211 produced from a cup 202 similar to the one depicted in FIG. 1A. According to some embodiments, a closure 213 is attached to the upper portion 132 of the container 211. The closure 213 can be a one-piece or multi-piece closure. In some embodiments, the closure 213 can be temporarily or permanently attached to the container 211. The entire closure 213 can be removed from the container 211 when the liquid is consumed. In other embodiments, a portion of the closure 213 can be removed while another portion of the closure 213 remains attached to the container 211 during consumption. The closure 213 can be semi-permanently or permanently attached to the container. If the closure 213 is semi-permanently attached to the container 211, the closure 213 can be pulled off the container 211. In one embodiment, if the closure 213 is permanently attached to the container 211, the closure 213 and container 211 can form a generally unitary body.

As shown in FIG. 1C, the upper surface 205 of the cup and the closure 213 can form a seal 231, preferably either a hermetic seal or other seal that inhibits or prevents liquid from escaping between the container 211 and the closure 213. In other embodiments, the seal 231 can be air-tight or substantially air-tight such that the container is capable of adequately storing a carbonated beverage. Optionally, the container 211 can have a gasket or removable seal. For example, the container 211 can have a removable seal, such as a membrane adhered to the upper lip of the container, or a portion of the closure 213 that can be removed. In some embodiments, the seal is manufactured from a plastic or other synthetic material. The seal can be a relatively thin membrane. However, in other embodiments, the sealing member can be relatively thick.

The removable seal can have a tab, ring, recess and/or other grasping member for convenient gripping and removal of the seal. Alternatively, the seal 231 can be formed by a membrane or sheet that can be broken, pierced and/or otherwise compromised in order open the container 211. For example, the seal 231 can comprise a perforated or otherwise weakened area which can be easily compromised by a user when he or she wishes to do so.

In the embodiment of the two layer cup that is illustrated in FIG. 1A, an outer layer 203 of the container 211 is formed of a generally high strength material or rigid material, such as, for example, polypropylene (PP) or the like, so that the flange 209 can be compressed between the closure 213 and the outer layer 203 to ensure that the integrity of the seal 231 is maintained. Although certain illustrations and descriptions reference or depict single layer or multilayer cup embodiments, any of the cup embodiments herein may be single layer or multilayer and any given description as to the number of layers should not be taken as limiting to that number of layers.

As shown in FIGS. 1B and 1C, the closure member 213 can comprise a body 215 and a cover 218. The body 215 can be connected to the cover 218 by a hinge 221 (e.g., a molded material acting as a living hinge or other structure to permit movement or any other movable member or feature). As illustrated in FIG. 1B, a latch or tang 217 can fasten the cover 218 to the body 215. The latch 217 can be moved to release the cover 218 in order to open the closure member 213. Alternatively, the cover 218 and body 215 can be separate pieces so that the cover 218 can be removed from the body 215. When the closure member 213 is in the opened position, contents can be delivered out of the interior of the container 211, preferably while the body 215 remains attached to the upper finish. After the desired amount of foodstuff, beverage and/or other comestible or non-comestible material has been removed from the container 211, the cover 218 can be returned to the closed position to reseal the container.

The body 215 of the closure 213 can be releasably coupled to the upper portion of the cup. For example, the body 215 can be snapped, screwed or otherwise engaged onto the upper portion 132. Alternatively, the body 215 can be permanently coupled to the upper portion 132. The upper portion 132 comprises one or more closure attaching structures 227, so that the closure member 213 can be snapped or otherwise placed onto and off of the container. The upper portion 132 in the illustrated embodiment has a closure attaching structure 227 in the form of a negative feature, such as a recess or indentation. The body 215 can be permanently coupled to outer layer 203 by a welding or fusing process (e.g., induction welding), an adhesive, frictional interaction, and/or the like.

The container 211 can be configured to receive various types of closures, such as BAP® closures produced by Bapco Closures Limited (England) (or similar closures), screw caps, snap closures, aluminum soda can lid, spout tops and/or the like. A skilled artisan can design the upper finish of the container 211 to receive closures of different configurations.

With continued reference to FIG. 1B, the container 211 is in certain embodiments well suited for hot-fill applications. Depending upon the materials used, the container 211 can generally maintain its shape during hot-fill processes. After hot-filling, final dimensions of the upper portion of the container 211 are preferably substantially identical to their initial dimensions. In hot-fill embodiments, the cup can be made from a single layer of suitable material or it may be made from a multi-layer sheet (i.e. two or more layers). For example, the inner layer can be formed of a material for contacting foodstuffs, such as PET. The outer layer can comprise moldable materials (e.g., PP, foam material, crystalline or semi-crystalline material, lamellar material, homopolymers, copolymers, combinations thereof, and other materials described herein) suitable for hot-filling. The outer layer provides dimensional stability to the upper portion 132 even during and/or after hot-filling. The width of the outer layer 203 can be increased or decreased to increase or decrease, respectively, the dimensional stability of the upper portion 132. Preferably, at least a portion of the upper portion 132 (including one layer of a multilayer structure) comprises a material having high thermal stability; however, the upper portion 132 can also include materials having low temperature stability, and may be made fully of such materials such as in non hot-fill applications.

Additionally, the dimensional stability of the cup ensures that the closure member 213 remains attached to the container 211. For example, the cup may comprise a high strength material (e.g., PP) and can maintain its shape thereby preventing the closure 213 from unintentionally decoupling from the container 211.

With reference to FIG. 1D, the container can include an upper portion that comprises closure attaching structures 227 for a snap fit. The upper portion of the cup in the illustrated embodiment has a closure attaching structure 227 in the form of a positive feature, such as a protrusion, flange, or the like suitable for engaging the closure 213. Alternatively, the closure attaching structure 227 can be in the form of a negative feature, such as a recess. The closure member 213 can have one-piece or multi-piece construction. The illustrated container 211 has an upwardly tapered wall forming the upper finish. The tapered portion of the upper finish can bear against the snap cap closure 213 and form a seal. As discussed, one or more separate sealing members can be included between the container and the closure member 213.

In FIG. 1E, yet another embodiment of a coupling structure 227 is shown. The coupling structure 227 is a flange or other similar feature positioned along the upper portion of the container. As illustrated the flange extends perpendicularly to the generally cylindrical outer wall of the container 211. However, it will be appreciated that the flange or other coupling structure can extend at angles less or more perpendicular with respect to the container wall. The flange or other coupling structure 227 may extend around the entire periphery of the container 211. Alternatively, a flange may extend from the container wall only at certain strategically positioned locations. In some embodiments, a closure 213 is configured to fit over the flange to seal the container.

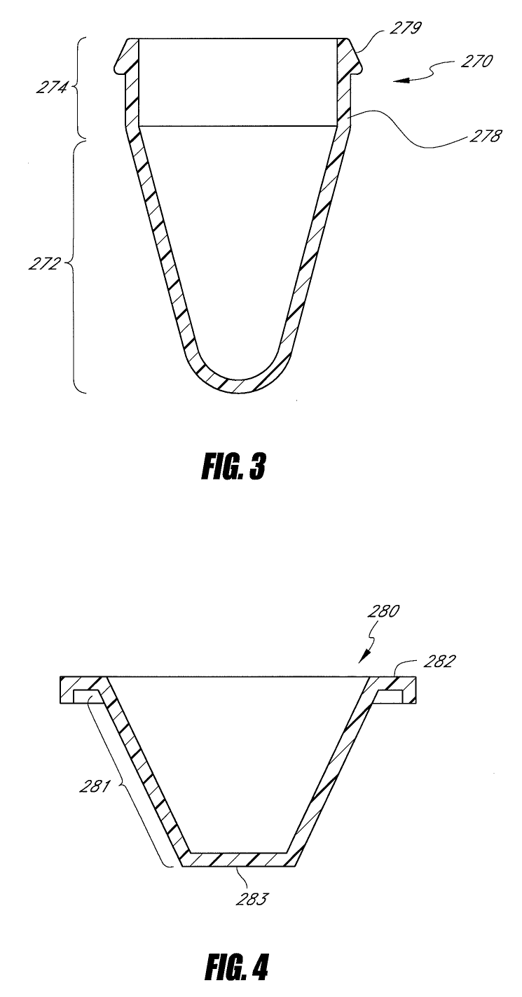

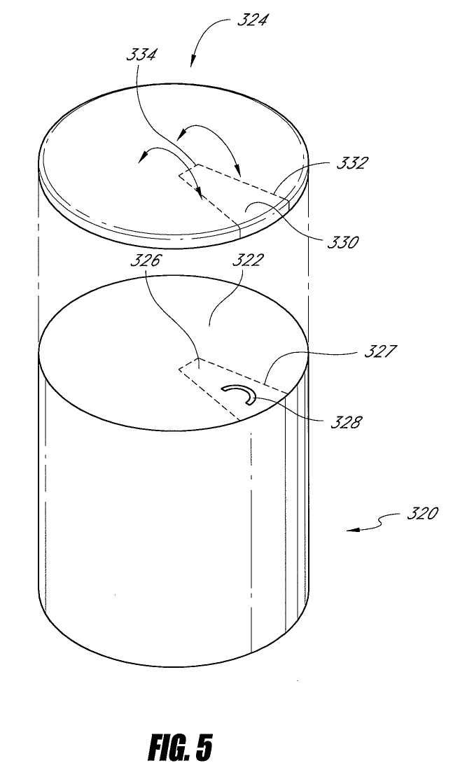

FIG. 2A illustrates a portion of a cup 220 in accordance with another embodiment. As depicted, the cup 220 can have an upper portion 225 and a body portion 224 extending downwardly therefrom. In some embodiments, the cup 220 can have an opening 226 at its upper end. In addition, the upper finish of the cup 200 can have a variety of configurations to facilitate coupling with a cap, lid or other closure member. The various indentations, protuberances and other features of upper finishes may be optionally formed on the cup 220 at the time the cup 220 is formed or in subsequent processes.

FIG. 2B illustrates one embodiment of the cup 220 after closure attaching structures 228 have been attached to the upper region 225. It is contemplated that structures engaging a snap cap or other type of mounting or attaching structure can be attached to the upper region 225 before or after the cup 220 has been made into a container. For example, the closure mounting structures 228 can be attached to the cup 220 after the cup has been molded (e.g., blow molded, thermoformed, compression molded, injection molded or otherwise produced into a container).

Cups can have other portions that are attached or coupled to each other. FIG. 2C illustrates a cup 234 that has at least a portion of the upper finish 240 that is coupled to a body 242 of the cup. The illustrated cup 234 has a portion 238 that is coupled to the upper end 250 of the lower portion 252 of the cup 234. The portion 238 may comprise different materials and/or microstructures than the lower portion 252. In some embodiments, the portion 238 comprises crystalline materials. Thus, the cup 234 can be suitable for hot fill applications. The lower portion 252 may be amorphous to facilitate the blow molding process. In some embodiments, the upper portion 238 comprises a different material than the lower portion 252. It will be appreciated that one or more different materials can be used to manufacture a cup and/or separate portions of a cup. A skilled artisan can select the material that forms the cup. The cups illustrated in FIGS. 2A to 2C can have monolayer or multilayer walls.

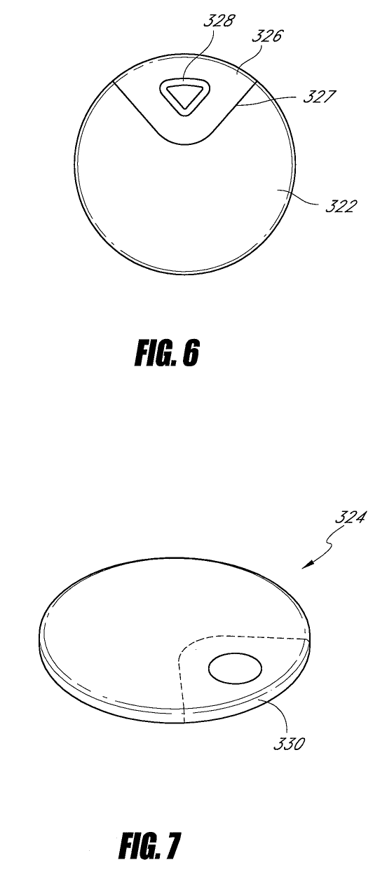

The cups, including the monolayer and multiplayer cups, described above can have other shapes, sizes, dimension and/or configurations. For example, FIG. 3 illustrates a cup 270 having a tapered body portion 272 and a upper finish 274. As shown, the cup 270 has a support ring 278 and one or more closure attaching structures 279, preferably configured to interact with a snap closure or other type of closure. Further, FIG. 4 illustrates another embodiment of a cup. The illustrated cup 280 comprises a body portion 281, which includes a lower end cap 283 and a upper finish 282. The cups illustrated in FIGS. 3 and 4 can be monolayer or multilayer cups (e.g., having layers as described herein). The cups described above can be formed without a upper finish or with any suitable finish including those described and/or illustrated in this application.

As discussed, one or more closure members or similar devices can be employed to seal a container. As used herein, the term “closure” is a broad term and is used in accordance with its ordinary meaning and may include, without limitation, a cap (including snap cap, flip cap, bottle cap, crimp cap, threaded bottle cap, pilfer-proof cap, etc.), a crown closure, puncturable or removable foil or film seal, a lid, aluminum can lid, multi-piece closures (e.g., BAP® closures produced by Bapco Closures Limited (England) or similar closure), snap closures, and/or the like.

In some embodiments, the closure members can have one or more features that provide additional advantages. Some closures can have one or more of the following: tamper evident feature, tamper resistant feature, sealing enhancer, compartment for storage, gripping structures to facilitate removal/placement of the closure, non-spill feature, and combinations thereof.

Closure members can have a one-piece or multi-piece construction, and may be configured for permanently or temporarily coupling to a container. For example, the closure illustrated in FIG. 1B has a multi-piece construction, while other closures can have one-piece construction. The terms “closure,” “closure member,” “cap,” and “lid” may be used interchangeably herein. As used herein, the term “cap” is a broad term and is used in accordance with its ordinary meaning and may include, without limitation, a cap or lid suitable for being attached to a can, bottle, or other container including those configured to hold beverages, liquids, liquid foods or soft foods. In view of the present disclosure, embodiments of closure members having one form of coupling structure may be modified to form caps or other closures for containers having different coupling structures or configurations. In some embodiments, closure members can engage a container or be attached to a container by various methods, such as sonic welding, induction welding, a multi-step molding process, adhesives, thermoforming, crimping, snap fitting, friction-fitting, press-fitting, couplings and/or the like.

The closure members can have one or more compartments configured for storage. The compartments can contain additives that can be added to the contents of the associated container. In some embodiments, the additives can affect the characteristics of the container's contents. The additives can be in a solid, gas and/or liquid state. In some embodiments, the additives can affect one or more of the following: aroma (e.g., additives can comprise scented gases/liquids), flavor, color (e.g., additives can comprise dies, pigments, etc.), nutrient content (e.g., additives can comprise vitamins, protein, carbohydrates, etc.) and/or combinations thereof. The additives can be delivered from the closure member into the contents within the container for subsequent ingestion. Preferably, such additives help to enhance the desirability of the contents and the consumption experience. According to some embodiments, the one or more interior compartments which contain the additives can release the additives during removal of the closure member so that the mixture is fresh. However, the compartments can be opened before or after the closure member is removed from the container. In some embodiments, the closure member comprises one or more compartments that can be broken (e.g., punctured) after the closure has been separated from a container. The compartments can be broken by a puncturing process, tearing and/or the like. The compartments can have a structure for releasing the additives or other ingredients contained therein. In some embodiments, the container can comprise a structure with a pull plug, snap cap or other suitable structure for releasing the compartment's contents.

The containers can also be include a seal that is separate from the closure member. Such seals can be attached to a closure member and/or can form part of the closure member itself. The seal can be applied to the container before or after the closure member is attached. A sealing process (e.g. thermal, induction, adhesive) can be employed to attach the seal member to the upper finish of a container after the container has been filled and/or to all or part of the closure. The seal can be similar to or different than any liner attached to a closure. The seals can be hermetic seals that ensure the integrity of the containers' contents. In some embodiments, the sealing members are configured to make the container spill-proof.

In other embodiments, a seal member comprises one or more of the following: metal (including metal foil such as aluminum foil), plastic, adhesive, paper and other materials. In certain preferred embodiments, a seal is a laminate comprising one or more layers, each of which may be a different material (including different plastics or different metals) or a combination of materials (e.g. a layer may comprise adhesive-impregnated paper or fiber-reinforced plastic). Seals may also be part of the closure. Seals may applied to a container and/or closure by a sealing or welding process, including thermal or inductive sealing and the like. However, the seal can be attached to a container and/or closure using other suitable attachment processes, for example an adhesive may be used. The terms “seal,” “seal member” and “sealing member” are used interchangeably herein.

The closure members can have an inner surface suitable for engaging closuring mounting structures (e.g., threads, snap cap fittings, BAPCO® fittings, spouts and/or the like). The inner surface can provide a somewhat lubricious surface to facilitate removal of the closure from a container. For example, the closure members can include a lubricious or low friction material (e.g. olefin polymers) to engage the material forming the container. If a closure member is formed of PET, for example, the closure member may stick or lock with a PET container. Thus, the closure (including snap caps, twist caps, and the like) may require a relatively high force to remove the closure. Advantageously, a closure with a lubricious or low friction material can reduce the removal forces in order to facilitate removal of the closure. The lubricious or low friction material preferably provides enough friction such that closure can remain coupled to an associated container while also permitting convenient closure removal. Thus, the lubricious or low friction material can be selected to achieve a desired removal force or torque. In other embodiments, however, closure members can comprise non-lubricous materials or less-lubricous materials, as desired or required for a particular application.

FIG. 5 illustrates one embodiment of can which comprises removable sealing functionality. The can may comprise a cup portion 320 which, in some embodiments, comprises one or more suitable materials or combination of materials, such as, for example, glass, metal, one or more plastic or polymeric materials and/or the like. In some embodiments, the cup portion 320 includes a coupling structure to engage, mate or couple with a closure such as the illustrated lid 324. The open end of the cup portion 320 can be covered by a sealing member 322. In other embodiments, the sealing member 322 only partially covers the opening of the open end of the cup portion 320.

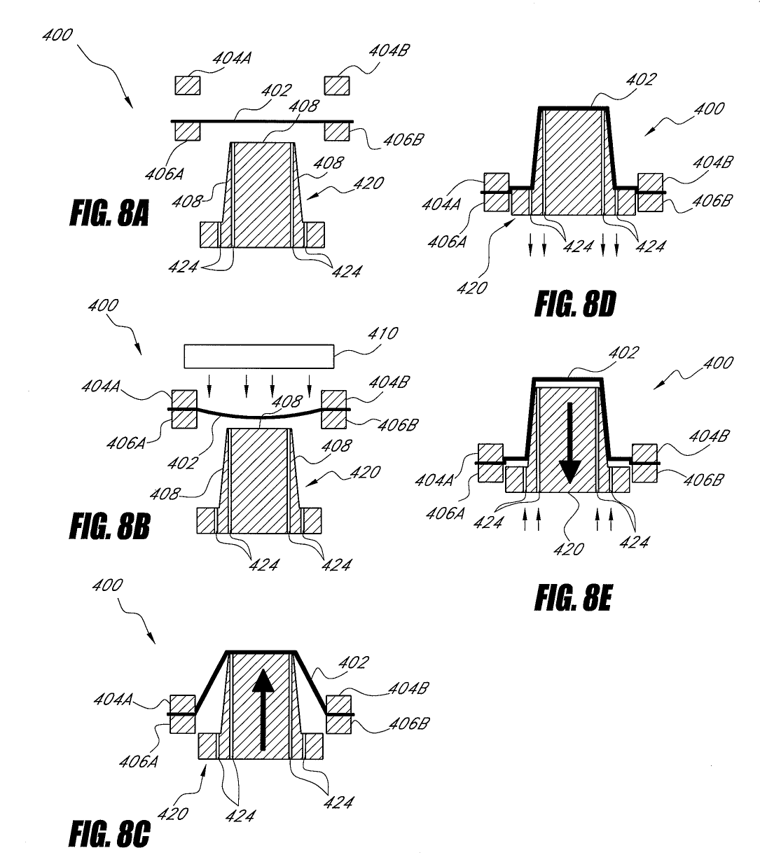

Embodiments of the sealing member 322 are illustrated in FIGS. 5 and 6. The sealing member 322 can be sealed, welded, adhered or otherwise attached to the cup member 320, closure member 324 and/or both. In addition, the sealing member 322 may be sealed to all or at least a portion of the cup portion 320 and/or closure member 324. The sealing member 322 can include a removable portion 326 that may be removed such as by pulling a tab 328 or similar structure affixed to or unitary with the removable portion 326. In some embodiments, wherein the removable portion 326 is affixed or sealed to the moveable section 330, the removable portion 326 can be removed by means of the moveable section 330. In some embodiments, the removable portion may be removed only partly so as to gain access to the contents of the container. Alternatively, the removable portion can be removed entirely and then discarded.

The removable portion 326 can also be removed by pressing down on the removable portion such as by a straw, a portion of the cap or some other object to gain access to the contents. In some embodiments, the removable portion can be positioned directly adjacent or attached to the moveable section 330. In some embodiment, the removable portion 326 is bounded by one or more boundaries 327 that are adapted to allow selective or preferential tearing, breaking, folding along such boundary 327 and/or the like. Such adaptation can take the form of perforations (through one or more layers of the seal), scoring, thinner portions, weakened portions, and the like. The removable portion 326 can have any suitable shape, such as, for example, wedge-shapes, rectangular, triangular, other polygonal, circular, oval, irregular shapes and/or the like. There can be two or more portions as in FIG. 5 or a single curve as in FIG. 7. If there are two or more portions, the portions may or may not intersect. In another embodiment, the removable portion 326 comprises an area adapted to being perforated or otherwise weakened or easily compromised (e.g. thinner than other portions of the seal) such as by a straw, finger, utensil, or implement.

With reference to the embodiments illustrated in FIGS. 5 and 7, a closure member 324 can be attached to the cup 320 or bottom portion by any suitable means, including, but not limited to snap cap, engaging with a coupling structure as described and illustrated herein, and the like. In the embodiment illustrated in FIG. 5, the closure 324 includes a moveable section 330 that can be lifted and/or removed. Lifting and/or removal of the section 330 can help expose at least a portion of the seal 322 (e.g. the removable portion 326). In other embodiments, wherein the seal is attached to at least the moveable section 330 of the closure 324, lifting and/or removal of the section 330 may expose the contents of the container, as moving the moveable section fully or partially removes at least the portion of the seal attached thereto. In certain embodiments, the moveable section 330 of the closure 324 and the removable portion 326 of the sealing member 322 are of a similar size and shape. In preferred embodiments, the size and shape of the sealing member 322 are adapted to allow a person to easily drink or pour from the container. It will be appreciated that the shape, size and other characteristics of the moveable section 330 and/or the removable portion 326 of the sealing member 322 can be different than illustrated herein.

The moveable section 330 can include one or more boundaries 332, 334 that are adapted to allow selective or preferential tearing, breaking, bending and/or folding along such boundary 332, 334. Such adaptation may take the form of perforations, cut portions (e.g., along the lip and/or side wall of the closure or the like) scoring, thinner portions, weakened portions and the like. The movable section 330 can have any suitable shape, such as wedge-shaped, rectangular, triangular, other polygonal, circular, curvate, oval, irregular shaped and/or the like. There may be two or more portions as in FIG. 5 or a single curve as in FIG. 7. If there are two or more portions, the portions may or may not intersect.

In certain embodiments, the moveable section 330 is fully removable and may be discarded. In other embodiments, the moveable section 330 is retained for possible later resealing with one or more boundary sections serving as a living hinge. In the embodiment illustrated in FIG. 5, boundary 332 is perforated to permit tearing along the boundary 334, which acts as a living hinge to permit the moveable section 330 to pivot up in the direction of the arrows. This can allow access to the seal and/or contents. Once pivoted upwardly, the moveable section 330 may be secured by a mechanical means such as, for example, one or more clips, tabs, hooks, snap fittings, press fittings or other engagement and/or securement mechanism or a combination of two or more such items. Any other type of securement means can also be used, whether mechanical or not. For example, a temporary or permanent adhesive or other tacky material can be used to secure the moveable section 330. In the embodiment of FIG. 7, the seal 322 is attached to at least a portion of the moveable section 330 such that access to the contents of the container may be achieved by lifting the moveable section 330.

Systems, Devices and Methods of Manufacturing Containers

The closure portion of the container may be made by any suitable process, including but not limited to thermoforming, injection molding, compression molding, blow molding, rotational molding, dip molding and/or other methods. The closure members can be single layer or multi-layer structures and can comprise one or more materials as described herein.

The body portion of the container, which may also be referred to as the cup, cup portion or can, can be made by any suitable process, such as, for example, extrusion blow molding, extrusion molding, extrusion, injection molding, injection blow molding, thermoforming and/or the like. In extrusion and/or thermoforming processes, the sheet stock from which the body is made can be single or multi-layer, and may comprise any combination of the materials described herein. Injection molding or injection blow molding can use one or more materials to make monolayer or multilayer containers. Multilayer injected containers can be produced by overinjection, including by inject-over-inject molding, co-injection and/or other methods, with or without subsequent blow molding. In addition, the cup and/or closure portions of a container can be coated (e.g., by dip, spray, flow coating, etc.).

Suitable methods, apparatus, and materials for making or processing containers, including both closures and cups, as disclosed herein include, but are not limited to, those described in U.S. Pat. Nos. 6,312,641, 6,391,408, 6,676,883, 6,352,426, and 6,808,820, U.S. Patent Application Publication Nos. 2004/0071885, 2006/0065992, 2006/0073298, and 2006/0073294, and U.S. patent application Ser. Nos. 11/179,025, 11/405,761, 60/892,515 and 60/809,974, all of which are incorporated by reference herein in their entireties.

The starting material for several methods of construction includes extruded sheet stock. Sheet stock may have mono- or multi-layer construction, and may include an active or passive barrier or other functionality, such as UV absorbance. Extruded sheet can be delivered to a molding apparatus from one or more systems (e.g., standard, traditional or custom systems, etc.). Prior to forming, the sheet stock may be cleaned and/or sterilized by one or more methods, such as, for example, steam, hydrogen peroxide, other chemical or physical treatments, UV, flame, gamma ray, plasma treatments and/or the like.

Thermoforming

In certain preferred embodiments, thermoforming is used to mold the can or cup portion of the container. Any form of thermoforming can be used to make the cup portion of the can. The discussion which follows is directed to certain thermoforming processes, and should not be taken as excluding other processes.

As is discussed in greater herein, some manufacturing methods can include a combination of vacuum, mandrel assist and/or pressure forming of cylindrical or differently shaped containers. According to some embodiments, such containers can comprise a minimal draft, long draw and/or complex base designs. In one embodiment, the process and tooling devices or methods used can facilitate molding of contours in the uppermost portion of the container. The containers can include various flange and/or other closure interface surfaces, which in some embodiments comprise integrated trimming devices or other features. This can advantageously enable functional and/or aesthetic designs or features to be incorporated into the containers.

The timing of the vacuum, mandrel pressure and positive air pressure steps or processes, especially in relation to axial and/or hoop stretching, can be modified to control the physical properties of the manufactured items, to vary the wall thickness distribution of plastic materials and/or to regulate one or more other characteristics of the manufactured items. Such processes can be used with one or more various polymers. However, these processes can also be configured for the heat setting and/or annealing of PET with hot and/or thermally stable filling processes in mind.

In FIG. 8A, a plastic or polymeric sheet 402 can be positioned in a molding apparatus 400. As shown, the sheet 402 can be placed between a set of upper clamping members 404A, 404B and a set of lower clamping members 406A, 406B. The sheet 402 may be manufactured from one or more plastic or polymeric materials as discussed herein. In the illustrated embodiment, the sheet 402 is clamped in a horizontal position, generally perpendicular to the direction of movement of the thermoforming mold section 420. According to some embodiments, the sheet 402 is maintained in a stretched or extended position when clamped in place over the mold section 420. As shown, the mold section 420 is a core mold section having a generally frusto-conical or cylindrical shape. In the depicted embodiment, the mold section 420 includes a slight draft angle so that the final molded product, e.g., a cup, may also include a taper along its side wall. Of course, it will be appreciated that the mold section can have a different shape, either more or less intricate than the embodiments illustrated and discussed herein, depending on the desired shape of the objects beings molded. The mold section 420 can include one or more outer structures, such as a flange, protuberance, recess and/or the like, that can be used to attach a closure to the molded product as described herein.

In addition, one or more portions of the mold section 420 can comprise a high heat transfer material, as discussed and defined herein. The use of such materials can enhance the heat transfer properties of the system, allowing for better cooling and temperature control of the thermoformed items. In addition, although not illustrated, the mold section 420 can advantageously comprise one or more cooling channels, which are configured to receive cooled water or any other cryogenic or non-cryogenic fluid, either in lieu of or preferably in addition to the use of high heat transfer materials.

After the sheet 402 has been adequately secured relative to the mold section 420, the temperature of the sheet 402 is regulated in preparation for the subsequent thermoforming steps. For example, the sheet 402 is typically heated to a desired temperature to give it the necessary elasticity for the molding steps that follow. In FIG. 8B, a heater 410 provides the necessary heat to raise the temperature of the sheet 402 to a desired level. Heaters may include ceramic/ceramic strip heaters, infrared heaters, natural gas heaters, convection heaters, conduction heaters, resistive-element heaters, radiant panel heaters, quartz tube or lamp heaters and/or the like. In some embodiments, two or more heaters may be used to heat the sheet 402. Although the heater 410 illustrated in FIG. 8B is positioned above the sheet 402, it will be recognized that one or more heaters may be located at any position and at any distance with respect to the sheet 402. In some embodiments, the heater 410 may be movable such that its distance to the sheet 402 can be varied depending on the level or extent of heating desired. The heater 410 may also be configured to move sufficiently away from the mold section 420 when heating of the sheet 402 is not required. In other embodiments, the sheet 402 can be configured to be heated uniformly or non-uniformly across its surface by one or more heaters 410.

With continued reference to FIG. 8B, sag can be created in the heated sheet 402. In the illustrated embodiment, the sag causes the sheet 402 to soften and expand, and thus, to become thinner in one or more areas. In some embodiments, the amount of sag created in the heated sheet 402 can be selectively varied depending on one or more factors, such as, for example, the type of material used, the sheet thickness, the sheet dimensions, the number of sheet layers, the amount and duration of heat to which the sheet is exposed and/or the like. In FIG. 8B, the sag brings a central portion of the sheet 402 closer to the top surface of the mold section 420. However, the sheet 402 and mold section 420 can be differently configured so that the sag positions one or more sections of the sheet 402 further away from a mold section surface.

In FIGS. 8A and 8B, heat from the heater 410 is introduced to the sheet 402 only after the sheet 402 has been positioned over the mold section 420. It will be appreciated, however, that the process can be reversed, such that the sheet 402 is heated to a desired temperature prior to being secured within the clamping members. In yet other embodiments, the a sheet 402 can be heated prior to and while it is secured to the clamping members.

In some embodiments, as depicted in FIG. 8C, after the sheet 402 has been adequately heated and positioned over a mold section 420, the mold section 420 can be moved upwardly toward the sheet 402. The movement of the mold section 420 relative to the sheet 402, stretches the sheet 402 around an outer surface of the mold section 420. Preferably, the elasticity, strength and/or other properties of the sheet 402 are such so as to prevent tearing, ripping or otherwise damaging the sheet 402 during the stretching and/or other molding procedures.

As illustrated, the mold section 420 can comprise a plurality of channels 424 that are situated in at least a portion of the mold section body and extend to one or more molding or forming surfaces 408. As used herein, the term “molding surface” is a broad term and is used in accordance with its ordinary meaning and may include, without limitation, any surface, regardless of shape, texture, location, etc., on which a plastic or polymeric material can form using thermoforming, intrusion molding, compression molding, blow molding, injection molding or any other type of molding technique or method. The terms “molding surface” and “forming surface” are used interchangeably herein.

In FIG. 8D, two channels 424 extend to an upper molding surface of the mold section 420, and two other channels 424 extend to a lower molding surface of the mold section 420. It will be appreciated, however, that a mold section can comprise more or fewer channels 424 than illustrated and discussed herein. Further, the orientation of the channels 424 through the body of the mold section 420 can be different than illustrated in FIG. 8D. For example, in some embodiments, two or more channels 424 are in fluid communication with one another, creating a manifold or similar hydraulic arrangement between them.

Preferably, the channels 424 are configured to convey air or other fluid in either direction. In some embodiments, the channels 424 may be connected to a compressed fluid and/or a vacuum source in order to permit fluid flow in either direction through the channels 424. As illustrated in FIGS. 8A through 8E, the channels 424 are connected to a compressed fluid and/or vacuum source along the lower end of the mold section, generally opposite of the molding surfaces 408. Depending on the configuration and operational scheme of a particular molding system, the flow of air or other fluid through the channels 424 can help urge the sheet 402 toward and/or away from the molding surface 408 of the mold section 420.

With reference to FIG. 8D, as the mold section 420 stretches the sheet 402 outwardly, a vacuum or suction force through the channels 424 may assist in drawing the sheet 402 toward one or more of the molding surfaces 408. Thus, air and/or other fluid present between the sheet 402 and the molding surfaces 408 may be expelled through the channels 424. This can advantageously cause the sheet 402 to better conform to the molding surfaces 408 of the mold section 420. In some embodiments, after the sheet 402 has conformed to the mold section, it can be cooled in order to retain its molded shape. The molded sheet 402 can be cooled using a variety of methods, such as, for example, introducing cooling air or other fluids directly on and/or in the vicinity of the sheet 402, directing a cooling fluid through one or more cooling channels located within a mold portion, cooling the entire mold section 420 using one or more cooling devices or methods and/or the like.

As illustrated in FIG. 8E, once the sheet 402 has been adequately cooled, a quantity of air or other fluid may be introduced through one, some or all of the channels 424 to facilitate its removal from the mold section 420. Thus, is some embodiments, the direction of flow through the channels 424 is opposite of the vacuum or suction flow used to shape the sheet 402 to the mold section 420. Air delivered to the molding surface can assist in separating the molded sheet 402 from the molding surfaces 408 of the mold section 420. Preferably, the air flow rate directed through the channels 424 to one or more molding surfaces 408 is sufficient to overcome any mold adhesion or bonding forces that may have developed between the molding surfaces 408 and the sheet 402 during the molding process.

In other embodiments, one or more physical separation methods can be used to detach the molded sheet 402 from the mold section 420. For example, the molded sheet 402 can be removed from the mold section 420 by applying a shearing force to the molded sheet 402 relative to an adjacent surface of the mold section. In other embodiments, it may not be necessary to include an initial separation step, as the mold adhesion or bonding forces may be relatively low. For instance, the sheet may include one or more components, additives and/or coatings that reduce the adhesion forces with the adjacent molding surfaces 408.

With continued reference to FIG. 8E, the mold section 420 can be lowered or otherwise moved away from the molded sheet 402 to complete the process. During the demolding procedure, lowering of the mold section 420 toward its original position can occur before, after or simultaneously with the introduction of air or other fluid to the molding surface 408 as described above. In some embodiments, after the mold section 420 has been separated from the molded sheet 402, the clamps holding the edges of the sheet 402 are moved apart to release the molded sheet 402. Undesirable or unwanted portions of the molded sheet 402, such as, for example, the edge portions retained in the clamps, can be removed by a cutting member or other device (not shown). The cup-shaped items thermoformed from the sheet 402 can undergo additional processing (e.g., surface treatment, coating, etc.), cooling, transporting and/or the like. In some embodiments, a coupling structure, such as, for example, a groove, recess, flange, etc., can be added or formed in one or more locations of the thermoformed cup in preparation for receiving a closure as discussed herein.

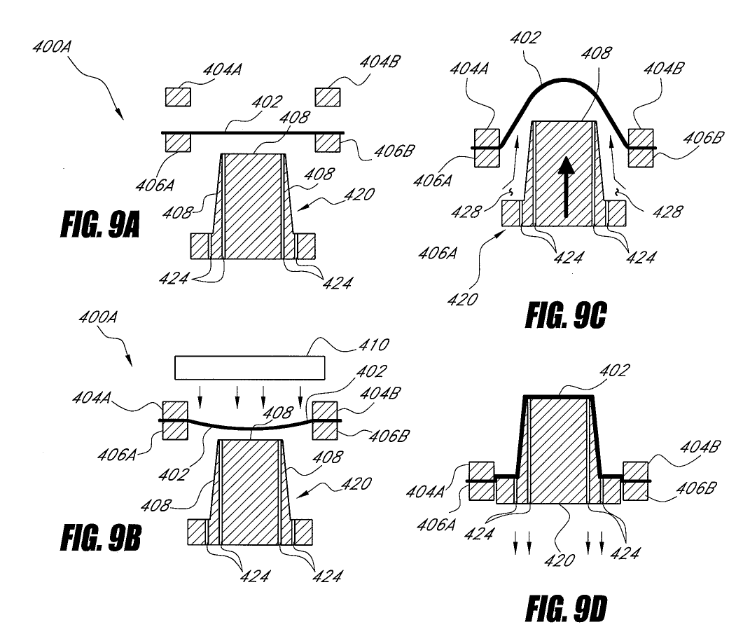

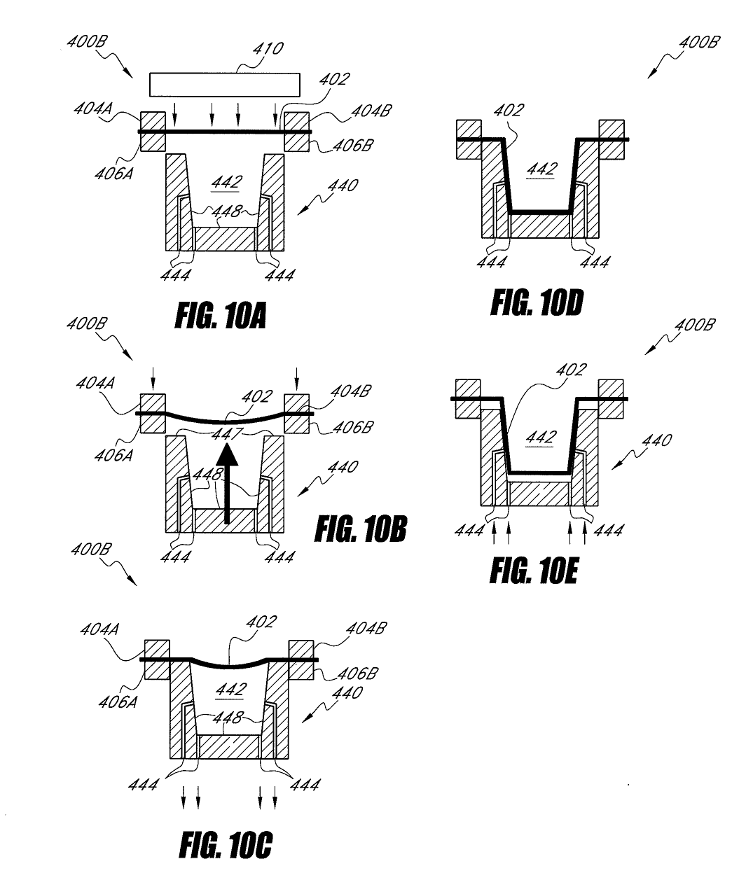

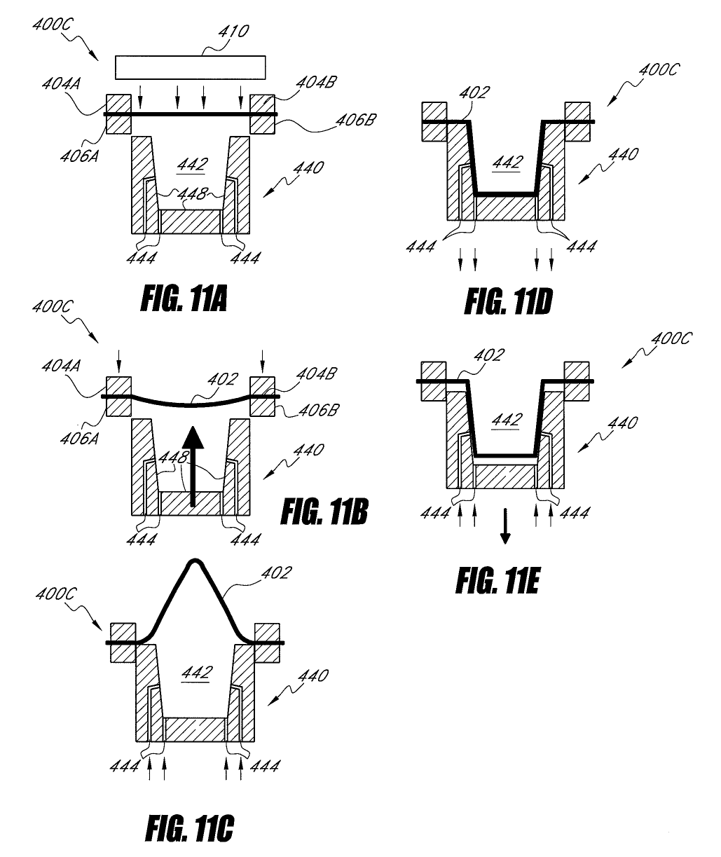

The molding apparatus 400A illustrated in FIGS. 9A through 9D is similar to the embodiment discussed above with respect to FIGS. 8A through 8E. However, after the sheet 402 has been positioned over the mold section 420 and heated (FIGS. 9A and 9B), compressed air or other fluid is directed to the underside of the sheet 402. In FIG. 9C, air or other fluid is delivered to the underside of the sheet 402 from the gap 428 provided between the mold section 420 and the clamping members 404A, 404B, 406A, 406B. Alternatively, air can be delivered through one or more channels 424 of the mold section 420, either in lieu of or in addition to gap 428. If sufficient air or other fluid is delivered underneath the sheet 402, the sheet 402 can be stretched upwardly. In the embodiment depicted in FIG. 9C, the sheet assumes a generally dome-like geometry. The extent to which the sheet 402 stretches and the shape it assumes can depend on one or more variables, such as, for example, the type(s) of sheet material used, the elastic properties of the sheet, the initial sheet thickness, the flow rate and direction of air or other fluid directed to the underside of the sheet 402, other properties and characteristics of the sheet 402 and/or the like.

With continued reference to FIG. 9C, while the sheet 402 is being pushed upwardly by the air, the mold section 420 also moves toward the sheet 402, urging the sheet 402 to conform to the mold section's molding surface 408. The initial stretching of the sheet 402 allows the final molded product to have a more evenly distributed thickness throughout the various locations of the sheet 402. Preferably, the rate of pre-stretching caused by the initial air flow is regulated to achieve an adequate thickness distribution of sheet material in the molded product. For example, the regulation of air or other fluid flow can be accomplished using one or more valves, sensors, pressure regulators and/or the like. In the embodiment illustrated in FIG. 9D, after the mold section 420 has attained its final position relative to the sheet 402, a vacuum or suction flow through the channels 424 in a direction away from the molding surface 408 expels a volume of air which is present between the sheet 402 and the molding surface 408. This permits the sheet 402 to more easily conform to the adjacent surfaces of the mold section 420.

FIGS. 10A through 10E illustrate another embodiment of a thermoforming apparatus 400B. In FIG. 10A, the mold section 440 is a cavity mold section comprising its molding surfaces 448 within an interior cavity 442. As shown, the orientation of the molding surfaces 448 is capable of forming a sheet 402 into a shape similar to that formed by the core mold section 420 described above with reference to FIGS. 8A-8E and 9A-9D. The thermoforming apparatus 400B may include a heater 410 to heat the sheet 402 and clamping members 404A, 404B, 406A, 406B to secure the sheet 402 over the mold section 440. In addition, the mold section 440 can comprise one or more internal channels 444 which are configured to deliver air or other fluid to and/or from the molding surfaces 448. As with other embodiments of core mold sections described herein, the shape of the molding surfaces 448 may be different than illustrated in FIGS. 10A through 10E. In addition, the molding surface can be configured to include one or more outer structures, such as, for example flanges, protrusions, protuberances, recesses and/or the like, that may be used to attach a closure member to the thermoformed sheet 402.

As discussed with regards to previous embodiments herein, one or more portions of the mold section 420 can comprise a high heat transfer material, as discussed and defined herein. The use of such materials can enhance the heat transfer properties of the system, allowing for better cooling and temperature control of the thermoformed items. In addition, although not illustrated, the mold section 420 can advantageously comprise one or more cooling channels, which are configured to receive cooled water or any other cryogenic or non-cryogenic fluid, either in lieu of or preferably in addition to the use of high heat transfer materials.

In operation, the sheet 402 is positioned over the mold section 440, and if necessary, heated or otherwise softened using one or more heaters 410 or other devices. Alternatively, the sheet 402 delivered to the position illustrated in FIG. 10A can already be heated to a desired temperature prior to and/or during being positioned over the mold section 440, either in lieu of or in addition to heating after it has been positioned over the mold section 440. As depicted in FIG. 10B, depending on the physical and material properties of the polymeric materials that comprise the sheet 402, the heated sheet 402 can be configured to sag, especially in the middle where it is generally unsupported. It will be appreciated that the extent, position and other details of the sag can be selectively controlled.

With continued reference to FIGS. 10B and 10C, the mold section 440 can then be moved in the direction of the heated sheet 402. In one embodiment, the mold section 440 is positioned so that its top surfaces 447 of the mold section 440 are generally flush with the sheet 402. Alternatively, the mold section 440 can be situated in a higher or lower position relative to the sheet 402. After the mold section 440 has been adequately positioned, a vacuum can be created within the cavity 442 of the mold section 440, causing the sheet 402 to be drawn towards the molding surfaces 448. In some embodiments, such as the one illustrated in FIG. 10C, air is directed out of the channels 444, away from the interior cavity 442 of the mold section 440, to create the necessary vacuum within the cavity 442.

In FIG. 10D, an adequate vacuum has stretched the sheet 402 along the molding surfaces 448, causing the sheet 402 to take the shape of the cavity 442. The rate at which the sheet 402 will be stretched or urged toward the molding surfaces 448 depends on the flow rate of air expelled from the cavity 442 through the channels 444, the thickness, material properties, temperature and other properties of the sheet 402 and/or one or more other factors. The sheet 402 can continue to stretch along the molding surfaces 448 of the mold section 440 until any air remaining between the sheet 402 and the cavity 442 has been eliminated.

In some embodiments, after the formed sheet 402 has been sufficiently cooled, it can be demolded from the adjacent molding surfaces 448 by lowering the mold section 440 as illustrated in FIG. 10E. A volume of air or other fluid may be delivered through the channels 444 toward the cavity 442 of the mold section. Such an air or other fluid surge can help overcome any mold adhesion forces that may have developed between the sheet 402 and the adjacent molding surfaces 448 during the molding process. It will be appreciated, however, that any other demolding method can also be used to remove the formed sheet 402 from the mold section 440, either in lieu of or in addition to providing a surge of air. For example, one or more mechanical (e.g., stripper), hydraulic or other types of the devices can be used.

The embodiment of a thermoforming apparatus 400C depicted in FIGS. 11A through 11E is similar to those discussed herein in relation to FIGS. 10A through 10E. As illustrated in FIGS. 11B and 11C, after the heated sheet 402 is properly positioned over the mold section 440, air can be introduced into the mold cavity 442 through the channels 444. The air or other fluid causes the sheet to stretch out in a direction generally away from the cavity 442. In some embodiments, the extent to which the sheet 402 is stretched can be related to the total area of the molding surfaces 448, which the sheet 402 will ultimately contact. In some embodiments, this pre-stretching process causes the sheet 402 to stretch in a way such that the thickness of the stretched sheet 402 is generally uniform throughout some or all of the sheet 402. Alternatively, the sheet 402 can be stretched to create one or more areas with thicker or thinner thicknesses.

With reference to FIG. 11D, the stretched sheet 402 can be then drawn toward the molding surfaces 448 of the mold section 440 by introducing a vacuum or suction in the cavity 442. As discussed above, in some embodiments, the vacuum in the cavity 442 is generated by directing air through the channels 444 in a direction away from the cavity 442 of the mold section 440. Depending on the how much the sheet 402 is pre-stretched, the sheet 402 may or may not require additional stretching when a vacuum or suction is created within the cavity 442. In one embodiment, no additional stretching of the sheet 402 occurs between the pre-stretching and the forming steps. In some embodiments, the extent of additional stretching can be relatively minor. Further, in some embodiments, pre-stretching is likely to reduce or eliminate additional stretching of the sheet 402 during the molding step, such as the one illustrated in FIG. 11D. Consequently, in certain embodiments, pre-stretching can lead to more uniform and consistent sheet thickness in the formed product. However, care must be taken when going from the pre-stretched to the formed phases (e.g., from the embodiment illustrated in FIG. 11D to the embodiment illustrated in FIG. 11E) to avoid wrinkles, creases and/other generally non-smooth features or structurally weakened areas on the sheet 402.

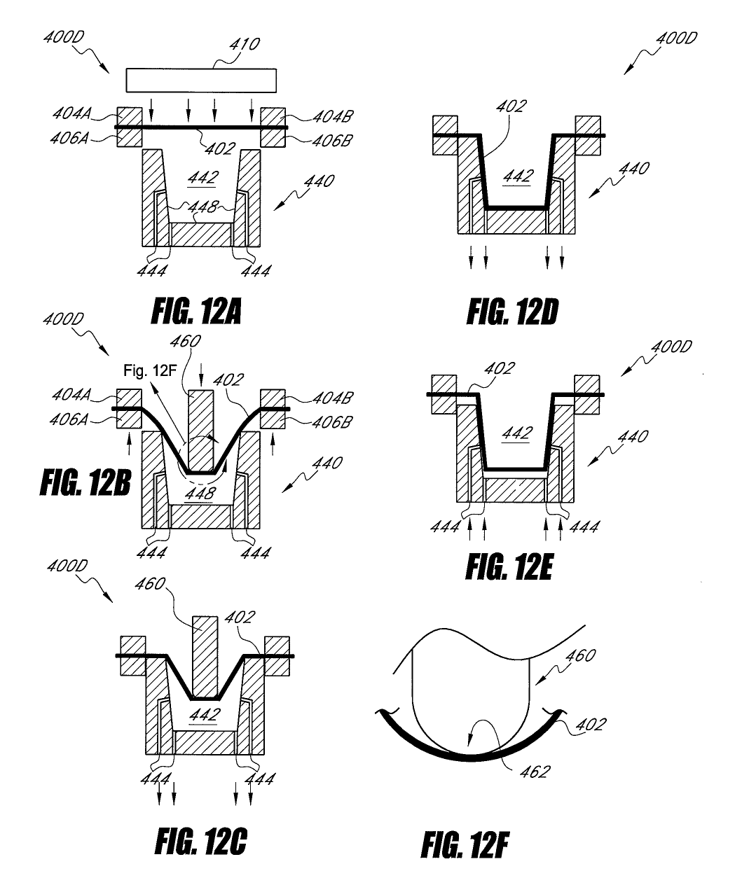

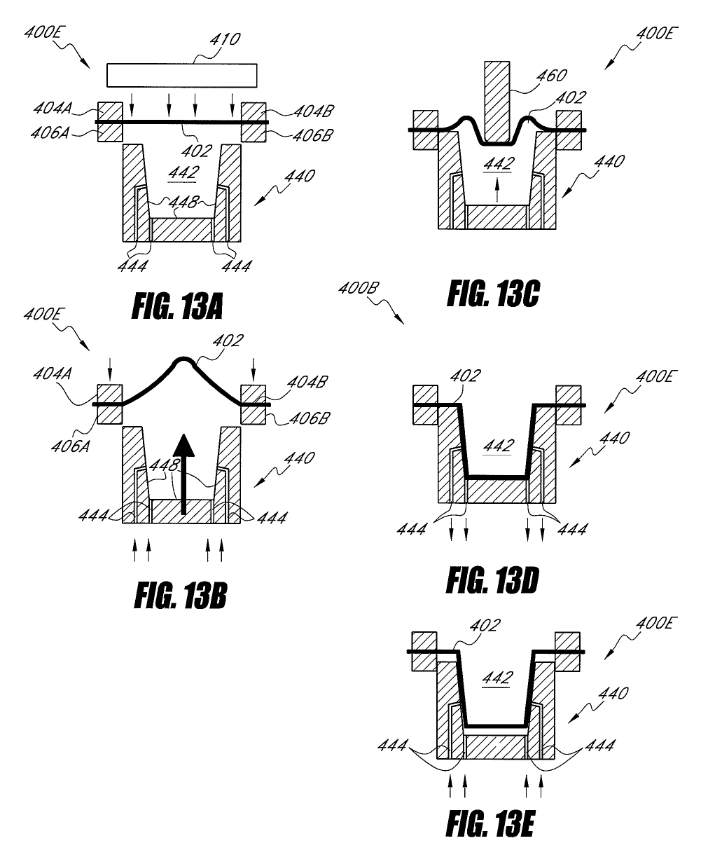

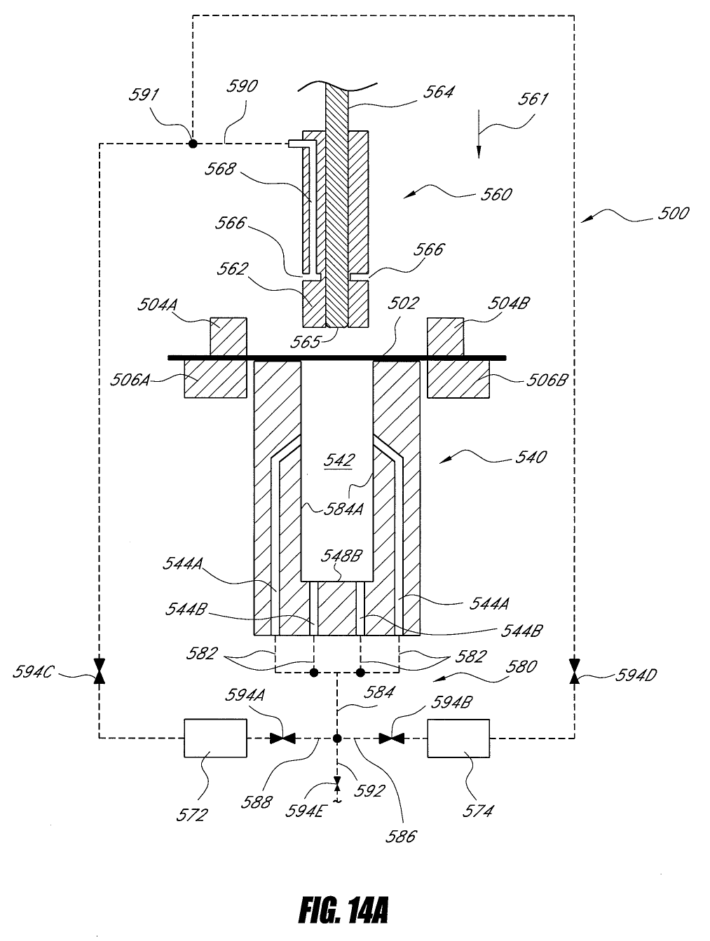

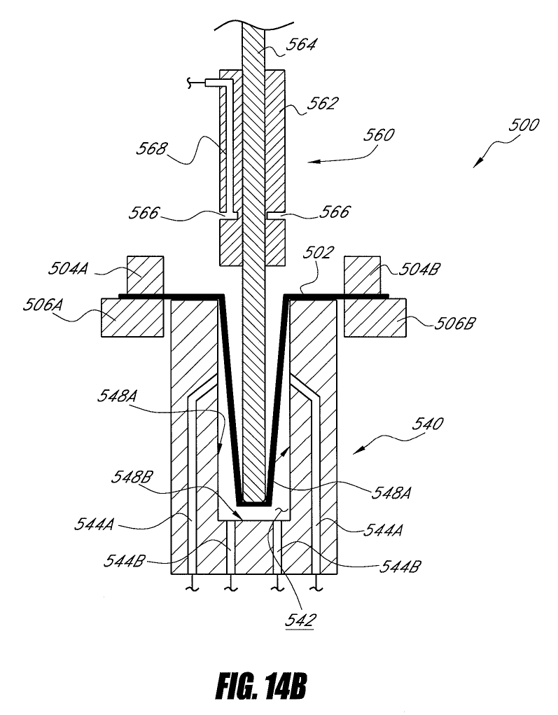

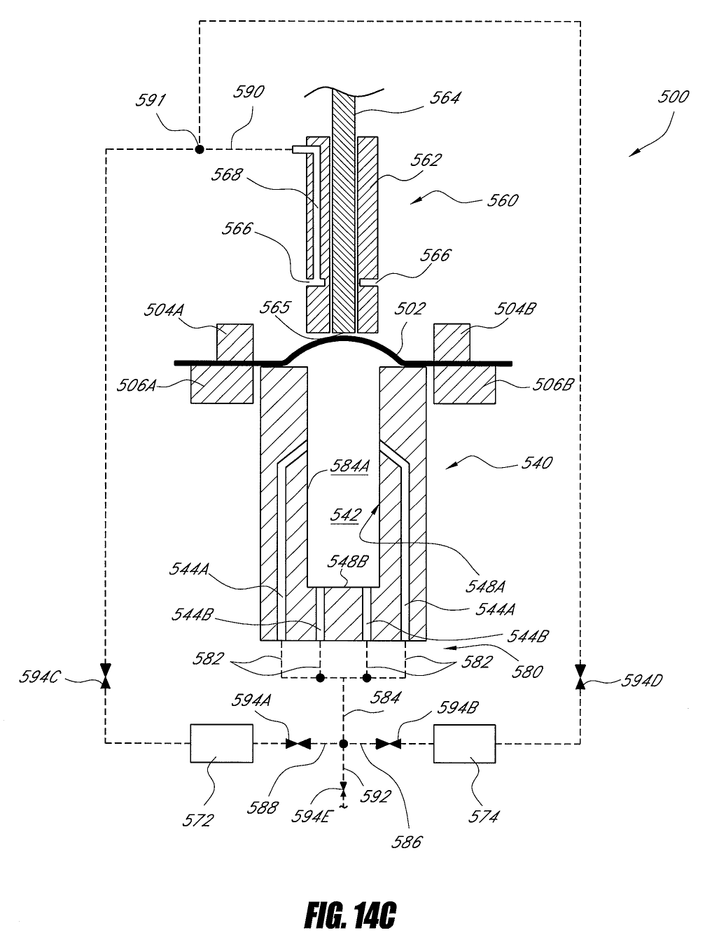

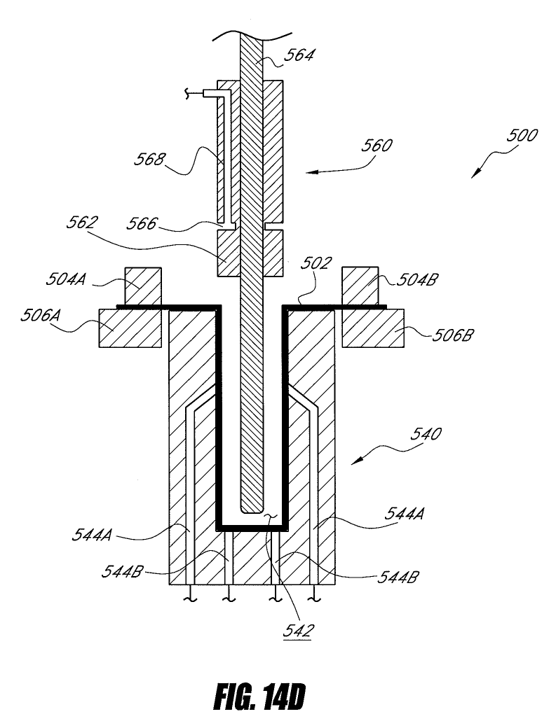

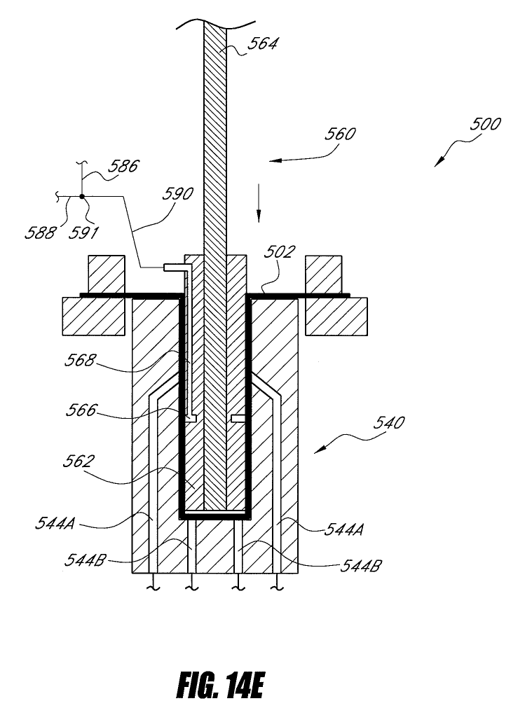

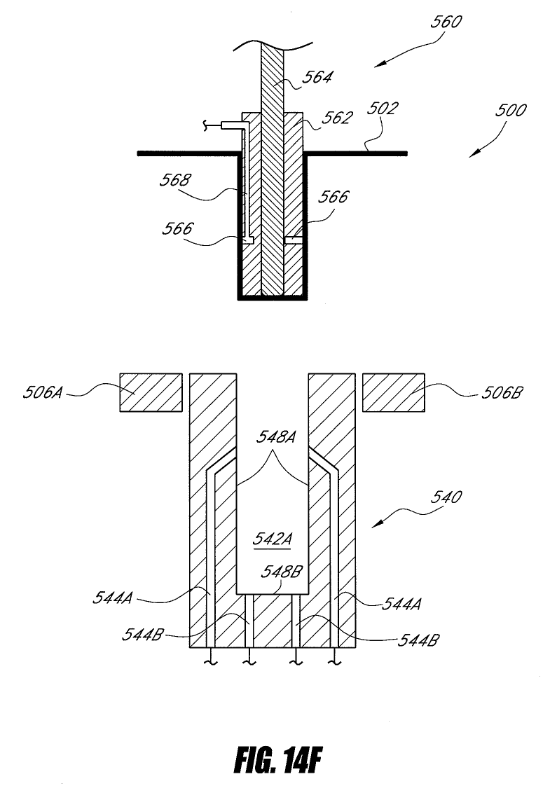

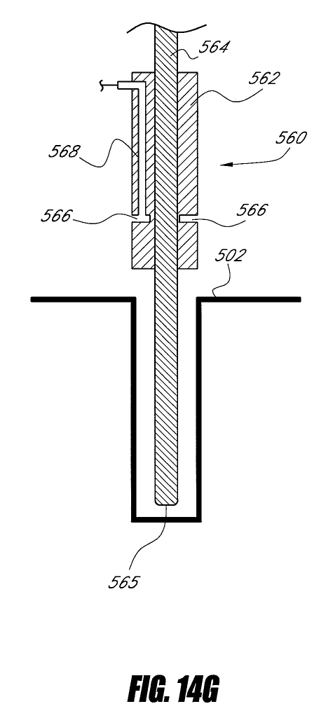

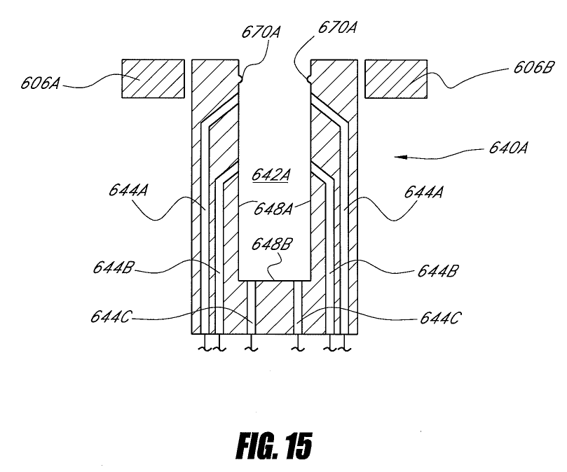

Another embodiment of a thermoforming apparatus 400D is illustrated in FIGS. 12A through 12E. With reference to FIG. 12A, the thermoforming apparatus 400D comprises a cavity-type mold section 440 having its molding surfaces 448 along an interior cavity 442. In addition, similar to other arrangements described herein, the apparatus 400D can include a heater 410, clamping members 404A, 404B, 406A, 406B, and/or one or more channels 444 disposed in the body of the mold section 440. In order to further assist in forming the sheet 402 within the cavity of the mold section 440, the apparatus can also comprise one or more mandrels 460, plugs and/or other similar members.

As used herein, the term “mandrel” is a broad term and is used in accordance with its ordinary meaning and may include, without limitation, any member configured to apply a force or pressure, either directly and/or indirectly, on a thermoformable sheet, solid, preform or other moldable item. The terms “mandrel,” “core,” “plunger” and “plug” are used interchangeably herein.

In FIG. 12B, after the sheet 402 has been properly heated and positioned over the cavity mold section 440, a mandrel 460 can be directed toward the sheet 402. In some embodiments, the leading surface 462 of the mandrel 460 which contacts the sheet 402 is generally curved to reduce the risk of puncturing, tearing and/or otherwise damaging the sheet 402. For example, in FIG. 12F, the leading surface 462 of the mandrel 460 is generally rounded to more evenly distribute the stresses applied to the sheet 402. In other embodiments, the mandrel 460 may have one or more other shapes other than circular. For example, the mandrel 460 can comprise a generally flat leading surface 462 with rounded edges. Alternatively, the leading surface 462 can be curvate, elliptical, oval, polygonal, multifaceted, conical, frusto-conical, frusto-spherical or any other shape.

With continued reference to FIG. 12B, the mandrel 460 can be configured to urge the sheet 402 toward the cavity 442 of the mold section 440. The mold section 440 may be moved in a direction opposite of the mandrel 460, either in lieu of or in addition to moving the mandrel 460 toward the cavity 442. In one embodiment, the mandrel 460 and the mold section 440 are simultaneously moved toward each other. In other embodiments, the mandrel 460 and/or the mold section 440 are stationary. In yet other embodiments, although both the mandrel 460 and the mold section 440 are configured to move toward one another during a thermoforming cycle, their movements do not exactly overlap. For example, while the mandrel 460 is moving, the mold section 440 can be stationary, or vice versa. Alternatively, a particular thermoforming cycle can be configured to have time periods when both the mandrel 460 and the mold section 440 are moving, and other time periods when either the mandrel 460 or the mold section 440 is stationary.

As illustrated in FIGS. 12B and 12C, as the mandrel 460 begins to urge the sheet 402 into the cavity 442, air or other fluid can be conveyed, either continuously or intermittently, from within the cavity 442 through the channels 444. In one embodiment, the mandrel 460 is lowered to a substantial depth of the cavity 442, thereby urging the sheet 402 to either contact or come very close to contacting the molding surface 408 which defines the bottom of the cavity 442. Alternatively, the mandrel 460 can be lowered about half-way into the cavity 442. In other embodiments, the mandrel 460 is lowered more or less than half-way into the cavity 442. For example, the mandrel 460 can be lowered to more than about 50%, 55%, 60%, 65%, 70%, 75%, 80%, 85%, 90%, 95%, 98%, 99%, or ranges encompassing such percentages of the depth of the cavity 442. In yet other embodiments, the mandrel 460 can be lowered to less than about 50%, 45%, 40%, 35%, 30%, 25%, 20%, 15%, 10%, 5%, 3%, 1%, or ranges encompassing such percenta the depth of the cavity 442. In still other embodiments, the mandrel 460 does not actually enter into the cavity 442 at all.

Lowering the mandrel 460 after contact with the sheet 402 can cause the sheet to stretch. Whether or not the sheet 402 stretches and/or the extent to which it stretches can depend on one or more factors, such as, for example, the sag of the sheet 402 after heating, the depth of the cavity 442, the depth to which the mandrel 460 is lowered, the dimensions of the mandrel 460, the material properties and other characteristics of the sheet 402 and/or the like. After the mandrel 460 has descended to a desired depth, it can be moved away from the cavity 442. As illustrated in FIG. 12D, a vacuum or suction created by removing the air from within cavity through the channels 444 can urge the sheet 402 toward the molding surfaces 448. As discussed, the thermoformed sheet 402 can be removed from the cavity 442 by moving the mold section 440 relative to the sheet 402. In some embodiments, removal can be facilitated by using one or more mechanical separation methods, by delivering a volume of air to the cavity through the channels 444 and/or by utilizing any other suitable devices and/or methods.

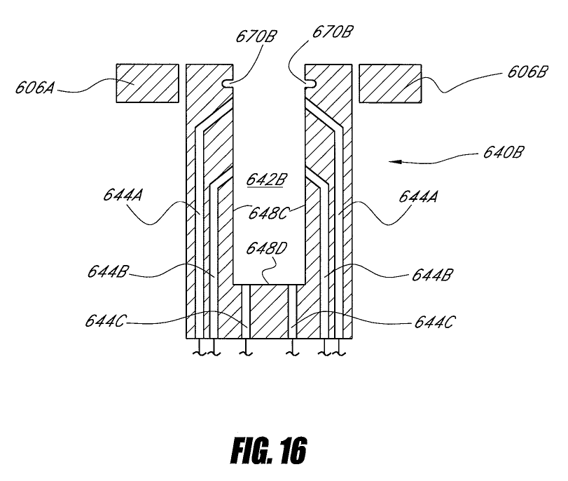

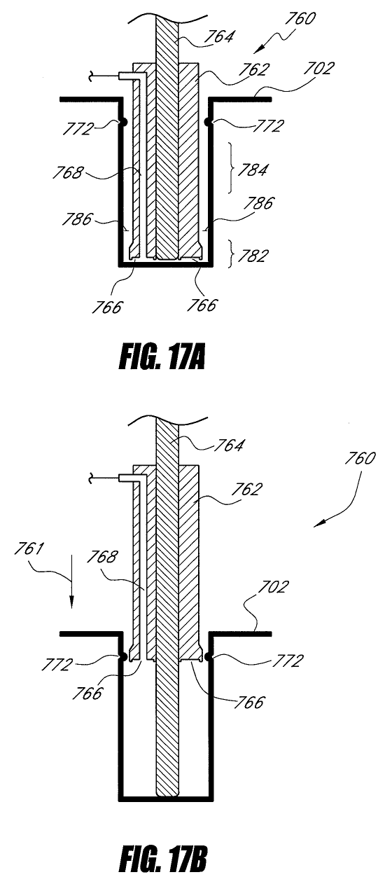

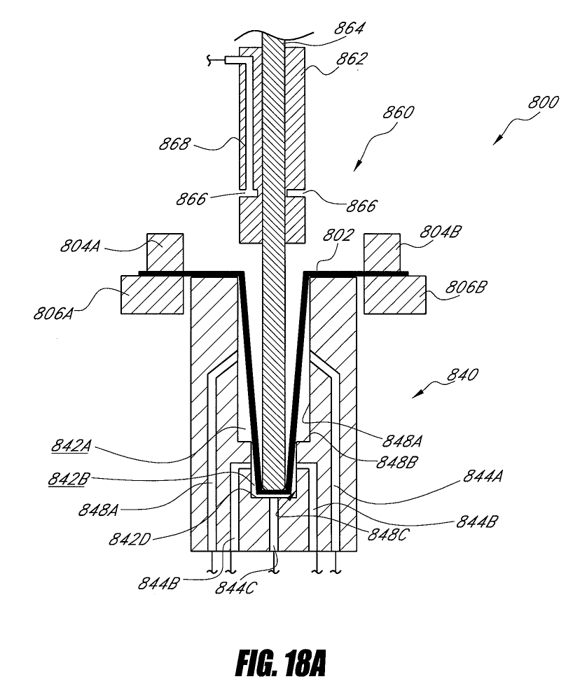

FIGS. 13A through 13E illustrate another embodiment of mold section 440 comprising a mandrel 460. The illustrated variation involves the use of pre-stretching before and/or while the mandrel 460 is lowered into the cavity 442 of the mold section 440. As shown in FIG. 13B, air or other fluid can be delivered to the underside of the sheet 402, causing it to move upwardly and/or stretch. In FIG. 13B, the stretched sheet 402 is shown having a generally bell shape. However, it will be appreciated that in other embodiments, the shape of the stretched sheet 402 can vary. For example, the sheet 402 can be stretched into a dome shape, a hemispherical shape and/or any other shape. As discussed above with reference to the embodiment illustrated in FIG. 11C, the extent to which the sheet 402 is stretched can be related to the total area of the molding surfaces 448 which the sheet 402 will ultimately contact and/or one or more other factors or considerations.

In some embodiments, the air stretching process causes the sheet 402 to stretch in a way such that the thickness of the stretched sheet 402 is substantially uniform throughout the some or all of the sheet 402. With continued reference to FIG. 11B, a volume of air or other fluid which is conveyed to the underside of the sheet 402 can be conveyed through one or more of the channels 444 and/or any gaps existing between the mold section 440 and the clamping members 404A, 404B, 406A, 406B. Preferably, the apparatus 400E is configured to regulate the stretching in the sheet 402 by controlling the temperature of the sheet 402, the flow rate, pressure, temperature and other properties of the fluid used to stretch the sheet 402, the time period during which the fluid is delivered to the underside of the sheet 402 and/or the like.

With reference to FIG. 13C, a mandrel 460 can be lowered and/or the mold section 440 can be raised so that the mandrel 460 contacts the stretched sheet 402 to urge it towards the cavity 442. After the mandrel 460 has lowered the sheet 402 to a desired depth within the cavity 442, it can be moved away from the mold section 440. As illustrated in FIG. 13D, application of a vacuum within the cavity 442 can help urge the sheet 402 against one or more of the molding surfaces 448 of the mold section 440. The thermoforming methods described above involving the use of a mold, a mandrel and a pre-stretching step can be referred to as “vacuum thermoforming with pre-stretching and plug assist.” This thermoforming method, and other similar or dissimilar variations thereof, can be particularly helpful in manufacturing items having long and/or narrow shapes. As described herein with respect to other embodiments, the mandrel 460 can advantageously comprise integrated fluid channels configured to convey air or other fluids. In some embodiments, a mandrel 460 includes two or more independently moving portions. In other embodiments, the sheet 402 is unevenly heated to vary the stretchability and/or the thickness in one or more areas of the sheet 402.

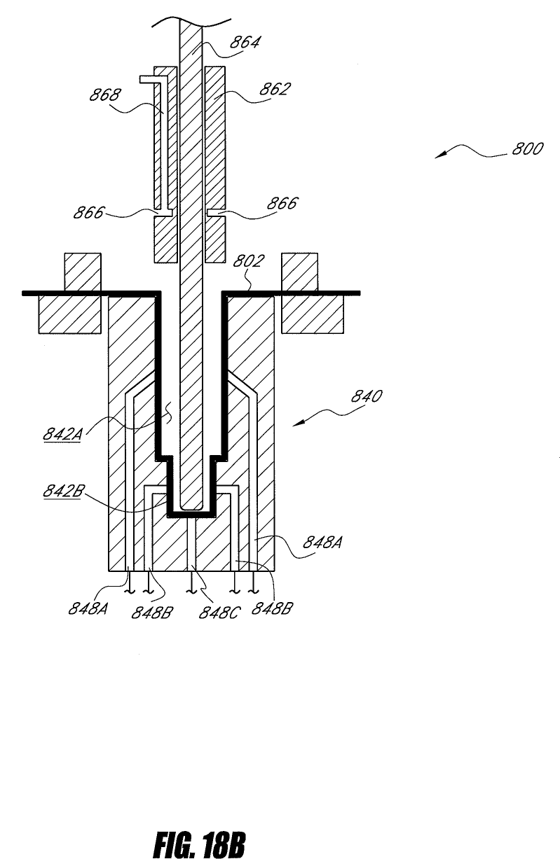

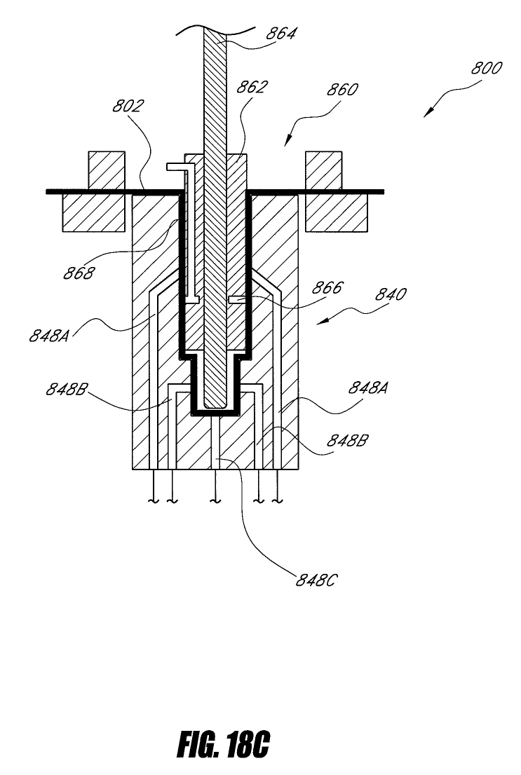

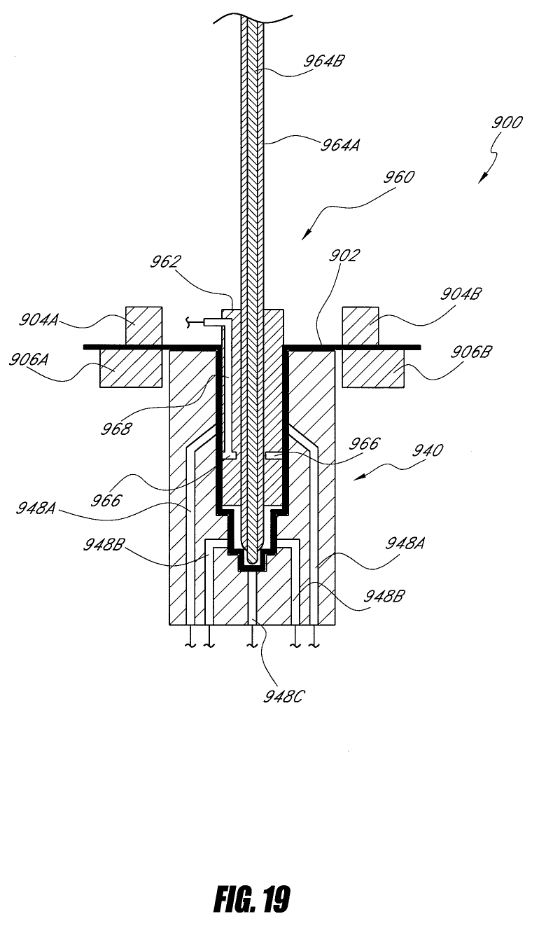

FIGS. 14A through 14G schematically illustrate another embodiment of a thermoforming apparatus 500 for producing a polymeric product, such as, for example, a cup-shaped portion of a two-piece container, as described above. As shown, the thermoforming apparatus 500 can include a cavity-type mold section 540 having molding or forming surfaces 548A, 548B that define a cavity 542. In FIG. 14A, the cavity 542 of the mold section 540 has a generally cylindrical shape. Since the polymeric sheet 402 will form along the molding surfaces 548A, 548B, and thus, take the shape of the cavity 540, the illustrated embodiment is particularly useful for thermoforming cylindrical cup-shaped objects. However, the cavity 540 can have a different shape and/or dimensions. For example, the cavity 542 of the mold section 540 can have a square, rectangular, other polygonal, elliptical, oval or any other suitable shape. Thus, the configuration of one or more molding surfaces 548A, 548B defining a cavity 540 can be customized according to the desired shape of the formed product. In addition, as discussed in greater detail herein, the cavity 540 can be modified so that the final thermoformed product includes one or more of the following: a draft angle, a diameter or opening size that varies with depth, a coupling structure, other aesthetic or functional features, rounded edges and/or the like. In some embodiments, a coupling structure includes a projection, protuberance, flange, indentation, recess and/or the like. As discussed, such coupling structures can be configured to engage a closure to seal, cover or cap the thermoformed cup.

In addition, as discussed in earlier embodiments disclosed herein, one or more portions of the mold section 540 can comprise a high heat transfer material, as discussed and defined herein. The use of such materials can enhance the heat transfer properties of the system, permitting for better cooling and temperature control of the thermoformed items. In addition, although not illustrated, the mold section 540 can advantageously comprise one or more cooling channels, which are configured to receive cooled water or any other cryogenic or non-cryogenic fluid, either in lieu of or preferably in addition to the use of high heat transfer materials.

The illustrated cavity mold section 540 can comprise one or more channels that are configured to be fluid communication with the cavity 542. For example, in FIG. 14A, the mold section 500 includes a total of four channels. In the depicted embodiment, two channels 544A are in fluid communication with a side molding surface 548A of the cavity 542, while the other two channels 544B are in fluid communication with a bottom molding surface 548B of the cavity 542. However, it will be appreciated that, in other embodiments, a mold section 540 can include more or fewer channels than illustrated and described herein. Further, the channels can be in fluid communication with any portion of the cavity 542. In order to minimize possible interference with the shape of the molding surfaces 548A, 548B, the channels preferably comprise relatively small openings. In addition, the channels are preferably flush with the molding surfaces 548A, 548B of the cavity 542.

With continued reference to FIG. 14A, the channels 544A, 544B are in fluid communication with one another by virtue of the illustrated hydraulic arrangement. More specifically, the channels 544A, 544B are connected to a manifold system 580 which, as illustrated, connects conduits 582 extending from the channels 544A, 544B in a series configuration. In FIG. 14A, the conduits 582 are in fluid communication with a single header conduit 584 which is configured to direct a fluid into the channels 544A, 544B from a plurality of directions. In addition, this single header conduit 584 can be configured to convey a fluid out of the channels 544A, 544B, and into one or more other conduits. For example, fluid can be directed into the channels 544A, 544B from a fluid supply device 574 via line 586. Further, fluid may be directed into the same channels 544A, 544B from a different source which is in fluid communication with line 592, either in lieu of or in addition to fluid originating from the fluid supply device 574.

As used herein, the term “fluid network” is a broad term and is used in accordance with its ordinary meaning and may include, without limitation, a plurality of pipes, tubing, conduits, other conveyance lines, valves, fluid delivery and section devices, junctions, fittings, inlets, outlets, channels and the like. The various components of the fluid network can be in direct or indirect fluid communication with each other or one or more other components of the system. The terms “fluid network” and “hydraulic network” are used interchangeably herein.

As illustrated in FIG. 14A, line 584 can be placed in fluid communication with line 586, line 588 and/or line 592, depending on the desired flow scheme through the channels 544A, 544B. In some embodiments, the illustrated thermoforming apparatus 500 includes a fluid supply device 574 which can be configured to provide compressed air or other fluids to line 586. A fluid supply can comprise an air compressor or a similar device capable of imparting a positive pressure on a fluid. Further, the apparatus 500 can also include a fluid suction device 572 which is configured to draw air or other fluids toward it. In some embodiments, the removal of a fluid can create at least a partial vacuum from the location where the fluid was removed. Fluid suction devices can include a diaphragm pump, a positive displacement pump and/or any other mechanical, electrical or pneumatic device.

With continued reference to FIG. 14A, valves 594A, 594B, 594C, 594D can be provided on either side of both the fluid supply device 574 and the fluid suction device 572 to better regulate fluid flow through the system. In some embodiments, the valves 594A, 594B, 594C, 594D are capable of modulation in order to control downstream and/or upstream flow and/or pressure of the fluid being conveyed through the channels 544A, 544B and any other hydraulic channel or line of the interconnected fluid network. As described in greater herein, one or more lines of the fluid network can also be connected to conduits or lines positioned in other parts of the thermoforming apparatus 500, such as for example, a channel 568 within the mandrel 560. In addition, the fluid network may include one or more vent lines that may place all or part of the fluid network in fluid communication with the ambient air. For example, in FIG. 14A, line 592 can be in fluid communication with the ambient air when valve 594E is open. It will be appreciated that a thermoforming apparatus can include fluid networks that are more or less intricate than the embodiments described herein. For example, a single fluid network may comprise two or more fluid supply devices and/or fluid suction devices. In other embodiments, the fluid network can include more or fewer valves, lines, channels, fittings, interconnections and/or the like.

With continued reference to FIG. 14A, the illustrated thermoforming apparatus 500 can be configured to receive a polymeric sheet 502 between a set of upper clamping members 504A, 504B and a set of lower clamping members 506A, 506B. In some embodiments, the clamping members apply a minimum pinching force on the sheet 502 so as to adequately maintain the pinched portions between the adjacent clamping members during normal operation of the thermoforming device 500. In some embodiments, the set of upper clamping members 504A, 504B or the set of lower clamping members 506A, 506B may be incorporated into a support structure or other portion of the thermoforming apparatus 500. In the illustrated embodiment, the center portion of the sheet 502 is positioned over the cavity 542 of the molding section 540 in preparation for the thermoforming procedure. As illustrated, the lower clamping members 506A, 508A are substantially flush with the top surface of the mold section 540 so that the sheet 502 is either contacting or is in very close proximity with the mold section 540. Alternatively, the vertical position of the sheet 502 relative to mold section 540 can be varied so that the distance between the sheet 502 and the top of the cavity 542 is greater or less than depicted in FIG. 14A.

In some embodiments, in order to provide it with the necessary elasticity for thermoforming, the sheet 502 is heated or otherwise softened. As discussed herein in relation to other embodiments, the sheet 502 can be heated before, during and/or after being placed in the position illustrated in FIG. 14A. Thus, one or more heaters may be required to heat the sheet 502 to the desired temperature.

The thermoforming apparatus 500 can also include a mandrel 560 that is configured to apply a force to the sheet 502 in the direction generally towards the cavity 542. As discussed in greater detail below, the mandrel 560 can also be used to remove the thermoformed sheet 502 from the mold section 540. In FIG. 14A, the mandrel 560 comprises an outer casing 562 and an interior mandrel rod 564. As shown, the outer casing 562 can include a channel 568 that is in fluid communication with the fluid network of the thermoforming apparatus 500. Thus, air and/or other fluids may be delivered to and from the channel 568, depending on how the fluid network is operated. It will be appreciated that the mandrel 560 can comprise additional channels located within the outer casing 562 and/or the mandrel rod 564.

Further, the outer casing 562 can comprise an annular groove 566 which is fluid communication with the channel 568. In the depicted embodiment, the outer casing 562 includes only a single annular groove 566 which has a generally rectangular cross-sectional shape and is located near the bottom portion of the outer casing 562. Further, the annular groove 566 is disposed around the entire perimeter of the outer casing 566. In other embodiments, however, the groove 566 may have a different cross-sectional size and/or shape, and may be located in a different portion of the outer casing 562. In addition, two or more annular grooves can be included in a single outer casing 562. In some embodiments, the outer casing 562 is selectively movable toward the cavity 542 of the mold section in the direction represented by arrow 561.

With continued reference to FIG. 14A, the shape of the leading surface 565 of the mandrel rod 564 can be configured to reduce the risk of and/or avoid tearing, puncturing and/or otherwise damaging the sheet 502 which it contacts. For example, the leading surface 565 of the mandrel rod 564 can be rounded, curvate, elliptical, oval, polygonal, multifaceted, conical, frusto-conical, frusto-spherical or any other shape. Like the outer casing 562 of the mandrel 560, the mandrel rod 564 can be moved longitudinally in the direction represented by arrow 561. In other embodiments, the mold section 540 can be configured to move toward the mandrel 560, either in lieu of or in addition to the mandrel 560 moving toward the mold section.

In some embodiments, the mandrel rod 564 is capable of being moved relative to and independently of the adjacent outer casing 562. This permits the mandrel rod 564 to be lowered into the cavity 542 while the outer casing 562 remains in a stationary position.

In some embodiments, an initial step for thermoforming a sheet 502 includes a mandrel-assisted stretching phase. In FIG. 14B, as the mandrel rod 564 is lowered toward the mold section 540, the leading surface 565 of the mandrel rod 564 engages a central portion of the sheet 502 and urges it into the cavity 542 of the mold section 540. As illustrated, the outer casing 562 of the mandrel 560 can remain stationary relative to the mandrel rod 564 as the mandrel rod 564 is lowered within the cavity 542. Alternatively, one or more pre-stretching steps can precede the mandrel-assisted stretching depicted in FIG. 14B.

One embodiment of pre-stretching the sheet 502 is illustrated in FIG. 14C. Before the mandrel rod 564 is lowered towards the cavity 542, air or other fluid is delivered into the cavity 542 through one or more of the channels 544A, 544B. Consequently, the pressure within the cavity 542 is increased and the sheet 502 can be stretched out generally away from the molding surfaces 548A, 548B of the mold section 540. The extent to which the sheet 502 stretches can depend on one or more factors, such as, for example, the sheet material, sheet temperature, sheet thickness and other dimensions, other sheet properties, the flow rate of fluid into the cavity 542 and the resulting increase in cavity pressure, the time duration of the pre-stretching phase, the dimensions of the mold section 540 and cavity 542, the spacing between the clamped portions of the sheet 502 and/or the like. In some embodiments, the amount of pre-stretching is carefully monitored and controlled to ensure that it is maintained within a desired range.

With reference to FIG. 14C, delivery of fluid into the cavity 542 for purposes of pre-stretching requires that valve 594B remain open and valves 594A, 594D and 594E remain closed. Thus, fluid generated by the fluid supply device 574 can be conveyed through lines 586 and 584, and distributed into the various channels 544A, 544B by the manifold system 580. If the thermoforming procedure includes a pre-stretching stage, the lowering of the mandrel rod 564 could follow. The delivery of fluid into the cavity 542 can either continue or cease once the mandrel rod 564 begins descending toward the sheet 402. In some embodiments, the mandrel rod 564 directs the pre-stretched sheet 502 in a generally opposite direction of the movement of the mandrel rod 564, toward the cavity 542 of the mold section. In such embodiments, however, since the sheet 502 was initially stretched, the stretching caused by the mandrel rod 564 can be eliminated or reduced. Typically, pre-stretching processes, like those described herein, can enable the various portions of a heated sheet to stretch more uniformly. Therefore, pre-stretching of the sheet 502 can advantageously provide more uniform thickness distribution in the molded product.

When the mandrel rod 564 has reached a desired position relative to the cavity 542, air or other fluid remaining between the molding surfaces 548A, 548B and the sheet 502 can be removed through one or more mold section channels 544A, 544B. In some embodiments, removal of this fluid can create a vacuum, whereby the sheet 502 is urged towards the molding surfaces 548A, 548B of the mold section 540. According to some embodiments, the fluid suction device 572 is activated, valve 594A is opened and valves 594B, 594C and 594E are closed in order to create a vacuum in the cavity 542. As depicted in FIG. 14D, the resulting reduction in pressure between the sheet 502 and the molding surfaces 548A, 548B can causes the sheet 502 to stretch and/or otherwise re-orient until it conforms to the shape of the cavity 542 as defined by the molding surfaces 548A, 548B. Once the sheet 502 cools to a sufficient temperature, it can become more rigid, allowing it to maintain its thermoformed shape.

In some embodiments, one or more surfaces or other portions of the mold sections and/or the mandrel portion discussed herein comprise a high heat transfer material. In some embodiments, the high heat transfer material has a thermal conductivity greater than the thermal conductivity of iron. In other embodiments, the mold sections discussed and illustrated herein comprise one or more temperature control channels through which a cooling, heating or other type of fluid can be conveyed to provide a desired level of temperature control of the mold section and the item being molded. Such temperature control channels can be included either in lieu of or in addition to the use of high heat transfer materials. Consequently, the mold sections and the thermoformed items (e.g., cups, etc.) can be cooled at an advantageously faster rate.

As used herein, the term “high heat transfer material” is a broad term and is used in accordance with its ordinary meaning and may include, without limitation, low range, mid range, and high range high heat transfer materials. Low range high heat transfer materials are materials that have a greater thermal conductivity than iron. For example, low range high heat transfer materials may have a heat conductivity superior to iron and its alloys. High range high heat transfer materials have thermal conductivity greater than the mid range materials. For example, a material that comprises mostly or entirely copper and its alloys can be a high range heat transfer material. Mid range high heat transfer materials have thermal conductivities greater than low range and less than the high range high heat transfer materials. For example, AMPCOLOY® alloys, alloys comprising copper and beryllium and/or the like can be mid range high heat transfer materials. In some embodiments, the high heat transfer materials can be a pure material (e.g., pure copper) or an alloy (e.g., copper alloys). Advantageously, high heat transfer materials can result in rapid heat transfer to reduce cycle times and increase production output. For example, the high heat transfer material at room temperature can have a thermal conductivity more than about 100 W/(mK), 140 W/(mK), 160 W/(mK), 200 W/(mK), 250 W/(mK), 300 W/(mK), 350 W/(mK), and ranges encompassing such thermal conductivities. In some embodiments, the high heat transfer material has a thermal conductivity 1.5 times, 2 times, 3 times, 4 times, or 5 times greater than iron.

In some embodiments, during the mandrel-assisted stretching phase, the mandrel rod 564 is lowered to a depth higher or lower than those illustrated in FIGS. 14B and 14D. In addition, the mandrel rod 564 can either remain within the cavity 542 or be withdrawn prior to or during the operation of the fluid suction device 572. Further, the diameter and/or other dimensions of the mandrel rod 564 can vary depending on the specific thermoforming procedure being utilized.

Once a sheet 502 has been thermoformed and sufficiently cooled, it can be removed from the cavity 542 of the mold section 540. FIGS. 14E through 14G illustrate one embodiment of separating a thermoformed product from the thermoforming apparatus 500. As illustrated in FIG. 14E, the outer casing 562 can also descend into the cavity 542 until it reaches a particular depth. In one embodiment, the outer casing 562 is lowered until its bottom surface is flush with the leading surface 565 of the mandrel rod 564. In order to avoid any obstruction or other interference with the thermoformed sheet 502, the outer casing 562 can preferably have an outside diameter which is slightly smaller than the inner diameter of the thermoformed sheet 502. Therefore, the outer casing 562 can be lowered into the cavity 542 without damaging the newly formed product. At this point, valves 594A and 594D can be closed while valve 594C can be opened (FIGS. 14A and 14C). If a fluid suction device 572 is activated, a volume of fluid existing between the thermoformed sheet 502 and the outer casing 562 can be channeled through the annular groove 566, and into the mandrel channel 568 and lines 590 and 588. Consequently, in some embodiments, a vacuum is created at the annular groove 566 which causes the thermoformed sheet 502 to be drawn towards the outer casing 562.

In addition to or in lieu of creating a vacuum at the annular groove 566, a fluid supply device 574 (FIG. 14A) can be configured to deliver a volume of air or other fluid through the mold section channels 544A, 544B to lower mold adhesion and other forces between the molding surfaces 584A, 584B and the thermoformed sheet 502. In order to do so, the fluid supply device 574 can be activated, valve 594B can be opened and valves 594A, 594D and 594E can be closed. Alternatively, the adhesion forces between the walls of the cavity 542 and the sheet 502 may be reduced by placing the channels 544A, 544B in fluid communication with ambient air. For example, in FIG. 14A, valves 594A and 594B could be closed and valve 594E could be opened. Thus, in some embodiments where line 592 vents to the atmosphere, lines 584, the manifold system 580 and the mold section channels 544A, 544B are placed in fluid communication with the ambient air.

In some embodiments, the creation of a vacuum at the annular groove 566 can be used in conjunction with the delivery of fluid to the molding surfaces 548A, 548B (or venting to the atmosphere) as described above. In other embodiments, the vacuum force generated at the annular groove 566 may be adequate on its own to draw the thermoformed sheet 502 to the outer casing 562. The exact demolding steps that are taken can be customized for a particular application, taking into account one or more factors, such as, for example, the adhesion forces between the molding surfaces and the thermoformed products, the vacuum force generated at the outer casing, the diameter, height, thickness and other dimensions of the thermoformed product, the properties of the material(s) used to manufacture the sheet and/or the like.

With reference to FIG. 14F, after the thermoformed sheet 502 has been drawn onto a surface of the outer casing 562, the entire mandrel 560, including the outer casing 562 and the mandrel rod 564, may be removed from the cavity 542 of the mold section 540. Before the mandrel 560 is lifted, the clamping members which have restrained the sheet's outer edges during the thermoforming process can be configured to release the sheet 502. Preferably, the mandrel 560 is lifted to a minimum height so that the bottom of the thermoformed sheet 502 completely clears all portions of the mold section 540.

To separate the thermoformed sheet 502 from the outer casing 562, the mandrel rod 564 can be lowered as illustrated in FIG. 14G. In the depicted embodiment, the leading surface 565 of the mandrel rod 564 contacts the bottom of the thermoformed sheet 502 and urges it away from the outer casing 562. Consequently, the inner surface of the thermoformed sheet 502 slides relative to the outer surface of the outer casing 562, and is eventually removed from the mandrel 560. Before, during and/or after its separation from the outer casing 562, the thermoformed product (e.g., cup, cap, other container, etc.) can undergo additional processing. For example, portions of the thermoformed sheet 402 can be trimmed, shaped, attached to another portion (e.g., closure) and/or otherwise modified. In some embodiments, the thermoformed sheets are trimmed, filled with a beverage or other food item and fitted with a corresponding closure member and/or seal.

In addition, removal of the thermoformed sheet 502 from the mandrel 560 can be facilitated by administering a volume of air or other fluid through the annular grove 566. As a volume of air or other fluid is delivered to the interface between the outer casing 562 and the thermoformed sheet 502, it can help to separate the thermoformed sheet 502 from the mandrel 560. In order to deliver the air or other fluid to the annular groove 566, the fluid supply device 574 can be activated and the fluid suction device 572 can be deactivated. Further, the valve 594D can be opened and valves 594B and 594C can be closed. Thus, in the illustrated embodiment, fluid is transferred from one or more fluid supply devices 574 to the mandrel channel 568 via lines 586 and 590. If a sufficient fluid flow is provided to the annular groove 566, the thermoformed product may be ejected from the mandrel 560. In some embodiments, both the action of the mandrel rod 564 and the delivery of fluid to the annular groove 566 are used to remove the thermoformed product from the mandrel 560. This can result in more controlled removal of the thermoformed sheet from the mandrel 560. However, it will be appreciated that in other embodiments, the thermoformed product is removed from the mandrel 560 using only the action of the mandrel rod 564 or the delivery of fluid to the annular groove 566.

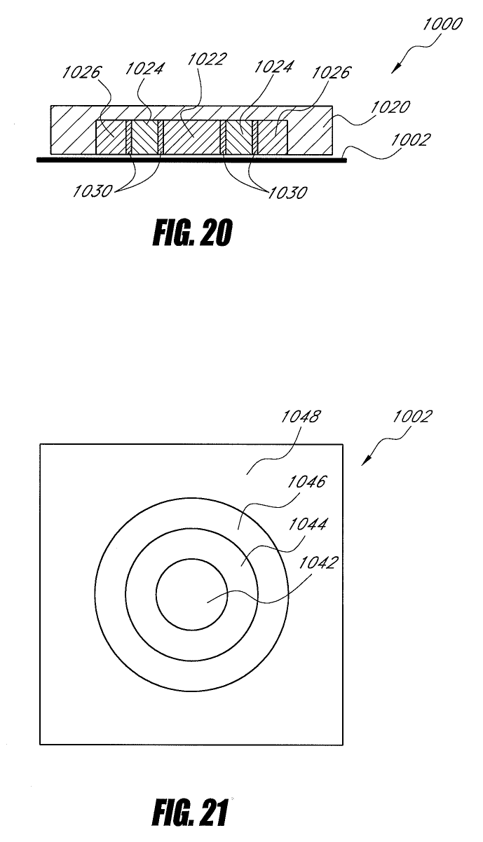

FIG. 15 illustrates another embodiment of a mold section 640A. In the depicted arrangement, the side molding surfaces 648A that define the cavity 642A include a projection member 670A. The projection member 670A can be annular so that it extends around the entire periphery of the cavity 642A. Alternatively, a projection member 670A can be configured to only intermittently extend into the cavity. Further, in other embodiments, two or more projection members 670A can be included in a single mold cavity 642A. The projection member 670A illustrated in FIG. 15 has a generally semicircular shape. However, it will be appreciated that such projection members can have any other shape, such as, for example, square, polygonal, oval, elliptical, triangular, multi-faceted, frusto-conical, frusto-spherical or the like. In addition, the one or more projection members 670A can be smaller or larger and/or can be positioned at a higher and/or lower cavity depth than illustrated and discussed herein.

In some embodiments, the projection member illustrated in FIG. 15 can be used to create a circumferential notch, recess, indentation and/or other coupling structure in the thermoformed product. As discussed, such coupling structures can provide an interface to which another member or portion (e.g., closure member) can engage and/or attach. For instance, as discussed above, a thermoformed cup can be manufactured with a particular coupling structure which is configured to accept a corresponding closure member (e.g., cap, lid, etc.).

FIG. 16 illustrates another embodiment of a mold section 640B which is similar to the mold section 640A depicted in FIG. 15. However, instead of having a projection member, the side molding surfaces 648C illustrated in FIG. 16 include a recessed portion 670B. The recessed portion 670B can advantageously form a flange or other positive coupling structure on a portion of a thermoformed product (not shown). As discussed with respect to FIG. 15, such coupling structures can be used to engage and/or attach closure members or other members to thermoformed products (e.g., cups, cans, etc.). A coupling structure can comprise any shape, size, dimension, orientation, location, spacing, position and/or other properties or characteristics. For example, the coupling structures can include one or more of the following: a protuberance, tab, indentation, flange, bump and/or the like. In addition, a coupling structure can be larger or smaller and/or may include a different orientation and position than illustrated in the embodiment of FIG. 16.

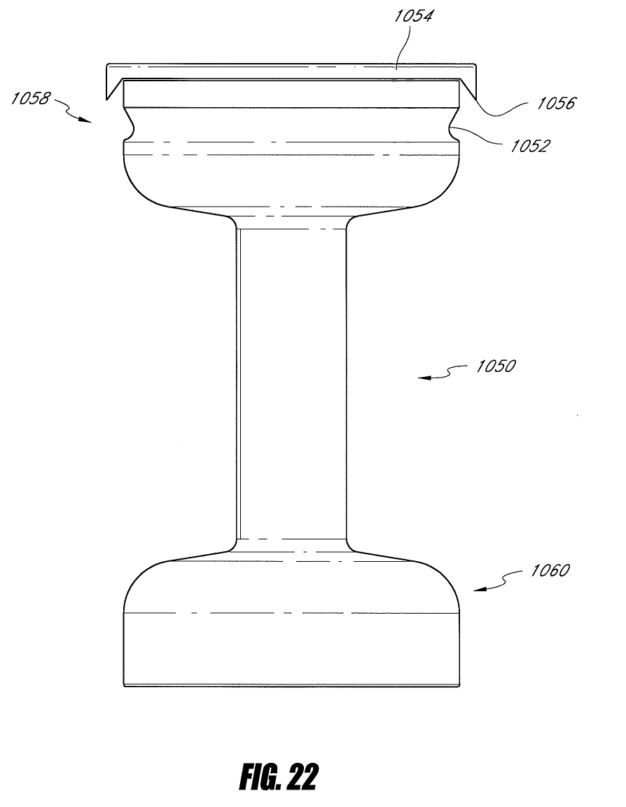

With reference to FIG. 17A, a mold section similar to that depicted in FIG. 15 can be used to create a cup-shaped thermoformed product having a circumferential notch 772 or other similar positive or negative feature along an upper portion of the thermoformed product. As discussed herein, such coupling structures 772 can be used to provide an attachment interface between the thermoformed product (e.g., a cup, can, other container, etc.) and a closure member or other item. In the illustrated embodiment, the mandrel 760 on which the thermoformed product is positioned has a varying diameter along its vertical length. More specifically, the outer diameter of a lower portion 782 of the mandrel 760 is greater than the outer diameter of an upper portion 784. In certain embodiments, the outer diameter of the lower portion 782 is only slightly smaller than the inner diameter of the thermoformed sheet 702. However, in other arrangements, the difference in outer diameter along the mandrel 760 can be greater, smaller and/or otherwise different than illustrated and discussed herein. For example, in some embodiments, the outer diameter of an upper portion of the mandrel 760 can be larger than the outer diameter of a lower portion of the mandrel 760.

With continued reference to FIG. 17A, the bottom of the outer casing 762 can include an annular groove 766 which is in fluid communication with the channel 768. Similar to the channel 568 discussed above in relation to FIGS. 14A through 14G, the channel 768 can be situated within the body of the outer casing 762 and/or be in fluid communication with the apparatus's fluid network. Thus, air or other fluid can be delivered to or from the annular groove 766 using a fluid supply or fluid suction device. If the annular groove 766 is connected to a fluid suction device, a vacuum may be generated between the bottom of the mandrel 760 and the bottom of the thermoformed sheet 702. As described in other embodiments herein, this can permit the mandrel to lift the thermoformed sheet 702 out of a mold section cavity.

As illustrated in FIG. 17A, dimensional differences created by the mandrel's varying outer diameter (e.g., between the lower portion 782 and the upper portion 784, along any other vertical portions of the mandrel 760, etc.) can create a circumferential gap 786 between the exterior surface of the outer casing 762 and the thermoformed sheet 702. In the depicted embodiment, since the annular groove 766 is located at or near the bottom of the mandrel 760, such a circumferential gap 786 can allow the lateral walls of the thermoformed product to move elastically in a lateral direction when the circumferential notch 772 is shifted from its original position during the removal process.

FIG. 17B illustrates the removal of the thermoformed sheet 702 from the mandrel 760. In some embodiments, the thermoformed sheet 702 is removed from the mandrel using ejection forces created by the delivery of fluid to the annular groove 766. As illustrated, however, removal of the thermoformed sheet 702 can also be performed by moving the mandrel rod 764 relative to the adjacent outer casing 762 in a direction represented by arrow 761, either in lieu of or in addition to the fluid ejection forces.

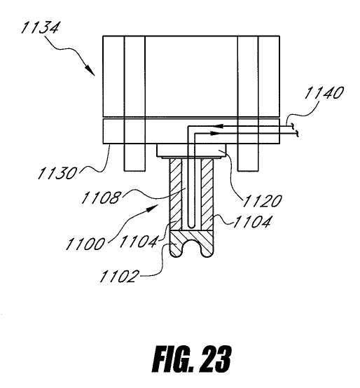

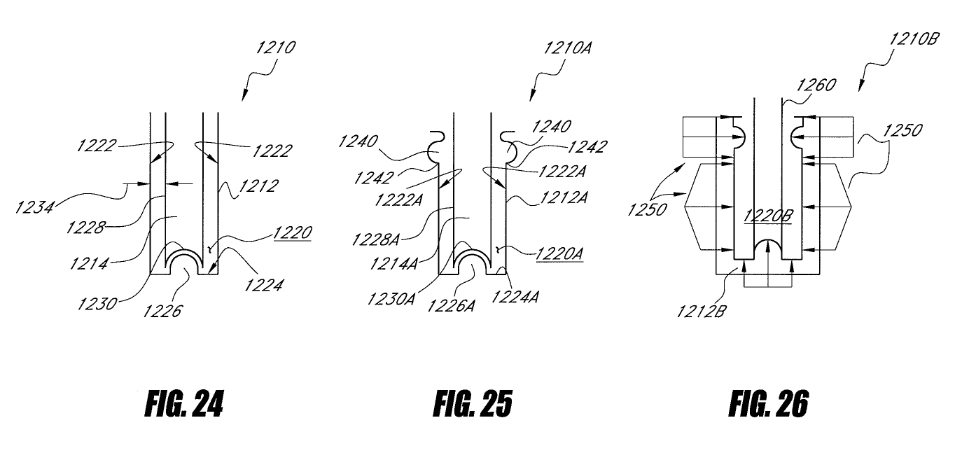

FIG. 18A illustrates a thermoforming apparatus 800 configured to produce bottle-shaped cups or containers and/or other similar objects. The mold section 840 comprises an inner cavity having two different diameters. In the depicted embodiment, the cavity includes an upper cavity portion 842A and a lower cavity portion 842B. As shown, the diameter of the upper cavity portion 842A is larger than the diameter of the lower cavity portion 842B. Alternatively, however, the mold section cavity can comprise additional (e.g., three, four, five or more) cavity portions of varying diameters. In addition, the cavity portions can have a different size, shape, location, spacing and/or orientation than illustrated herein. For example, a cavity portion with a smaller diameter can be included above a cavity portion having a larger diameter. In FIG. 18A, the lower cavity portion 842B can be used to form a bottleneck, a bottom surface and/or any other feature which has a different diameter than an adjacent portion of the thermoformed product.

The thermoforming apparatus 800 depicted in FIGS. 18A through 18C can operate in a generally similar manner as other apparatuses and systems described and illustrated above. For example, after an adequately heated or otherwise softened polymeric sheet 802 has been positioned over the mold section 840, the mandrel rod 864 of the mandrel 860 can move relative to the adjacent outer casing 862. Thus, in some embodiments, the mandrel rod 864 contacts the sheet 802 and urges it into the cavity of the mold section 840. The mandrel rod 864 can be lowered to any cavity depth, as long as the diameter of the mandrel rod 864 is sufficiently smaller than the diameter of the cavity portion it is attempting to reach. For example, in the embodiment illustrated in FIGS. 18A through 18C, the mandrel rod 864 is capable of being lowered into both cavity portions 842A, 842B. However, it will be appreciated that other embodiments of mold sections may comprise cavity portions that are too narrow to accommodate the mandrel rod 864 together with the sheet 802 that it is contacting.

With reference to FIG. 18B, a vacuum created by air or other fluid being drawn out of the cavity portions 842A, 842B, can help urge the sheet 802 against the corresponding molding surfaces of the cavity portions 842A, 842B. After the thermoformed sheet 802 has adequately cooled, the outer casing 862 of the mandrel 860 can be lowered into the mold section 840. As discussed, one or more portions of the mold section 840 and/or the mandrel 860 can advantageously comprise a high heat transfer material (e.g., copper, copper alloys, beryllium, AMPCOLOY® alloys, etc.). In addition to or in lieu of the use of high heat transfer materials, the mold section can comprise one or more cooling channels through which cooling water or other fluid may be conveyed for heat transfer purposes.

As illustrated in FIG. 18C, the outer casing 862 can only descend to the bottom of the upper cavity portion 842A, as its diameter is too large for the lower cavity portion 842B. Nevertheless, a vacuum generated at the annular groove 866 of the outer casing 862 can help draw the thermoformed sheet 802 onto the mandrel 860 so that it can be removed from the mold section 840. It will be appreciated that the thermoformed sheet 802 can be removed from the mandrel using one or more of the devices and/or methods described herein. Further, in other embodiments, the mold section 840 can include a split mold design, which permits the manufacture of more complex shapes. For example, the mold section 840 can be formed by two or more separate portions which are configured to move away from one another. Such a feature can permit removal of thermoformed items that includes threads, flanges, protrusions, coupling structures, aesthetic or decorative elements and/or other features which may otherwise make removal difficult or impossible.

Another embodiment of a thermoforming apparatus 900 is illustrated in FIG. 19. As shown, the mandrel 960 can comprise an outer casing 962 and two interior mandrel rods 964A, 964B. The inner mandrel rod 964B, which is positioned concentrically within the outer mandrel rod 964A, can be configured so that it is capable of moving relative to and independent from both the outer mandrel rod 964A and the outer casing 962. Likewise, as shown in the illustrated embodiment, the outer mandrel rod 964A can be configured to move independently of both the inner mandrel rod 964B and the outer casing 962. Such a design can advantageously permit the mandrel 960 to urge a sheet 902 to deeper portions of the mold section cavity that otherwise may not be possible. As illustrated in FIG. 19, the inner mandrel rod 964B can be configured to reach the deepest and narrowest cavity portion when lowered. However, it will be appreciated that care should be taken when using a mandrel rod with a relatively small diameter and/or leading surface, because of the higher likelihood that that the mandrel rod 964B may puncture, tear, core and/or otherwise damage the sheet 902 being thermoformed.

In all the thermoforming embodiments described and illustrated herein, it is contemplated that a pre-stretching step, during which the heated or otherwise softened polymeric sheet is stretched away from the mold cavity, can be advantageously used to produce a more uniform thickness throughout some, most or all portions of the thermoformed product. In some embodiments, this can help reduce the localized stretching effects created by moving the mandrel against one or more surfaces of a moldable sheet.

Although the various thermoforming embodiments in this application are discussed only in terms of mono-layer sheets, it should be recognized that multi-layer sheets can also be thermoformed or otherwise molded using the apparatuses, systems and methods disclosed herein. In addition, those of skill in the art will appreciate that one or more coatings or layers may be applied to one or more surfaces of a polymeric sheet being thermoformed or otherwise shaped, either before, during and/or after the molding process. For example, formed products (e.g., thermoformed cups, cans, other containers, etc.) can comprise one or more layers or portions having one or more of the following advantageous characteristics: an insulating layer, a barrier layer, a foodstuff contacting layer, a non-flavor scalping layer, a high strength layer, a compliant layer, a tie layer, a gas scavenging layer, a layer or portion suitable for hot fill applications, a layer having a melt strength suitable for extrusion. In some embodiments, the thermoformed layer or layers comprise one or more of the following materials: PET (including recycled and/or virgin PET), PETG, foam, polypropylene, phenoxy type thermoplastics, polyolefins, phenoxy-polyolefin thermoplastic blends, and/or combinations thereof.

Moreover, as illustrated by the embodiment in FIG. 19, mandrel arrangements can comprise additional concentric casings and/or mandrel rods. Such additional features can create thermoformed products having more complex shapes, which, in some preferred embodiments, have a favorable wall thickness throughout the entire product body.

In some embodiments, the mandrel (or core) and/or the mold sections may not have a symmetrical configuration. In addition, a mandrel and/or a mold section can include straight or substantially straight walls. Further, a mandrel and/or mold section may comprise one or more undercuts. If such undercuts are relatively slight, demolding may be possible without the need for a split mold cavity design, as the elasticity of the formed product will enable it to be removed. If larger undercuts or similar shapes are desired, a split mold design may be incorporated into the cavity section.

Consequently, it may be possible to thermoform intricate cups, bottles and the like, regardless of shape, contours, threads, flanges, projections, coupling members, other features on the outside of the formed product, draft angle, diameter, depth, dimension and/or one or more other features or properties of the products being molded or thermoformed. For example, thermoforming can be used to produce a container, such as a bottle, with a tapered neck along its upper portion. In one embodiment, a slender core or mandrel rod can be used to move a sheet through a relatively narrow opening of the cavity section. In such arrangements, the core or mandrel rod can urge the sheet toward the bottom of the cavity, where the diameter of the mold is likely greater than the diameter at the top. Vacuum and/or pressure thermoforming methods can be used to urge the sheet against the molding surfaces of the cavity, either before, during and/or after the mandrel rod urges the sheet towards the bottom of the cavity. The split mold design could then be opened in order to remove the formed product. Such intricate designs, regardless of whether or not they are thermoformed in split molds, would be further facilitated and/or enhanced by using a heater comprising individualized heating zones, as discussed in greater detail below.

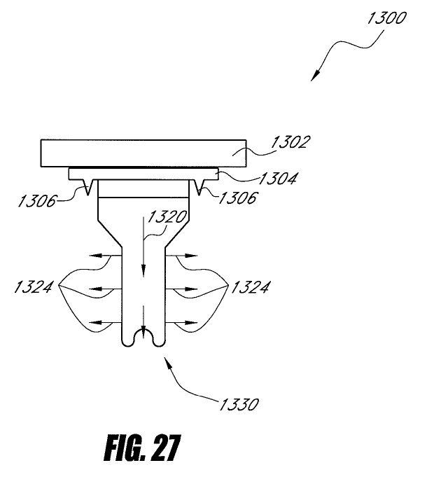

FIG. 20 illustrates a cross-sectional view of a heater 1000 or other device that is configured to heat or otherwise soften a sheet 1002 immediately prior to the thermoforming or other molding procedure. As shown, the heater 1000 can include two or more individual heating zones which are capable of maintaining an adjacent portion of a polymeric sheet or other item at a desired temperature or within a desired temperature range. In the illustrated embodiment, the heater 1000 comprises three concentric heating zones 1022, 1024, 1026. In some embodiments, each heating zone is thermally isolated from an adjacent heating zone by one or more insulating members 1030.

With continued reference to FIG. 20, an insulating member 1030 can include ceramic insulation, fiberglass, Styrofoam, air gaps and/or any other material or configuration. In some embodiments, the thickness of the insulating material can be minimized to avoid relatively cold portions on the heater 1000. The heating zones 1022, 1024, 1026 and the insulating members 1030 can be held together by a plate 1020, as shown in FIG. 20. Although the heating zones in the illustrated embodiment are concentric to one another, other configurations can also be used. For example, a heater may include other types of concentric shapes that are capable of individualized heating, such as, polygons, ovals, ellipses, triangles and the like. Alternatively, the heater 1000 may comprise non-concentric heating zones, where the heating surface is divided into a plurality of squares, polygons or other shapes. The number, size, shape, temperature range control and/or other characteristics of the zones can be varied depending on the desired heating effect desired in a particular application. In addition, the heater can include one or more temperature sensors and other temperature control components to better regulate the individual heating zones.

In operation, a sheet 1002 can be brought within a desired distance of the heater 1000, and selectively retained there for a predetermined time period. The sheet 1002 may or may not contact the heater 1000. For example, in the illustrated embodiment, the sheet 1002 is either contacting or immediately adjacent to the heater 1000. However, in other embodiments, the amount of heat discharged by the heater may require the sheet 1002 to be closer or further away from the heater 1000.

FIG. 21 schematically illustrates a sheet 1002 that has been heated using a heater 1000 similar to the one shown in FIG. 20. In one embodiment, the sheet 1002 comprises four regions with distinct temperatures and/or temperature ranges. The temperature of the innermost region 1042 of the sheet 1002 can be related to the corresponding heating zone 1022 of the heater 1000. Likewise, similar correlations can also be made between the other regions 1044, 1046, 1048 of the sheet 1002 and the corresponding to the individual heating zones of the heater 1000.

In some embodiments, the cup portion of the can or other beverage or foodstuff container can be de-molded, at least in part, by urging a portion of the thermoformed item on a mandrel. Thus, after “sticking” to the mandrel, the thermoformed cup can be removed from the cavity of the mold section. In some embodiments, the thermoformed cup or other item can effectively stick to a mandrel because of one or more factors, such as, for example, the incorporation of contours on the thermoformed items. For example, such contours can interact with the mandrel and hold the newly molded item in place during de-molding and shrinking or contracting of the plastic material onto the mandrel during cooling. In some embodiments, the cup portion can be removed from the mandrel using mechanically stripping or the like. Alternatively, the system can be designed to have the thermoformed item stick to or be retained by the cavity after removal of the mandrel and be mechanically stripped from the cavity. Such mechanical stripping or similar mechanical removal methods, apparatuses, systems and techniques can be used either in lieu of or in addition to the mandrel assist and/or pneumatic removal methods described herein with reference to FIGS. 8A through 19.

A negative or positive features or contour on the upper portion of the cup, such as, for example, a flange, notch, projection, protuberance, indentation, recess and/or the like, can facilitate positive stripping of the formed item from the mandrel, cavity or other mold portion. This can allows the manufacture of a wide range of products, such as those that are relatively difficult to produce, including items with a large diameter, a long draw, minimal draft (e.g., 1 degree or less, greater than 1 degree, etc.). After a formed item (e.g., thermoformed cup or other container) is removed from the mandrel or another portion of a mold, it can be engaged and/or picked up by post mold handling systems, such as robotics or conveying for further processing. In some embodiments, additional processing can include the application of one or more coats, exposure to additional cutting and/or shaping, exposure to surface treatment (e.g., plasma treatment) and/or the like.

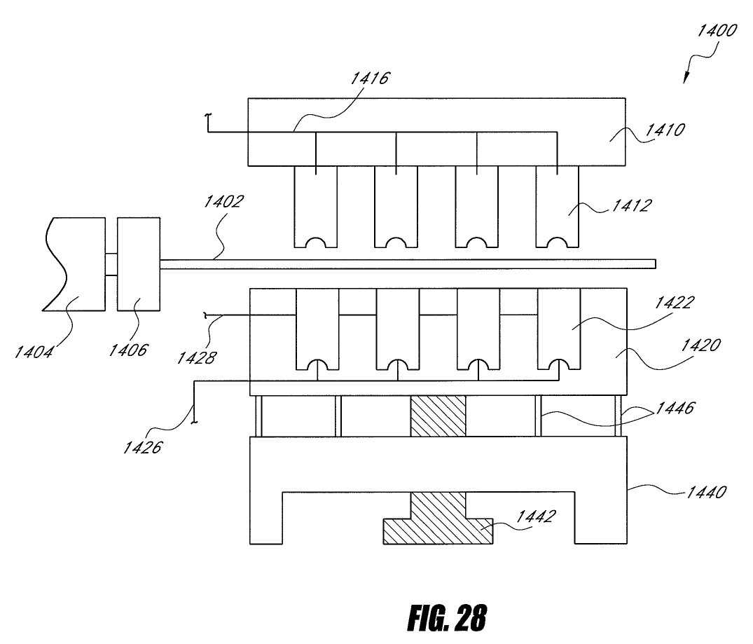

FIG. 22 illustrates one embodiment of a core or mandrel. In some embodiments, the illustrated mandrel 1050 or variations thereof can be used in lieu of a plug in a thermoforming system. The mandrel 1050 can include portions which help to form the upper 1058 and lower 1060 ends of a cup or other container. In the section which forms the upper portion of a cup or other container, the mandrel 1050 can comprise one or more protuberances, indentations and/or any other positive or negative feature as disclosed herein. The size, shape and general configuration of such features that form one or more coupling structures along the surface of thermoformed items can be varied to satisfy a particular application. These features can be consistent for the entire circumference of the mandrel. Alternatively, they may be located only on certain portions of the circumference of the mandrel 1050.

It will be appreciated that one or more protuberances, indentations and/or other features, as illustrated in FIG. 22, can be advantageously incorporated into any of the other embodiments of a mandrel disclosed and/or illustrated herein. For example, such features can be incorporated into the mandrel casing and/or mandrel rod embodiments, illustrated in FIGS. 8A through 19. Consequently, a corresponding positive or negative features can be created in the cup formed using such a mold. As discussed, such features can be used to secure a closure portion or similar member to the cup portion. It will also be appreciated that, in some embodiments, one or more high heat transfer materials and/or hardened materials can be used in the mandrel and/or the mold section of the mold.

With continued reference to the embodiment illustrated in FIG. 22, the mandrel 1050 includes a single annular notch 1052 which extends about the entire circumference of the mandrel 1050. Also at the upper portion is a cutting ring 1054 which includes a cutter 1056. In some embodiments, the cutter 1056 or similar device can extend about the entire circumference of the mandrel 1050. However, in other embodiments, the cutter 1056 can extend only intermittently around the periphery of the mandrel 1050. In addition, in other embodiments, a mandrel 1050 can comprises two or more different cutters 1056 or other devices that are configured to facilitate in the removal of thermoformed items from the mandrel 1050.

With continued reference to FIG. 22, the cutting ring 1054 may or may not be separate from the mandrel 1050 and/or moveable with respect to the mandrel 1050. In one embodiment, the cutting ring 1054 is moveable with respect to the mandrel 1050, and can travel at least part way down the length of the mandrel 1050 towards the lower end 1060. In the illustrated embodiment, the cutting ring 1054 can also operate as a stripper to strip the formed cup from the mandrel. In addition, the cutting ring 1054 can be configured to rotate about at least a portion of the circumference of the mandrel 1050. It will be appreciated that a mandrel can comprise one or more cutters and/or strippers which have a different shape, size, location, method of connection, orientation and/or other configuration that those illustrated herein. Regardless of their characteristics and configuration, such devices can be used to cut select portions of a thermoformed item and/or remove it from a mandrel or other portion of a mold.

In some embodiments, the mold sections (e.g., core, cavity, etc.) and/or mandrels of a thermoforming apparatus or system are connected or attached to one or more plates. In turn, such plates can be configured to move the mold section and/or the mandrels through the desired motions of a thermoforming cycle, as described herein. In some embodiments, a plate can comprise two or more mold sections or mandrels so that multiple items can be formed during a single thermoforming cycle. For example, in some embodiments, the plates can include 2, 4, 16, 64 mold sections or mandrels, or ranges in between such values. In other embodiments, the plates can include more or fewer mold sections or mandrels.

According to some embodiments, the mold section and/or mandrel plates are constructed of lightweight material, such as, for example, aluminum (e.g., T-6 aluminum or the like). Lightweight construction can advantageously facilitate the rotation and/or re-positioning of the mandrel plates. In turn, this can make it easier to accommodate certain process steps such as molding and product stripping. Depending on the specific application, the mold section (e.g., core, cavity, etc.) or the mandrels can be constructed from various combinations of metals. For example, in some embodiments, a mandrel or mold section comprises T-6 aluminum with hardened steel cutting/trimming inserts. Mandrels and/or mold sections can also be constructed in sections to accommodate ports for vacuum, air, water and/or oil to be transported through the mandrel such as for temperature regulation, vacuum and pressure-regulated molding/de-molding of thermoformed items as described herein and/or the like. Mandrels, mold sections and/or portions thereof can also be constructed of materials having high heat transfer properties, as discussed herein.

In some embodiments, it may be desirable to vary the temperature along the length or other dimension of the mandrels or mold sections. For example, it may be desirable to maintain the mandrel temperature at or near the mandrel tip relatively low as compared to the temperature in one or more other portions of the mandrel. In some embodiments, the relatively low temperature of the mandrel tip can be done for holding material in the base area of the container. A relatively sharp transition between high and low temperatures can be achieved by insulating the tip area of the mandrel from the rest of the mandrel body (or at least the immediately adjacent portions) so the mandrel body can remain at relatively elevated temperature, and thus, reduce the influence of the cooling of the tip in the sidewall. Consequently, in some embodiments, the enhanced cooling at the base area will be less likely to affect other portions of the mandrel and the items being formed. Thermal isolation of the mandrel tip can be accomplished by using one or more suitable devices and/or methods, such as, for example, the selective use of non-high heat transfer materials, the use of air gaps or thermal isolation materials and/or the like.

In embodiments where heat-setting or annealing of PET (or other material) is desired, the mandrel can be dimensioned to be closer to the finished inside dimensions of the cup or container being formed. As part of the heat setting process, the PET or other thermoplastic or polymeric materials may shrink onto the mandrel. As discussed, such formed items can be subsequently cut and/or stripped from the mandrel or another mold section, taking into consideration elapsed cooling/forming time, temperature and/or one or more other factors. In some embodiments, cavity and mandrel temperatures are separately adjusted and/or optimized to provide desired de-molding and/or enhanced thermal properties of PET or other materials used. However, in other embodiments, the temperature of the mandrels and other portions of the mold can be collectively controlled.

The ability to accurately control the surface temperature of the tooling can also enhance the aesthetic and physical properties of plastic materials used in cans, such as, for example, polypropylene (PP), PET and the like. An extruded sheet of such materials can have various degrees of crystallinity depending upon material composition, process conditions and the like. Thus, in some embodiments, uniform and/or accurately controlled heat transfer can help reduce or increase the crystallinity within the finished product, as required or desired for a particular application.

In certain embodiments of mandrels such as the one illustrated in FIG. 22, the parting line of the cutter and/or stripper can be located such that the corresponding positive or negative contour in the thermoformed cup or other item can be molded through splitting the halves and mechanically opening them to facilitate stripping from the mandrel. In addition, the split section may be applied to the cavity if more complex shapes are desired.

As discussed herein, in some embodiments, a finished cup portion of a container will generally resemble a cylindrical cup with one end open for filling. The open end and/or the base can have any suitable shape including round or some kind of polygon (with sharp and/or rounded corners). However, it will be appreciated that the thermoforming methods described herein can be used to produced any type of item, including those that are not intended to be used as cups or in other container assemblies.

FIG. 23 illustrates one embodiment of a core 1100 (or mandrel) which is intended to be used in a molding apparatus, such as, a thermoforming apparatus. The terms “mandrel” and “core” are used interchangeably herein. The core 1100, which in the depicted embodiment is positioned on an upper platen 1134, has a generally cylindrical body 1104 with a more intricate bottom portion 1102 for forming a custom base of a cup, bottle or other container. The core 1100 can be manufactured from a single material, such as aluminum T-6. Alternatively, two or more different materials can be used in the body of the core 1100. For example, in FIG. 23, the core 1100 includes three distinct regions 1102, 1104, 1108, each of which may include one or more materials, such as hardened materials, high heat transfer materials, wear resistant materials, normal tooling materials and/or the like.

Various material properties and other factors can be considered in determining which materials to utilize in a particular region of the core and/or other mold sections, such as, for example, strength, hardness, durability, malleability, heat transfer properties, wear-resistance properties, anticipated level of contact with adjacent surfaces and/or the like. As discussed herein, the core 1100 can include one or more lightweight materials, such as aluminum T-6, in order to facilitate the movement of the various system components. Such materials may, in some embodiments, advantageously reduce cycle times. In addition, as discussed, the core 1100 can include one or more high heat transfer materials (e.g., AMPCOLOY®, copper, beryllium, alloys thereof, etc.) to provide improved heat transfer rates that facilitate the cooling/heating of a molded, thermoformed or otherwise shaped plastic material. For example, the bottom region 1102 of the core 1100 can include a high heat transfer material to improve the cooling of a container's base portion. However, it will be appreciated that one or more other regions of the core 1100 may also include a high heat transfer material.

Further, one or more cooling channels 1140 can be incorporated into the core 1100 to further improve the cooling of formed materials. In FIG. 23, a cooling channel 1140 is directed through a central portion of the core 1100. In other embodiments, additional cooling channels can be provided, either in the core and/or in other portions or regions of the core 1100, adjacent cavity section (not shown) or other parts of the molding apparatus or system. In some embodiments, a cooling fluid is preferably conveyed within the cooling channels to remove heat from the core 1100. As used herein, the term “cooling fluid” is a broad term and is used in its ordinary sense and refers, without limitation, to non-cryogenic refrigerants, cryogenic refrigerants and other fluids. In some embodiments, cryogenic fluids can comprise water, CO₂, N₂, Helium, Freon, combinations thereof, and the like.

Although not necessarily shown, the mandrels and other mold sections illustrated herein can include one or more cooling channels to improve heat transfer away from (or to) a thermoformed or other molded item. In addition, the thermoforming and other mold apparatus and systems discussed and illustrated herein can include one or more materials to further enhance heat transfer, prevent wear along a friction or mating surface and/or to provide further benefits. For example, the apparatus and systems discussed and illustrated herein can comprise one or more high heat transfer materials, wear resistant materials, case hardened materials and/or the like.

With continued reference to FIG. 23, the core 1100 can include a steel insert 1120 along its upper portion. In a preferred embodiment, the steel insert 1120 comprises a cutting edge which can be used to trim one or more portions of the plastic sheet used in a thermoforming or other forming or molding process. Further, the core 1100 can include a stripper plate 1130 which can be used to remove the formed product from the core 1100. In some embodiments, the stripper plate 1130 comprises a lightweight metal or other material, such as, for example, aluminum T-6.

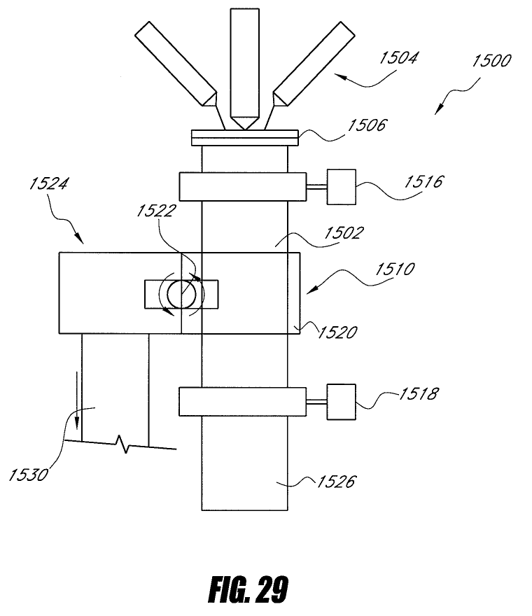

FIGS. 24 through 26 illustrate three embodiments of a mandrel positioned within a cavity section of a thermoforming apparatus. In FIG. 24, the thermoforming apparatus 1210 comprises a cavity section 1212 and a mandrel 1214 or core. In some embodiments, the cavity section 1212 defines an inner cavity 1220 having generally smooth inside walls 1222. The bottom of the inner cavity 1220 can include one or more features 1226 which are used to create a specialized base design. In the illustrated embodiment, the feature 1226 is a single bump located along the center of the cavity 1220. In will be appreciated that additional features may be included within one or more other portions of the cavity 1220, either in lieu of or in addition to the bump shown in FIG. 24. The core 1214 or mandrel is configured to urge a plastic sheet or other formable material into the cavity 1220. In some embodiments, the bottom surface 1230 of the core 1214 is shaped to generally match the shape of the bottom surface 1226 of the cavity. Thus, in FIG. 24, the core 1214 comprises a rounded or curved bottom surface 1230 configured to generally match and fit over the bump or other feature 1226 of the cavity section 1212.

According to some embodiments, material distribution of the sheet is preferably taken into consideration as the core guides the sheet or film within the cavity section. For example, the core 1214 can be shaped or can be configured to descend in such a manner that the thickness of the sheet material along different portions of the cavity 1220 (e.g., sides, top, bottom, etc.) is carefully controlled. In some embodiments, it is desirable to have a generally uniform wall thickness throughout the entire formed product. Alternatively, one or more portions of the formed products may be provided with thicker or thinner walls.

With continued reference to FIG. 24, the apparatus 1210 can be configured so that a gap 1234 exists between the outside surface of the core 1214 and the inside surface 1222 of the core section 1212. As described in greater detail herein, one or more pressure and/or vacuum thermoforming devices and/or methods can be used to urge the plastic sheet or other moldable material along the inner surfaces 1222, 1224 of the cavity section 1212.

Once the plastic material has been adequately formed and cooled, the formed product may be removed from the apparatus 1210 using one or more methods. In one embodiment, a volume of air or other fluid may be delivered between the cavity's inner surfaces 1222, 1224 and the formed product (not shown). The fluid flow can help overcome any adhesive forces existing between the inner surfaces 1222, 1224 and the formed product, and may even cause the product to be ejected out of the cavity section. In other embodiments, one or more mechanical methods (e.g., cutter, stripper, mandrel, etc.) can be used to remove the formed product, either in lieu of or in addition to using fluids for mold-formed item separation.

In FIG. 25, the cavity section 1212A includes a projection 1240 or other similar feature near its upper portion. In some embodiments, such a projection 1240 can provide the formed product (e.g., cup, can, etc.) with a corresponding protrusion or other coupling structure, as discussed and illustrated herein. The coupling structures can be used to advantageously engage and/or attach a closure member or other device to the formed product. The core 1214A can be configured to stretch a thermoplastic or other polymeric sheet (e.g., PET, PP, etc.) past the split line 1242, which is located at the base of the projection 1240, prior to beginning the vacuum and/or pressure thermoforming process. This can help ensure that plastic material is properly distributed throughout the formed product. Further, the thickness of the sheet within the cavity section can be advantageously controlled, at least in part, by the timing and/or rate of air delivery associated with the vacuum or pressure thermoforming processes. In some embodiments, a sliding seal ring can be used to adjust the rate of vacuum or pressure forming. However, it will be appreciated that one or more other methods of adjusting the vacuum and/or pressure can also be used.

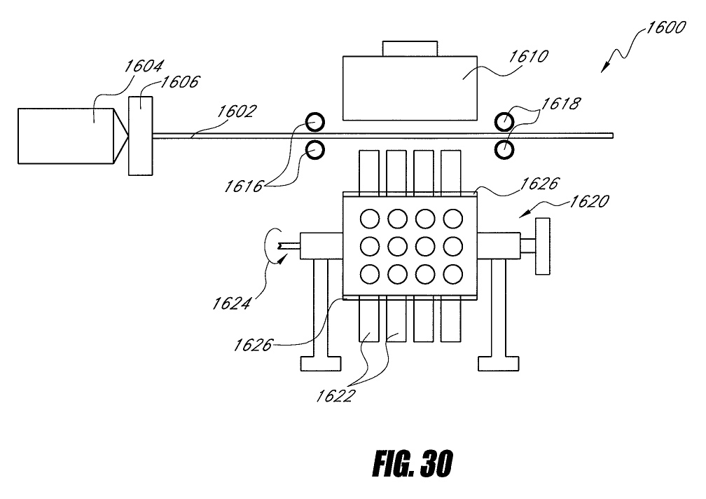

FIG. 26 illustrates another embodiment of a cavity section 1212B configured for vacuum thermoforming a plastic sheet or other item. As shown, the apparatus 1210B can comprise a plurality of fluid channels 1250 which are in fluid communication with the cavity 1220B. Thus, fluid may be drawn out of the cavity 1220B though one or more of the fluid channels 1250 to create the necessary vacuum between the sheet 1260 and the walls of the cavity 1220B. Consequently, the plastic sheet or other moldable material can be urged against the cavity 1220B. In some embodiments, once the sheet has been adequately cooled, flow through the channels 1250 can be reversed to overcome any adhesive forces that developed between the sheet 1260 and the walls of the cavity. It will be appreciated that the fluid channels 1250 need not be oriented as illustrated in FIG. 26. For example, more or fewer channels can be provided. Also, the channels may be located along other portions of the cavity.

With reference to the embodiment illustrated in FIG. 27, a core 1300 or mandrel includes a stripper plate 1302 and a cutting ring 1304 with a cutter 1306. In one embodiment, the cutter 1306 is positioned around the entire circumference of the core 1300. The cutting ring 1304 may or may not be separate from the core 1300 and/or moveable with respect to the core 1300. In some embodiments, the cutting ring 1304 is moveable with respect to the core 1300, and can travel at least part way down the length of the core 1300 towards the lower end 1330. The cutting ring 1304 can also act as a stripper to strip the formed cup or other product from the core 1300. In other embodiments, the cutting ring 1304 can also be configured to rotate about at least a portion of the circumference of the core 1300.

With continued reference to FIG. 27, the core 1300 can be configured to operate in a vacuum thermoforming system and/or a pressure thermoforming system. In some embodiments, the core 1300 is adapted to convey fluid into and/or out of a plurality of openings (not shown) along its body. As illustrated in FIG. 27, air, gas and/or other fluids can be conveyed through one or more channels (not shown) situated within the body of the core 1300. Thus, fluid can be discharged through the surface openings to the area surrounding the core's outer surface. Therefore, once the core 1300 has moved a sheet or other formable material into a cavity, fluid may be delivered through the core's outer surface to urge a sheet against the mold.

Generally, such pressure thermoforming methods work in reverse of vacuum thermoforming methods. By way of example, if the mandrel or core 460 illustrated in FIGS. 12A-12E was configured to discharge air or other fluid through its outer surface, the step from FIG. 12C to FIG. 12D would be similar, regardless if vacuum or pressure thermoforming was used. In some embodiments, it may be advantageous to use both vacuum thermoforming and pressure thermoforming methods together, either simultaneously or not. Such an embodiment can also provide better control of the thickness distribution of the sheet during the forming process.

Further, the same and/or other openings and channels can be used to draw air or other fluid within the body of the core 1300. Such fluid delivery features can be utilized when the core 1300 is positioned within a cavity section for vacuum and/or pressure thermoforming functions. Consequently, a single core 1300 can provide various combinations of vacuum generation, timed physical stretching, introduction of low and/or high pressure air or fluid and/or other functions and features which may facilitate the production of more complex base designs. In addition, such features can provide more enhanced control of wall thicknesses.

In accordance with one preferred embodiment, a thermoforming system comprises a single upper platen with fixed mandrels and an indexing cube. As used herein, “cube” is a broad term and is used in accordance with its ordinary meaning, and may include, without limitation, any rotating or moving molding device regardless of whether it is shaped like a cube. Thus, a “cube” can have six sides, or more or fewer than six sides. In some embodiments, the indexing cube comprises two to four cavity sets. However, in other embodiments, an indexing cube can comprises more or fewer than two to four cavity sets.

With continued reference to a preferred embodiment, a sheet can be indexed over the top set of cavities or mandrels. In some embodiments, as discussed and illustrated herein, the sheet is grasped and positioned so that a corresponding mandrel platen can move relative to the cavities to assist in forming the desired cup, can or other product. As discussed, the sheet can be heated to an appropriate temperature or otherwise prepared for the thermoforming procedure depending, in part, on the material or material combination being used. In one embodiment, the sheet comprises PET and/or has a thickness of about 40-80 mil, including about 60 mil. Preferably care is taken to allow the outer sheet edges and the zones used to index the sheet forward to remain generally unheated to facilitate handling.

When the cup or other desired item is formed, the mandrel platen can move away from the cavity platen. In some embodiments, the cube can be configured to index, such as by 90 to 180 degrees, while a new portion sheet portion is indexed between the cavity and mandrel platens. In some embodiments, this indexing of the cube and the sheet portion occurs simultaneously. The cube can be optionally and selectively lowered during this step to account for film droop and to provide better centering. In some embodiments, the formed cup or other product can use the dwell time for cooling or post mold conditioning, sterilization, surface treatment, coating application and/or any other conditioning or treatment steps. The formed product can be mechanically and/or hydraulically (e.g., with air assist methods of the cavity and/or mandrel as described herein) ejected. In some embodiments, the ejection occurs at stations located at 90 to 180 degrees to the molding stage. De-molded cups or other formed items can be subjected to additional transport and/or processing steps. For example, the de-molded items can be placed onto a conveyor, a sorting/stacking assembly or post mold or fill and seal system, can be dip coated, can undergo surface treatment (e.g., plasma treatment) and/or the like.

In alternative configurations, an extruded sheet can be pulled across a single set of cavities. The upper platen can have an even number of sets of mandrels, including from 2 to 16. In some embodiments, each set of mandrels can be indexed via a shuttle or rotation system to one set of cavities where the molding operation is performed. Finished containers may be transported on the mandrels to an eject station where they are cut and/or stripped. Next, the sheet can be indexed forward (i.e. to the next portion that is available for use), preferably simultaneously as the mandrel platen moves to the upward position. The finished thermoformed cup, can or other item could have vertical or slightly tapered walls with a small draft angle, preferably less than about 5 degrees, including less than about 3 degrees, 2 degrees or 1 degree. The shape, size, draft angle, dimensions and/or other characteristics and properties of the thermoformed cups can vary. In addition, it will be appreciated that the cups, cans or other items produced by such thermoforming techniques can include one or more other features or characteristics, such as, for example, coupling structures (e.g., recesses, flanges, projections, etc.), aesthetic or functional markings (e.g., contours, etc.) and/or the like.

In alternative embodiments, the molding operation is mobile in a linear direction to the degree that the cavity/mandrel section moves at the same speed as the extruded film while molding the article. Thus, a cavity section can lower to a sufficient height to rotate and clear the sheet while returning to the start position to start another molding cycle. The thermoformed cups, cans, containers or other items could be punched out of the sheet. In some embodiments, ejection of the formed products occurs when the cavity has returned to a desired location. The stroke can be determined by the dimensions of the cavity plate or any other factors.

The apparatuses described above are only some embodiments of the thermoforming apparatuses and systems. The relative movements and positions of the mandrel platen, cavity platen, cube and other portions can be varied. For example, the mandrels and cavities could be brought together by movement of the cube and/or both the cube and mandrel platen.

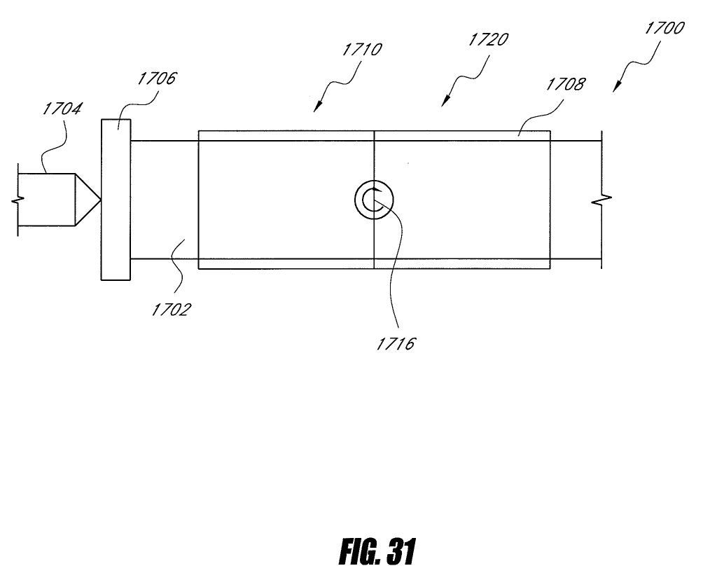

FIG. 28 illustrates one embodiment of a thermoforming apparatus 1400 which can selectively incorporate one or more of the thermoforming principles and features discussed herein. As shown, the apparatus 1400 comprises an upper platen 1410 having a plurality of cores 1412 or mandrels, and a lower platen 1420 having a corresponding number of cavity sections 1422. The molding apparatus 1400 additionally includes a base 1440 and a hydraulic cylinder 1442 for moving the upper platen 1410 and the lower platen 1420 relative to one another. Further, the apparatus 1400 may comprise one or more alignment bars 1446 which assist in maintaining proper positioning between the upper platen 1410 and the lower platen 1420.

With continued reference to FIG. 28, the upper platen 1410 can comprise a fluid network 1416 for the delivery of cooling and/or heating fluid to the cores 1412. Likewise, the lower platen 1420 may include a similar separate fluid network 1428 in fluid communication with the cavity sections 1422. Further, one or more other fluid networks may be provided for the cores 1412 and/or the cavity sections 1422. In addition to or in lieu of cooling channels, the cores 1412 and cavity sections 1422 can comprise one or more high heat transfer materials to further enhance the heat transfer capabilities of the apparatus. In the depicted embodiment, the cavity sections 1422 are in fluid communication with a vacuum system 1426 which can be used to remove air or other fluid from the cavity sections 1422 during the vacuum thermoforming process. Although not illustrated in FIG. 28, the cores 1412 may include a corresponding system for pressure thermoforming purposes.

With continued reference to FIG. 28, a sheet 1402 can be formed using an extruder 1404 and an accompanying dye 1406. Depending on the particular product being formed, the extruder and/or dye settings can be adjusted to modify the thickness, shape, temperature and/or other properties of the sheet 1402. The sheet can be moved between the cores 1412 and the cavity section 1422 in preparation for the thermoforming procedure. As discussed herein, a heating and/or cooling device (not shown) may be optionally used to adjust or maintain the temperature of the sheet 1402 to a desired level or range. When the upper platen 1410 and the lower platen 1420 move relative to one another, the cores 1412 urge portions of the sheet 1402 into the corresponding cavity sections 1422. Vacuum and/or pressure thermoforming methods, such as those described herein, are then used to produce the thermoformed products. After the formed sheet portions situated within the core sections 1422 have been adequately cooled, they may be removed using pneumatic, mechanical and/or other methods disclosed herein. A new section of sheet 1402 can then be indexed between the platens, and the cycle can be repeated.

FIG. 29 illustrates another embodiment of a thermoforming apparatus 1500. As shown, a plastic sheet 1502 can be formed using an extruder 1504 and an accompanying dye 1506. After it is passed between one or more rollers 1516, heaters (not shown) and/or other preparatory stages, the sheet 1502 can be moved between platens 1520 comprising one or more sets of cores and corresponding cavity sections. Following a thermoforming cycle, during which the platens engage and disengage one another, a puller 1518 can be used to move a new section of extruded sheet between the platens 1520. The portion of the sheet remaining following the thermoforming cycle can be collected, and preferably, recycled.

Depending on whether the formed product is configured to remain on the core or within the cavity section after the thermoforming stage, the appropriate platen can rotate (e.g., 180 degrees from the thermoforming station 1510) to the eject station 1524. The formed cups, cans or other products can then be ejected and/or otherwise removed from the cores or the cavity sections. In one embodiment, the formed products may be ejected onto a conveyor 1530 for transport and/or further processing (e.g., coating, plasma treatment, assembly with one or more closure members, etc.).

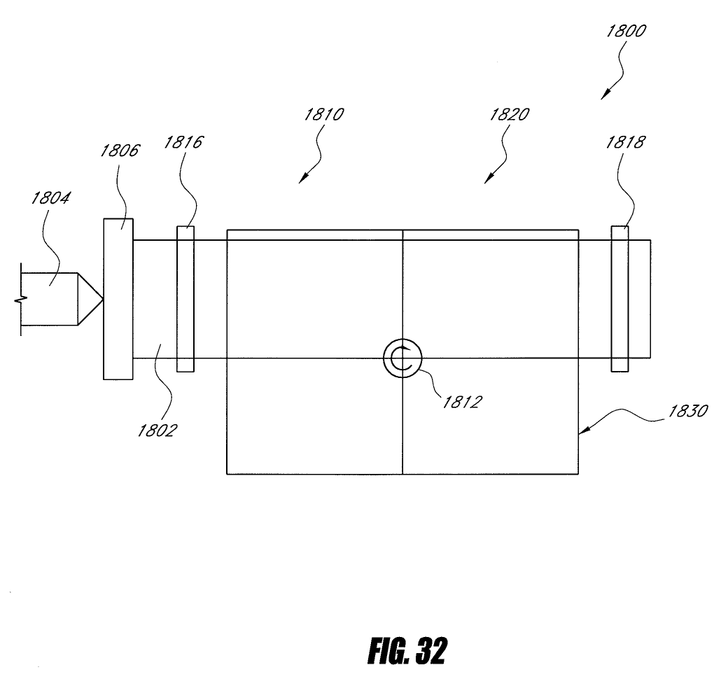

Another embodiment of a thermoforming apparatus 1600 is illustrated in FIG. 30. As in other arrangements described above, a sheet 1602 can be produced by a strategically located extruder 1604 and dye 1606. Preferably, the extruder 1604 and the dye 1606 are in close proximity to the thermoforming apparatus 1600 to maintain the sheet 1602 in heated state. This can also help avoid additional transport of the sheet 1602. Using one or more rollers 1616 and/or pullers 1618, the sheet 1602 is moved between a cavity platen 1610 and a core or mandrel platen 1620. In the depicted embodiment, the cavity platen 1610 is stationary, at least in the sense that it is not configured to rotate, and the core platen 1620 is capable of rotation. In order to move the cores 1622 into the corresponding cavity sections (not shown), the core platen 1620 can be configured to also move vertically toward the cavity sections. However, in other embodiments, the cavity platen 1610 may be configured to shift vertically in the direction of the cores 1622. In yet other embodiments, both platens 1610, 1620 can be configured to move toward one another.

With continued reference to FIG. 30, the formed products can remain on the cores 1622 following a thermoforming cycle. In the depicted embodiment, since each side of the core platen comprises twelve cores 1622, a total of twelve products can be produced with each cycle. Thus, after a thermoforming cycle, the core platen can be lowered relative to the cavity platen, and can be rotated (e.g., by 90 degrees). The newly formed cups, can or other products can be delivered to an ejection or removal station (not shown). In one embodiment, the formed products (e.g., cups) are mechanically removed from the cores by operation of the stripper plate 1626. It will be recognized that one or more other removal methods, such as mandrel-assisted or air-assisted methods, can be used, either in lieu of or in addition to such mechanical stripping methods. After a new sheet section has been delivered under the cavity platen, the thermoforming process can be advantageously repeated.

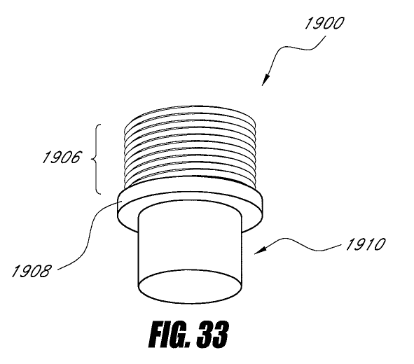

FIGS. 31 and 32 illustrate yet other embodiments of thermoforming apparatuses. In FIG. 31, a rotatable platen 1708 is configured to rotate 180 degrees during each thermoforming cycle. The rotatable platen 1708 can be either the core platen or the cavity platen. According to the illustrated embodiment, the rotatable platen 1708 is indexed between a process station 1710, where the sheet is thermoformed, and an eject station 1720, where the formed product is removed from the rotatable platen.

Similarly, as illustrated in FIG. 32, a thermoforming apparatus 1800 comprises a rotatable platen (e.g., core or cavity) which is configured to rotate 90 degrees during each thermoforming cycle. In one arrangement, the platen is sequentially moved from process station 1810, to a first cooling station 1820, to a second cooling station 1830 and an eject station, where the formed product is removed. It will be appreciated that a thermoforming apparatus can be configured to include fewer or more stations than shown in the embodiments discussed herein. For example, additional processing steps can occur at the various stations, such as, for example, application of coatings, surface treatment, assembly of closure members or the like, selective heating/cooling and/or the like. In addition, it will be appreciated that a thermoforming can be differently configured.

In some preferred embodiments, the formed cavities are sterile and could thus be filled in line after forming. Closure members whether described herein or not (e.g., lids, screw caps, other caps, snap closures, BAPCO® closures, etc.) could be fitted or placed on the cup. In some embodiments, such closure members are thermally or inductively sealed or welded in place by laser or ultrasonically to provide a secure hermetic seal protecting the product. In the case of a closure of the type illustrated in FIGS. 1A through 7, the closure can fit over the open end of the cup and sealed in place using one of the methods described. A sealing member, as shown in FIG. 5 and discussed herein, can also be applied to the top end of a cup. If an aluminum can type closure system with a pull tab is used, the aluminum lid may be crimped on.

Alternatively, the open flanged end of a cup or other container can be sealed with a suitable foil laminated with a sealable layer. In some embodiments, as discussed herein, such sealing or sealable layers can be removable. Sealing layers can help maintain the internal content of a container water-right and/or air-tight. In other embodiments, a thinner sheet stock could be formed into a dished end and sealed in place to the flange at the open end or inserted as a plug and fused to the cylindrical wall at the open end. In this case the closed end of the initial can could be punched or reamed to provide an opening to access packaged beverage. The opening could also be sealed with an adhesive foil (e.g., metalized, non-metalized, etc.), where the foil is peeled away to access the stored beverage or other foodstuff.

For convenience, many of the embodiments disclosed herein are only discussed in relation to forming mono-layer cups, cans or other containers. However, it should be appreciated that these and other thermoforming methods can be practiced with multi-layer sheets or films. Although not necessary, the different layers may comprise different materials, thicknesses, properties, function and the like. In other embodiments, the plastic sheets used in the thermoforming process may include one or more layers and/or coatings. In addition, the thermoforming methods, principles and apparatuses discussed in this application can apply to both thin wall and thick wall designs.

Preferably, one or more lightweight materials can be incorporated into the cores, mandrels, cavity sections and/or other components that are either directly or indirectly associated with the thermoforming process. For example, aluminum T-6, other lightweight alloys and the like can be used. The use of lightweight materials in these systems can allow for faster forming or molding procedures, thereby reducing cycle times. High strength materials (e.g., hardened steel and the like) capable of withstanding friction and contact with adjacent surfaces can be used where necessary. Such materials on high wear and/or contact surfaces can be located on the core and/or mandrel, on or within the cavity section and/or any other component of the thermoforming device. Further, one or more high heat transfer materials can be used in order to provide enhanced heat transfer rates that facilitate the cooling/heating of a molded, thermoformed or otherwise shaped plastic material. Moreover, one or more cooling channels can be provided in any of the cavity sections, mandrels and/or any other mold portion to further improve heat transfer.

In addition, the cups, containers or other products manufactured using methods or apparatus described in this application may or may not comprise a minimum draft. Further, the molds can be used to create complex base designs in the formed products. In other embodiments, contours, threads, flanges, lips, other features and the like can be included on and/or within the thermoformed products. However, as discussed, it may be necessary to provide split-mold designs or other types of systems to create such intricate designs.

The thermoforming apparatuses, systems and/or methods described and/or illustrated herein, or variations thereof, can be advantageously applied to polymeric materials other than sheets or films. For example, a high speed process can be initially used to generate a mass of polymeric material. In one embodiment, a mass of extruded polymer is produced and placed on a conveyor belt or similar moving system. Preferably, the volume, shape, size, physical properties and other characteristics of these masses is consistent to avoid problems with subsequent processing steps. The masses of polymeric materials being moved on the conveyor belt could be stamped or pressed into a flatter shape (e.g., disk). The amount of force applied to the masses and the manner in which the force is applied will depend on the dimensions, thickness and/or other characteristics and properties of the item being formed, the material properties and temperature of the extruded material, the type of conveyor belt system utilized, the type of thermoforming that will be used and/or the like.

According to some embodiments, such flattened masses could be shaped into a desired product using one or more thermoforming methods (e.g., vacuum thermoforming, pressure thermoforming, mandrel or plug-assist, etc.). In certain embodiments, the process by which the masses are formed and flattened, as well as the subsequent thermoforming process, are conducted in close proximity to one another, in terms of time and/or space. This enables the flattened masses (or disks) to retain at least a portion of their heat content, so that the time and energy required to cool the masses is reduced. The terms “flattened mass” and “disk” are used interchangeably herein.

Further, the use of high heat transfer materials, such as AMPCOLOY® alloys, alloys comprising copper and beryllium, and the like, on the mandrel, core, cavity section and other portions of the molding apparatus may result in improved wall thickness distribution and repeatability, especially when thermoforming products having a deeper draw and/or contoured surfaces. Consequently, in some embodiments, the use of the polymeric disks and/or the high heat transfer materials can result in a faster and more cost efficient thermoforming process.

Furthermore, since such polymeric disks are easy to compression mold, it may be possible to produce multilayer disks by stamping or otherwise compressing together different extruded materials. In some embodiments, such multilayer disks can even enhance the barrier properties of the formed product. Thermoforming a disk, regardless of whether the disk is extruded, compression molded or produced using another method, can reduce the costs of thermoforming a container, because the costs associated with producing relatively thin sheet rolls is eliminated.

In one embodiment, extruded disks can be formed into a shallow cup-shaped member 1900 by compression molding or another method. As illustrated in FIG. 33, such a cup-shaped member resembles an inverted bottle cap. The cup-shaped member 1900 can comprise an exterior threaded region 1906 and a neck support ring 1908 along its upper, open portion. The neck support ring 1908 can facilitate the handling of the cup-shaped member 1900 as it is transferred to and between different processing stations. The middle shallow section 1910 of the cup-shaped member 1900 comprises a relatively thicker disk shape and comprises sufficient polymeric material so that it may be later thermoformed into the intended shape of the container (e.g., main bottle portion, other main container portion, etc.). In some embodiments, one or more high heat transfer materials can be used to quickly and efficiently cool the threaded region 1906 and neck support ring 1908. In addition, the high heat transfer material can be used to effectively “freeze” or quickly cool the skin of the middle shallow section 1910, leaving the inner polymeric material of the thicker disk warm.

With continued reference to FIG. 33, after the cup-shaped member 1900 has been compression molded, it can be quickly thermoformed in order to take advantage of the residual thermal energy contained within the thicker disk portion. If necessary or desired, the member 1900 could be heated or cooled in preparation for the subsequent thermoforming step. For example, if the disk requires additional heat, the cup-shaped member 1900 may be directed to a conditioning station where the necessary heating may be provided. In one embodiment, heat is added to the member 1900 by conduction. Alternatively, the cup-shaped member 1900 can be transported to the thermoforming station via a warm air transfer tunnel to counter any unwanted heat losses.

The thermoforming apparatus used to shape the member 1900 into its desired shape may include a plunger (not shown), which is used to initially deform the disk portion of the cup-shaped member and distribute its resin in critical zones. According to some embodiments, the plunger is cylindrical and comprises a blunt end. Alternatively, the plunger end can include a plurality of tapered steps. After deformed by the plunger, the disk can resemble a shallow formed cup. Subsequently, the shallow cup could be shaped by urging it against the molding surfaces of the cavity section using one or more thermoforming methods. In one embodiment, a combination of pressure thermoforming and vacuum thermoforming is used. However, those of skill in the art will recognize that the shallow cup can also be formed using only one type of thermoforming method.

According to some embodiments, the capacity of the formed container is approximately 200 ml. In other embodiments, the container's capacity is slightly or significantly lower than 200 ml. The container's capacity may be 180 ml, 160 ml, 140 ml, 120 ml, 100 ml, 80 ml, 60 ml, 40 ml, 20 ml, and ranges encompassing these volumes. In yet other embodiments, the container's capacity is slightly or significantly higher than 200 ml. For example, in one embodiment the capacity of the container may be 0.5 l, 1 l, 2 l, 5 l, 10 l, 25 l or higher. In other embodiments, the container's capacity may be 310 ml, 320 ml, 330 ml, 340 ml, 350 ml, 400 ml, 450 ml, 500 ml, and ranges encompassing these volumes.

In another embodiment, the thicker disk of the middle shallow section 1910 comprises one or more high stretch materials. Thus, because of its high stretch properties, the thermoformed plastic may be formed into a larger, flexible bag or the like. In one embodiment, the bag can have an approximate capacity of 500 ml or 1 l. It will be appreciated, however, that the volume of the bag or any other thermoformed items may be higher or lower than indicated herein. The formed bag could be packaged in secondary packaging, such as, for example, a cardboard box. In one embodiment, the bag-box combination to a filling station, where a suitable closure can be secured to the threaded portion of the bag. In some embodiments, the closure can include a screw cap, an ultrasonically welded cap, an inductively welded cap and/or the like.

Extrusion Blow Molding (EBM) Processes

Any form of extrusion blow molding may be used to make the cup portion of the can. The discussion which follows is directed to certain preferred EBM processes, and should not be taken as excluding other processes. Extrusion blow molding begins by extruding or coextruding one or more molten materials through a die, preferably an annular die so as to form a tube. The molten tube is commonly called a parison. In one embodiment, the molten parison descends from the annular die under gravity as it cools. In alternate embodiments, the parison can be drawn from the die. The former method is frequently performed using shuttle machines with a hot knife cutting equal sections of the molten material as it descends, while the latter is often used in a wheel operation. It should be noted, however, that some wheels extrude downwards, while other wheel arrangements are paired with an extrusion system that extrudes upward against gravity such that the parison is held in place and stretched by the rotating action of the wheel.

In both shuttle and wheel systems the basic mechanism of blowing is similar. A mold closes around the cooling tube of material or parison while it is still in the “rubbery” state (e.g. above its glass transition temperature), pinching off the ends that form the top and the base. Compressed air is blown into the tubular softened parison within the mold to expand the parison and/or press it against the surface of the mold. The softened parison solidifies upon contacting the mold surface and takes on the shape defined by the mold. In a wheel operation, two containers in a head-to-head arrangement can be blown from a single tubular section. The molds for such an arrangement in addition to having two container molds has a connective section through which blow air can be introduced. Blow air introduced from a blow pin forms two containers simultaneously from a single large parison. Upon cooling the single untrimmed unit or multiple units (called logs in the case of wheels) are ejected. In a subsequent operation the tail (portion below the base of the container) is deflashed. The section that defines the top sealing surface is produced by a clean cut such as by rotating a grooved section above the container against a straight edge or rotating blade which is preferably heated so as to lessen any rough edges formed by cutting.

Stretch Blow Molding (SBM) Processes

Any form of stretch blow molding may be used to make the cup portion of the can or container. The discussion which follows is directed to certain preferred SBM processes, and should not be taken as excluding other processes. SBM is a one step blow molding process. Suitable commercial equipment is manufactured by Aoki and/or Nisei. This method of manufacturing includes injection molding a preform or parison. The preform is similar in shape and size to those made for ISBM, and the platform is also similar to ISBM. The platform differs from ISBM, however, in that the preform body is not allowed to cool completely before it is ejected from the mold, although the neck finish is completely cooled following the molding process. The preform body is allowed to cool in the mold long enough to allow the preform to be ejected without sticking to the mold. The warm/hot preform then moves to the next stage where it is blow molded into the finished part. Much like in an ISBM process, the preform is inserted into the mold and the body of the warm preform is blown to expand and lock in the shape of the cool blow mold cavity. In some embodiments, there is an intermediate heat conditioning station to augment heating the preform in specific zones to achieve desired results in the blowing process. SBM is suitable for production of large-mouthed/necked containers and/or non-symmetric or larger containers that have a greater hoop deformation or irregular shapes (e.g. rectangular, oval or square). If a cup portion having two or more layers is desired, it is preferably made by using an 101 process such as that described in U.S. Pat. No. 6,391,408.

Injection Stretch Blow Molding (ISBM) Processes

Any form of injection stretch blow molding may be used to make the cup portion of the container or can. The discussion which follows is directed to certain preferred ISBM processes, and should not be taken as excluding other processes. ISBM allows the production of a biaxally oriented container, which is particularly suitable for applications where higher strength containers are desired, such as for pressurized liquids. A preform is first made by injection molding by any suitable process. If a container having a cup portion comprising two or more layers is desired, it may be made by using an 101 process such as that described in U.S. Pat. No. 6,391,408. The preform is cooled to a point where it can be handled without being seriously damaged. The finished preform may be blown into a container at any time after it is made. This allows for preforms to be made at one site and then shipped to another site for blowing and filling. The preform is then subjected to a stretch blow molding process. During SBM, the preform may be supported by the coupling structure much as many standard preforms are supported by a support ring. Alternatively, a support ring may be included with the container or it may be trimmed off following the SBM process. Optionally, further conditioning of the neck portion of the preform, in the blow mold or afterwards, may be done to enhance crystallinity and dimensional stability in the neck portion including the coupling structure.

General Description of Preferred Materials

The articles disclosed herein, including cups and closures may be made from any of a wide variety of materials as discussed herein. In addition, the thermoforming and other types of methods, systems, apparatuses and devices disclosed herein can be configured to form containers and other items using some or all of the materials discussed herein. Although some articles may be described specifically in relation to one or more particular materials, these same articles, and the methods used to make the articles are applicable to many other thermoplastics including, but not limited to, polyesters, polyolefins, polylactic acid, polycarbonate, and the like. Other suitable materials include, but are not limited to, polymeric materials, including thermoset polymers, thermoplastic materials such as polyesters, polyolefins, including polypropylene and polyethylene, polycarbonate, polyamides, including nylons (e.g. Nylon 6, Nylon 66) and MXD6, polystyrenes, epoxies, acrylics, copolymers, blends, grafted polymers, and/or modified polymers (monomers or portion thereof having another group as a side group, e.g. olefin-modified polyesters). These materials may be used alone or in conjunction with others in multi-layer structures, blends or copolymers, and can also be combined with different additives, such as nanoparticle barrier materials, oxygen scavengers, UV absorbers, foaming agents and the like. More specific material examples include, but are not limited to, ethylene vinyl alcohol copolymer (EVOH), ethylene vinyl acetate (EVA), ethylene acrylic acid (EAA), linear low density polyethylene (LLDPE), polyethylene 2,6- and 1,5-naphthalate (PEN), polyethylene terephthalate glycol (PETG), poly(cyclohexylenedimethylene terephthalate), polylactic acid (PLA), polycarbonate, polyglycolic acid (PGA), polystyrene, cycloolefin, poly-4-methylpentene-1, poly(methyl methacrylate), acrylonitrile, polyvinyl chloride, polyvinylidine chloride (PVDC), styrene acrylonitrile, acrylonitrile-butadiene-styrene, polyacetal, polybutylene terephthalate, polymeric ionomers such as sulfonates of PET, polysulfone, polytetra-fluoroethylene, polytetramethylene 1,2-dioxybenzoate, polyurethane, and copolymers of ethylene terephthalate and ethylene isophthalate, and copolymers and/or blends of one or more of the foregoing.

As used herein, the term “polyethylene terephthalate glycol” (PETG) refers to a copolymer of PET wherein an additional comonomer, cyclohexane di-methanol (CHDM), is added in significant amounts (e.g. approximately 40% or more by weight) to the PET mixture. In one embodiment, preferred PETG material is essentially amorphous. Suitable PETG materials may be purchased from various sources. One suitable source is Voridian, a division of Eastman Chemical Company. Other PET copolymers include CHDM at lower levels such that the resulting material remains crystallizable or semi-crystalline. One example of PET copolymer containing low levels of CHDM is Voridian 9921 resin. Another example of modified PET is “high IPA PET” or IPA-modified PET, which refers to PET in which the IPA content is preferably more than about 2% by weight, including about 2-20% IPA by weight, also including about 5-10% IPA by weight. Throughout the specification, all percentages in formulations and compositions are by weight unless stated otherwise.

In some embodiments polymers that have been grafted or modified may be used. In one embodiment polypropylene or other polymers may be grafted or modified with polar groups including, but not limited to, maleic anhydride, glycidyl methacrylate, acryl methacrylate and/or similar compounds to improve adhesion. In other embodiments polypropylene also refers to clarified polypropylene. As used herein, the term “clarified polypropylene” is a broad term and is used in accordance with its ordinary meaning and may include, without limitation, a polypropylene that includes nucleation inhibitors and/or clarifying additives. Clarified polypropylene is a generally transparent material as compared to the homopolymer or block copolymer of polypropylene. The inclusion of nucleation inhibitors can help prevent and/or reduce crystallinity or the effects of crystallinity, which contributes to the haziness of polypropylene, within the polypropylene or other material to which they are added. Some clarifiers work not so much by reducing total crystallinty as by reducing the size of the crystalline domains and/or inducing the formation of numerous small domains as opposed to the larger domain sizes that can be formed in the absence of a clarifier. Clarified polypropylene may be purchased from various sources such as Dow Chemical Co. Alternatively, nucleation inhibitors may be added to polypropylene or other materials. One suitable source of nucleation inhibitor additives is Schulman.

In certain embodiments preferred materials may be virgin, pre-consumer, post-consumer, regrind, recycled, and/or combinations thereof. For example, PET can be virgin, pre or post-consumer, recycled, or regrind PET, PET copolymers and combinations thereof. In preferred embodiments, the finished container and/or the materials used therein are benign in the subsequent plastic container recycling stream.

In certain embodiments, a cup may be further processed such as by dip, spray or flow coating. Preferred apparatus, methods, and materials include those described in such as described in WO 04/004929 and U.S. Pat. No. 6,676,883, the disclosures of which are hereby incorporated by reference in their entireties. The cup is preferably made from polymers, such as thermoplastic materials. Examples of suitable thermoplastics include, but are not limited to, polyesters (e.g. PET, PEN), polyolefins (PP, HDPE), polylactic acid, polycarbonate, and polyamide.

One or more layers which form a cup may include one or more additives. Additives preferably provide functionality to the cup (e.g. UV resistance, barrier, scratch resistance). A polymeric material used in a layer composition may, itself, provide functional properties such as barrier, water resistance, and the like.

In embodiments of preferred methods and processes one or more layers may comprise barrier layers, UV protection layers, oxygen scavenging layers, oxygen barrier layers, carbon dioxide scavenging layers, carbon dioxide barrier layers, and other layers as needed for the particular application. As used herein, the terms “barrier material,” “barrier resin,” and the like are broad terms and are used in their ordinary sense and refer, without limitation, to materials which, when used in preferred methods and processes, have a lower permeability to oxygen, carbon dioxide, and/or than the one or more of the other layers of the finished article (including the substrate). As used herein, the terms “UV protection” and the like are broad terms and are used in their ordinary sense and refer, without limitation, to materials which have a higher UV absorption rate than one or more other layers of the article. As used herein, the terms “oxygen scavenging” and the like are broad terms and are used in their ordinary sense and refer, without limitation, to materials which have a higher oxygen absorption rate than one or more other layers of the article. As used herein, the terms “oxygen barrier” and the like are broad terms and are used in their ordinary sense and refer, without limitation, to materials which are passive or active in nature and slow the transmission of oxygen into and/or out of an article. As used herein, the terms “carbon dioxide scavenging” and the like are broad terms and are used in their ordinary sense and refer, without limitation, to materials which have a higher carbon dioxide absorption rate than one or more other layers of the article. As used herein, the terms “carbon dioxide barrier” and the like are broad terms and are used in their ordinary sense and refer, without limitation, to materials which are passive or active in nature and slow the transmission of carbon dioxide into and/or out of an article. Without wishing to be bound to any theory, applicants believe that in applications wherein a carbonated product, e.g. a soft-drink beverage, contained in an article is over-carbonated, the inclusion of a carbon dioxide scavenger in one or more layers of the article allows the excess carbonation to saturate the layer which contains the carbon dioxide scavenger. Therefore, as carbon dioxide escapes to the atmosphere from the article it first leaves the article layer rather than the product contained therein. As used herein, the terms “crosslink,” “crosslinked,” and the like are broad terms and are used in their ordinary sense and refer, without limitation, to materials and coatings which vary in degree from a very small degree of crosslinking up to and including fully cross linked materials. The degree of crosslinking can be adjusted to provide desired or appropriate physical properties, such as the degree of chemical or mechanical abuse resistance for the particular circumstances.

Other functionality provided by one or more layers, alone or together with other functionality, include color, including but not limited to dyes and pigments, adhesion promoters, improved water vapor barrier, lubricity, including from natural or man-made lubricants, including waxes such as carnauba and paraffins, and abrasion resistance.

In addition, the cup portions of the can or container can undergo one or more various forms of surface treatment, either in preparation for the application of a coating or for any other purpose. Preferred apparatus, methods, and materials include those described in such as described in U.S. Publication No. 2007/0087131, filed on Oct. 12, 2006 as U.S. application Ser. No. 11/546654, the disclosure of which is hereby incorporated by reference in its entirety.

Examples of Preferred Materials

In one preferred embodiment, preferred materials comprise thermoplastic materials. A further preferred embodiment includes “Phenoxy-Type Thermoplastics.” Phenoxy-Type Thermoplastics, as that term is used herein, include a wide variety of materials including those discussed in WO 99/20462. In one embodiment, materials comprise thermoplastic epoxy resins (TPEs), a subset of Phenoxy-Type Thermoplastics. A further subset of Phenoxy-Type Thermoplastics, and thermoplastic materials, are certain preferred hydroxy-phenoxyether polymers, of which certain polyhydroxyaminoether copolymers (PHAE) are further preferred materials. See for example, U.S. Pat. Nos. 6,455,116; 6,180,715; 6,011,111; 5,834,078; 5,814,373; 5,464,924; and 5,275,853; see also PCT Application Nos. WO 99/48962; WO 99/12995; WO 98/29491; and WO 98/14498. In some embodiments, PHAEs are TPEs.

Preferably, the Phenoxy-Type Thermoplastics used in preferred embodiments comprise one of the following types:
(1) hydroxy-functional poly(amide ethers) having repeating units represented by any one of the Formulae Ia, Ib or Ic: 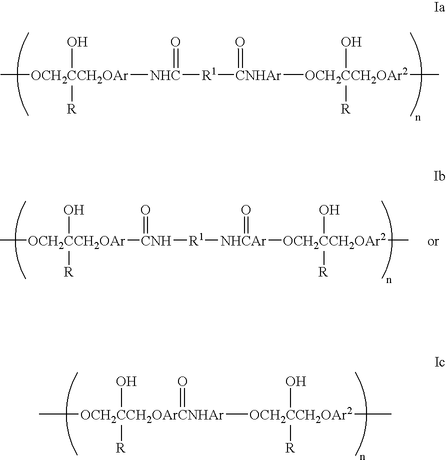
(2) poly(hydroxy amide ethers) having repeating units represented independently by any one of the Formulae IIa, IIb or IIc: 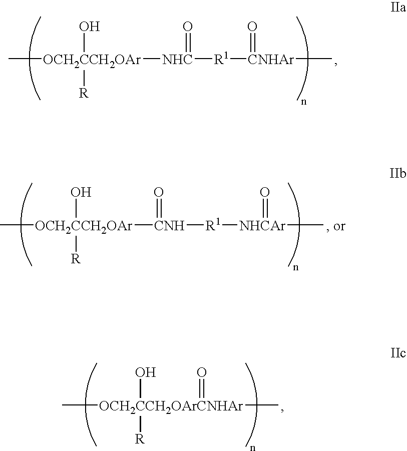
(3) amide- and hydroxymethyl-functionalized polyethers having repeating units represented by Formula III: 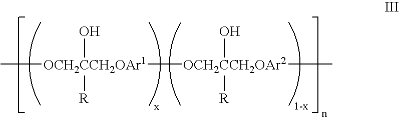
(4) hydroxy-functional polyethers having repeating units represented by Formula IV: 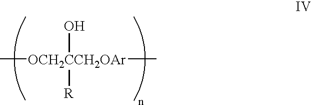
(5) hydroxy-functional poly(ether sulfonamides) having repeating units represented by Formulae Va or Vb: 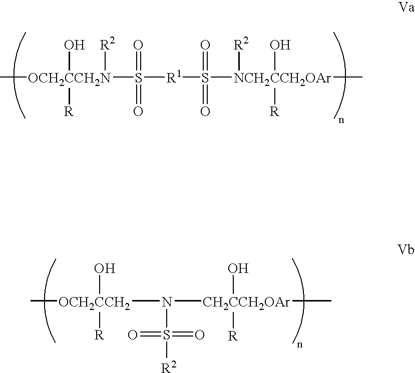
(6) poly(hydroxy ester ethers) having repeating units represented by Formula VI: 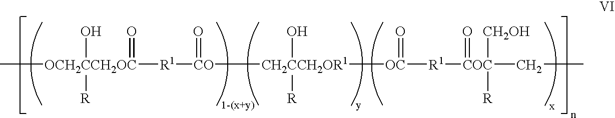
(7) hydroxy-phenoxyether polymers having repeating units represented by Formula VII: 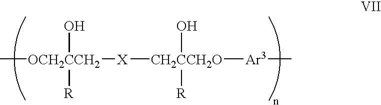
   and
(8) poly(hydroxyamino ethers) having repeating units represented by Formula VIII: 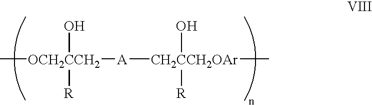
   wherein each Ar individually represents a divalent aromatic moiety, substituted divalent aromatic moiety or heteroaromatic moiety, or a combination of different divalent aromatic moieties, substituted aromatic moieties or heteroaromatic moieties; R is individually hydrogen or a monovalent hydrocarbyl moiety; each Ar₁ is a divalent aromatic moiety or combination of divalent aromatic moieties bearing amide or hydroxymethyl groups; each Ar₂ is the same or different than Ar and is individually a divalent aromatic moiety, substituted aromatic moiety or heteroaromatic moiety or a combination of different divalent aromatic moieties, substituted aromatic moieties or heteroaromatic moieties; R₁ is individually a predominantly hydrocarbylene moiety, such as a divalent aromatic moiety, substituted divalent aromatic moiety, divalent heteroaromatic moiety, divalent alkylene moiety, divalent substituted alkylene moiety or divalent heteroalkylene moiety or a combination of such moieties; R₂ is individually a monovalent hydrocarbyl moiety; A is an amine moiety or a combination of different amine moieties; X is an amine, an arylenedioxy, an arylenedisulfonamido or an arylenedicarboxy moiety or combination of such moieties; and Ar₃ is a “cardo” moiety represented by any one of the Formulae:

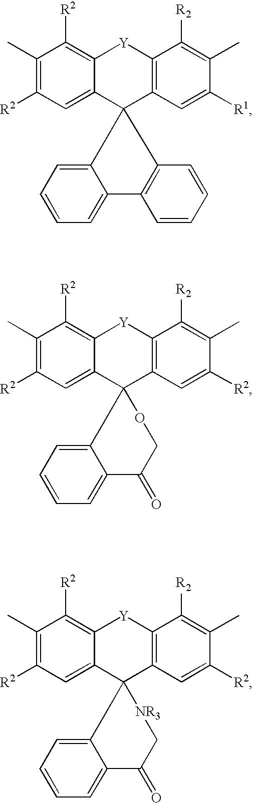

wherein Y is nil, a covalent bond, or a linking group, wherein suitable linking groups include, for example, an oxygen atom, a sulfur atom, a carbonyl atom, a sulfonyl group, or a methylene group or similar linkage; n is an integer from about 10 to about 1000; x is 0.01 to 1.0; and y is 0 to 0.5.

The term “predominantly hydrocarbylene” means a divalent radical that is predominantly hydrocarbon, but which optionally contains a small quantity of a heteroatomic moiety such as oxygen, sulfur, imino, sulfonyl, sulfoxyl, and the like.

The hydroxy-functional poly(amide ethers) represented by Formula I are preferably prepared by contacting an N,N′-bis(hydroxyphenylamido)alkane or arene with a diglycidyl ether as described in U.S. Pat. Nos. 5,089,588 and 5,143,998.

The poly(hydroxy amide ethers) represented by Formula II are prepared by contacting a bis(hydroxyphenylamido)alkane or arene, or a combination of 2 or more of these compounds, such as N,N′-bis(3-hydroxyphenyl)adipamide or N,N′-bis(3-hydroxyphenyl)glutaramide, with an epihalohydrin as described in U.S. Pat. No. 5,134,218.

The amide- and hydroxymethyl-functionalized polyethers represented by Formula III can be prepared, for example, by reacting the diglycidyl ethers, such as the diglycidyl ether of bisphenol A, with a dihydric phenol having pendant amido, N-substituted amido and/or hydroxyalkyl moieties, such as 2,2-bis(4-hydroxyphenyl)acetamide and 3,5-dihydroxybenzamide. These polyethers and their preparation are described in U.S. Pat. Nos. 5,115,075 and 5,218,075.

The hydroxy-functional polyethers represented by Formula IV can be prepared, for example, by allowing a diglycidyl ether or combination of diglycidyl ethers to react with a dihydric phenol or a combination of dihydric phenols using the process described in U.S. Pat. No. 5,164,472. Alternatively, the hydroxy-functional polyethers are obtained by allowing a dihydric phenol or combination of dihydric phenols to react with an epihalohydrin by the process described by Reinking, Barnabeo and Hale in the Journal of Applied Polymer Science, Vol. 7, p. 2135 (1963).

The hydroxy-functional poly(ether sulfonamides) represented by Formula V are prepared, for example, by polymerizing an N,N′-dialkyl or N,N′-diaryldisulfonamide with a diglycidyl ether as described in U.S. Pat. No. 5,149,768.

The poly(hydroxy ester ethers) represented by Formula VI are prepared by reacting diglycidyl ethers of aliphatic or aromatic diacids, such as diglycidyl terephthalate, or diglycidyl ethers of dihydric phenols with, aliphatic or aromatic diacids such as adipic acid or isophthalic acid. These polyesters are described in U.S. Pat. No. 5,171,820.

The hydroxy-phenoxyether polymers represented by Formula VII are prepared, for example, by contacting at least one dinucleophilic monomer with at least one diglycidyl ether of a cardo bisphenol, such as 9,9-bis(4-hydroxyphenyl)fluorene, phenolphthalein, or phenolphthalimidine or a substituted cardo bisphenol, such as a substituted bis(hydroxyphenyl)fluorene, a substituted phenolphthalein or a substituted phenolphthalimidine under conditions sufficient to cause the nucleophilic moieties of the dinucleophilic monomer to react with epoxy moieties to form a polymer backbone containing pendant hydroxy moieties and ether, imino, amino, sulfonamido or ester linkages. These hydroxy-phenoxyether polymers are described in U.S. Pat. No. 5,184,373.

The poly(hydroxyamino ethers) (“PHAE” or polyetheramines) represented by Formula VIII are prepared by contacting one or more of the diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. These compounds are described in U.S. Pat. No. 5,275,853. For example, polyhydroxyaminoether copolymers can be made from resorcinol diglycidyl ether, hydroquinone diglycidyl ether, bisphenol A diglycidyl ether, or mixtures thereof. The hydroxy-phenoxyether polymers are the condensation reaction products of a dihydric polynuclear phenol, such as bisphenol A, and an epihalohydrin and have the repeating units represented by Formula IV wherein Ar is an isopropylidene diphenylene moiety. The process for preparing these is described in U.S. Pat. No. 3,305,528, incorporated herein by reference in its entirety.

Phenoxy-type thermoplastics may comprise one or more layers in a sheet used to form a cup or they may be used in subsequent coating steps to provide additional features. In those embodiments where they are used as coatings, preferred phenoxy-type materials form relatively stable aqueous based solutions or dispersions. Preferably, the properties of the solutions/dispersions are not adversely affected by contact with water. Preferred materials range from about 10% solids to about 50% solids, including about 15%, 20%, 25%, 30%, 35%, 40% and 45%, and ranges encompassing such percentages, although values above and below these values are also contemplated. Preferably, the material used dissolves or disperses in polar solvents. These polar solvents include, but are not limited to, water, alcohols, and glycol ethers. See, for example, U.S. Pat. Nos. 6,455,116, 6,180,715, and 5,834,078 which describe some preferred phenoxy-type solutions and/or dispersions. One preferred phenoxy-type material is a polyhydroxyaminoether (PHAE), dispersion or solution. The dispersion or solution, when applied to a container or preform, greatly reduces the permeation rate of a variety of gases through the container walls in a predictable and well known manner. One dispersion or latex made thereof comprises 10-30 percent solids. A PHAE solution/dispersion may be prepared by stirring or otherwise agitating the PHAE in a solution of water with an organic acid, preferably acetic or phosphoric acid, but also including lactic, malic, citric, or glycolic acid and/or mixtures thereof. These PHAE solution/dispersions also include organic acid salts as may be produced by the reaction of the polyhydroxyaminoethers with these acids.

In some embodiments, phenoxy-type thermoplastics are mixed or blended with other materials using methods known to those of skill in the art. In some embodiments a compatibilizer may be added to the blend. When compatibilizers are used, preferably one or more properties of the blends are improved, such properties including, but not limited to, color, haze, and adhesion between a layer comprising a blend and other layers. One preferred blend comprises one or more phenoxy-type thermoplastics and one or more polyolefins. A preferred polyolefin comprises polypropylene. In one embodiment polypropylene or other polyolefins may be grafted or modified with a polar molecule, group, or monomer, including, but not limited to, maleic anhydride, glycidyl methacrylate, acryl methacrylate and/or similar compounds to increase compatibility.

Other suitable materials include preferred copolyester materials as described in U.S. Pat. No. 4,578,295 to Jabarin. They are generally prepared by heating a mixture of at least one reactant selected from isophthalic acid, terephthalic acid and their C₁ to C₄ alkyl esters with 1,3 bis(2-hydroxyethoxy)benzene and ethylene glycol. Optionally, the mixture may further comprise one or more ester-forming dihydroxy hydrocarbon and/or bis(4-β-hydroxyethoxyphenyl)sulfone. Especially preferred copolyester materials are available from Mitsui Petrochemical Ind. Ltd. (Japan) as B-010, B-030 and others of this family.

Examples of preferred polyamide materials include MXD-6 from Mitsubishi Gas Chemical (Japan). Other preferred polyamide materials include Nylon 6, and Nylon 66. Other preferred polyamide materials are blends of polyamide and polyester, including those comprising about 1-20% polyester by weight, including about 1-10% polyester by weight, where the polyester is preferably PET or a modified PET, including PET ionomer. In another embodiment, preferred polyamide materials are blends of polyamide and polyester, including those comprising about 1-20% polyamide by weight, and 1-10% polyamide by weight, where the polyester is preferably PET or a modified PET, including PET ionomer. The blends may be ordinary blends or they may be compatibilized with one or more antioxidants or other materials. Examples of such materials include those described in U.S. Patent Publication No. 2004/0013833, filed Mar. 21, 2003, which is hereby incorporated by reference in its entirety. Other preferred polyesters include, but are not limited to, PEN and PET/PEN copolymers.

Certain materials may be applied as part of a top coat or layer that provides chemical resistance such as to hot water, steam, caustic or acidic materials. In certain embodiments, these top coats or layers are aqueous based or non-aqueous based polyesters, acrylics, EAA, polyolefins, and blends thereof which are optionally partially or fully cross linked. Preferred aqueous based polyesters include polyethylene terephthalate and sulfonated polyesters, however other polyesters may also be used.

Additives to Enhance Coating Materials

Preferred additives may be prepared by methods known to those of skill in the art. For example, the additives may be mixed directly with a particular material. In addition, in some embodiments, preferred additives may be used alone as a single layer or as part of a single layer.

In preferred embodiments, the barrier properties of a layer may be enhanced by the use of additives. Additives are preferably present in an amount up to about 40% of the material, also including up to about 30%, 20%, 10%, 5%, 2% and 1% by weight of the material. In other embodiments, additives are preferably present in an amount less than or equal to 1% by weight, preferred ranges of materials include, but are not limited to, about 0.01% to about 1%, about 0.01% to about 0.1%, and about 0.1% to about 1% by weight. In some embodiments additives are preferably stable in aqueous conditions.

Derivatives of resorcinol (m-dihydroxybenzene) may be used in conjunction with various preferred materials as blends or as additives or monomers in the formation of the material. The higher the resorcinol content the greater the barrier properties of the material. For example, resorcinol diglycidyl ether can be used in PHAE and hydroxyethyl ether resorcinol can be used in PET and other polyesters and Copolyester Barrier Materials.

Another type of additive that may be used are “nanoparticles” or “nanoparticulate material.” For convenience the term nanoparticles will be used herein to refer to both nanoparticles and nanoparticulate material. These nanoparticles are tiny, micron or sub-micron size (diameter), particles of materials including inorganic materials such as clay, ceramics, zeolites, elements, metals and metal compounds such as aluminum, aluminum oxide, iron oxide, and silica, which enhance the barrier properties of a material usually by creating a more tortuous path for migrating gas molecules, e.g. oxygen or carbon dioxide, to take as they permeate a material. In preferred embodiments nanoparticulate material is present in amounts ranging from 0.05 to 1% by weight, including 0.1%, 0.5% by weight and ranges encompassing these amounts.

One preferred type of nanoparticulate material is a microparticular clay based product available from Southern Clay Products. One preferred line of products available from Southern Clay products is Cloisite® nanoparticles. In one embodiment preferred nanoparticles comprise monmorillonite modified with a quaternary ammonium salt. In other embodiments nanoparticles comprise monmorillonite modified with a ternary ammonium salt. In other embodiments nanoparticles comprise natural monmorillonite. In further embodiments, nanoparticles comprise organoclays as described in U.S. Pat. No. 5,780,376, the entire disclosure of which is hereby incorporated by reference and forms part of the disclosure of this application. Other suitable organic and inorganic microparticular clay based products may also be used. Both man-made and natural products are also suitable.

Another type of preferred nanoparticulate material comprises a composite material of a metal. For example, one suitable composite is a water based dispersion of aluminum oxide in nanoparticulate form available from BYK Chemie (Germany). It is believed that this type of nanoparticular material may provide one or more of the following advantages: increased abrasion resistance, increased scratch resistance, increased Tg, and thermal stability.

Another type of preferred nanoparticulate material comprises a polymer-silicate composite. In preferred embodiments the silicate comprises montmorillonite. Suitable polymer-silicate nanoparticulate material are available from Nanocor and RTP Company. Other preferred nanoparticle materials include fumed silica, such as Cab-O-Sil.

In preferred embodiments, the UV protection properties of the material may be enhanced by the addition of different additives. In a preferred embodiment, the UV protection material used provides UV protection up to about 350 nm or lower, including about 370 nm or lower, and about 400 nm or lower. The UV protection material may be used as an additive with layers providing additional functionality or applied separately from other functional materials or additives in one or more layers. Preferably additives providing enhanced UV protection are present in the material from about 0.05 to 20% by weight, but also including about 0.1%, 0.5%, 1%, 2%, 3%, 5%, 10%, and 15% by weight, and ranges encompassing these amounts. Preferably the UV protection material is added in a form that is compatible with the other materials. In other embodiments, a preferred UV protection material comprises a polymer grafted or modified with a UV absorber that is added as a concentrate. Other preferred UV protection materials include, but are not limited to, benzotriazoles, phenothiazines, and azaphenothiazines. UV protection materials may be added during the melt phase process prior to use, e.g. prior to injection molding extrusion, or palletizing, or added directly to a coating material that is in the form of a solution or dispersion. Suitable UV protection materials include those available from Milliken, Ciba and Clariant.

Carbon dioxide (CO2) scavenging properties can be added to one or more materials and/or layers. In one preferred embodiment such properties are achieved by including one or more scavengers, such as an active amine reacts with CO2 to form a high gas barrier salt. This salt then acts as a passive CO2 barrier. The active amine may be an additive or it may be one or more moieties in the resin material of one or more layers. Suitable carbon dioxide scavenger materials other than amines may also be used.

Oxygen (O2) scavenging properties can be added to preferred materials by including one or more O2 scavengers such as anthroquinone and others known in the art. In another embodiment, one suitable O2 scavenger is AMOSORB® O2 scavenger available from BP Amoco Corporation and ColorMatrix Corporation which is disclosed in U.S. Pat. No. 6,083,585 to Cahill et al., the disclosure of which is hereby incorporated in its entirety. In one embodiment, O2 scavenging properties are added to preferred phenoxy-type materials, or other materials, by including O2 scavengers in the phenoxy-type material, with different activating mechanisms. Preferred O2 scavengers can act spontaneously, gradually or with delayed action, e.g. not acting until being initiated by a specific trigger. In some embodiments the O2 scavengers are activated via exposure to either UV or water (e.g., present in the contents of the container), or a combination of both. The O2 scavenger, when present, is preferably present in an amount of from about 0.1 to about 20 percent by weight, more preferably in an amount of from about 0.5 to about 10 percent by weight, and, most preferably, in an amount of from about 1 to about 5 percent by weight, based on the total weight of the material forming the layer.

The materials of certain embodiments may be cross-linked to enhance thermal stability for various applications, for example hot fill applications. In one embodiment, one or more layers may comprise low-cross linking materials while outer layers may comprise high crosslinking materials or other suitable combinations. Suitable additives capable of cross linking may be added to one or more layers. Suitable cross linkers can be chosen depending upon the chemistry and functionality of the resin or material to which they are added. For example, amine cross linkers may be useful for crosslinking resins comprising epoxide groups. Preferably cross linking additives, if present, are present in an amount of about 1% to 10% by weight, preferably about 1% to 5%, more preferably about 0.01% to 0.1% by weight, also including 2%, 3%, 4%, 6%, 7%, 8%, and 9% by weight. Optionally, a thermoplastic epoxy (TPE) can be used with one or more crosslinking agents. In some embodiments, agents (e.g. carbon black) may also incorporated into a layer material, including TPE material. The TPE material can form part of the articles disclosed herein. It is contemplated that carbon black or similar additives can be employed in other polymers to enhance material properties.

The materials of certain embodiments may optionally comprise a curing enhancer. As used herein, the term “curing enhancer” is a broad term and is used in its ordinary meaning and includes, without limitation, chemical cross-linking catalyst, thermal enhancer, and the like. As used herein, the term “thermal enhancer” is a broad term and is used in its ordinary meaning and includes, without limitation, materials that, when included in a polymer layer, increase the rate at which that polymer layer absorbs thermal energy and/or increases in temperature as compared to a layer without the thermal enhancer. Preferred thermal enhancers include, but are not limited to, transition metals, transition metal compounds, radiation absorbing additives (e.g., carbon black). Suitable transition metals include, but are not limited to, cobalt, rhodium, and copper. Suitable transition metal compounds include, but are not limited to, metal carboxylates. Preferred carboxylates include, but are not limited to, neodecanoate, octoate, and acetate. Thermal enhancers may be used alone or in combination with one or more other thermal enhancers.

The thermal enhancer can be added to a material and may significantly increase the temperature of the material that can be achieved during a given curing process, as compared to the material without the thermal enhancer. For example, in some embodiments, the thermal enhancer (e.g., carbon black) can be added to a polymer so that the rate of heating or final temperature of the polymer subjected to a heating or curing process (e.g., IR radiation) is significantly greater than the polymer without the thermal enhancer when subjected to the same or similar process. The increased heating rate of the polymer caused by the thermal enhancer can increase the rate of curing or drying and therefore increase production rates because less time is required for the process.

In some embodiments, the thermal enhancer is present in an amount of about 5 to 800 ppm, preferably about 20 to about 150 ppm, preferably about 50 to 125 ppm, preferably about 75 to 100 ppm, also including about 10, 20, 30, 40, 50, 75, 100, 125, 150, 175, 200, 300, 400, 500, 600, and 700 ppm and ranges encompassing these amounts. The amount of thermal enhancer may be calculated based on the weight of layer which comprises the thermal enhancer or the total weight of all layers comprising the article.

In some embodiments, a preferred thermal enhancer comprises carbon black. In one embodiment, carbon black can be applied as a component of a coating material in order to enhance the curing of a material. In another embodiment carbon black may be added to the polymer blend in the melt phase process prior to extruding.

In another embodiment foaming agents may be added to the coating materials in order to foam the coating layer. In a further embodiment a reaction product of a foaming agent is used. Useful foaming agents include, but are not limited to azobisformamide, azobisisobutyronitrile, diazoaminobenzene, N,N-dimethyl-N,N-dinitroso terephthalamide, N,N-dinitrosopentamethylene-tetramine, benzenesulfonyl-hydrazide, benzene-1,3-disulfonyl hydrazide, diphenylsulfon-3-3, disulfonyl hydrazide, 4,4′-oxybis benzene sulfonyl hydrazide, p-toluene sulfonyl semicarbizide, barium azodicarboxylate, butylamine nitrile, nitroureas, trihydrazino triazine, phenyl-methyl-urethane, p-sulfonhydrazide, peroxides, ammonium bicarbonate, and sodium bicarbonate. As presently contemplated, commercially available foaming agents include, but are not limited to, EXPANCEL®, CELOGEN®, HYDROCEROL®, MIKROFINE®, CEL-SPAN®, and PLASTRON® FOAM. Foaming agents and foamed layers are described in greater detail below.

The foaming agent is preferably present in the material in an amount from about 1 up to about 20 percent by weight, more preferably from about 1 to about 10 percent by weight, and, most preferably, from about 1 to about 5 percent by weight. Newer foaming technologies known to those of skill in the art using compressed gas could also be used as an alternate means to generate foam in place of conventional blowing agents listed above.

In one embodiment, a cup comprises a water barrier material, that is a material that imparts a barrier to water vapor, exhibits water repellency and/or exhibits chemical resistance to hot water. Optionally, additives such as those to increase lubricity and abrasion resistance are also included. Such materials may be applied by dip, flow, or spray coating.

Suitable materials for water barrier layers include ethylene-acrylic acid copolymers, polyolefins, polyethylene, blends of polyethylene/polypropylene/other polyolefins with EAA, urethane polymer, epoxy polymer, and paraffins. Other suitable materials include those disclosed in U.S. Pat. No. 6,429,240, which is hereby incorporated by reference in its entirety. Among polyolefins, one preferred class is low molecular weight polyolefins, preferably using metallocene technology which can facilitate tailoring a material to desired properties as is known in the art. For example, the metallocene technology can be used to fine-tune the material to improve the handling, achieve desired melting temperature or other melting behaviour, achieve a desired viscosity, achieve a particular molecular weight or molecular weight distribution (e.g. Mw, Mn) and/or improve the compatibility with other polymers. An example of suitable materials is the LICOCENE range of polymers manufactured by Clariant. The range includes olefin waxes such as polyethylene, polypropylene and PE/PP waxes available from Clariant under the tradenames LICOWAX, LICOLUB and LICOMONT. More information available at www.clariant.com. Other materials include grafted or modified polymers, including polyolefins such as polypropylene, where the grafting or modification includes polar compounds such as maleic anhydride, glycidyl methacrylate, acryl methacrylate and/or similar compounds. Such grafted or modified polymers alter the properties of the materials and can, for example, enable better adhesion to both polyolefins such as polypropylene and/or PET or other polyesters. Materials are preferably those approved by the FDA for direct food contact, but such approval is not necessary.

In polyethylene/EAA blends, generally speaking, the higher the polyethylene content the better the resultant water resistance, but the lower the EAA content the poorer the adhesion. Similar trade-offs may occur with other blends comprising one or more of the materials listed above. Accordingly, the percentage of each component in a blend are chosen to maximize whichever characteristics are deemed more important in a given application and given the other materials used in the article.

The coating is preferably applied in a liquid form. The liquid may be a solution, dispersion or emulsion, or a melt. In one embodiment, the material is applied as a melt. The melt may comprise one or more materials as described above and elsewhere herein, and may also comprise one or more additives, including functional additives, such as are described elsewhere herein. The temperature of the melt during application depends upon the melt temperature of the one or more components, and may also depend upon one or more other characteristics such as the viscosity, additives, mode of application, and the like. One should also consider the melt temperature and Tg of the substrate materials prior to selecting an application temperature for a melt coating. In one embodiment, the hot melt material is heated to about 120-150° C. and applied to a container by dip or flow coating, or spray coating, followed by cooling to solidify the coating. One advantage to the melt coating is that it allows for a water repellent or resistant coating to be applied without exposing the substrate or other coating layer(s) to water. One preferred material for hot melt dip or flow coating is low molecular weight polyester, such as polypropylene.

In other embodiments, water and/or water vapor-resistant material is applied in the form of a melt or an aqueous or solvent based solution or dispersion, preferably exhibiting low VOCs. Additives to a coating layer may include silicone based lubricants, waxes, paraffins, thermal enhancers, UV absorbers and adhesion promoters. The application is preferably effected by dip, spray or flow coating on to a preform or article such as a container, followed by drying and curing, preferably with IR, other radiation, blown air or other suitable means. In one embodiment, the outer surface of the article is suitable for printing directly thereon with any desired graphic design, such as by using inks and pigments including those suitable for use in the food and beverage packaging arts.

Preferred Foam Materials

In some embodiments, a foam material may be used in a substrate (base article or preform) or in a coating layer. As used herein, the term “foam material” is a broad term and is used in accordance with its ordinary meaning and may include, without limitation, a foaming agent, a mixture of foaming agent and a binder or carrier material, an expandable cellular material, and/or a material having voids. The terms “foam material” and “expandable material” are used interchangeably herein. Preferred foam materials may exhibit one or more physical characteristics that improve the thermal and/or structural characteristics of articles (e.g., containers) and may enable the preferred embodiments to be able to withstand processing and physical stresses typically experienced by containers. In one embodiment, the foam material provides structural support to the container. In another embodiment, the foam material forms a protective layer that can reduce damage to the container during processing. For example, the foam material can provide abrasion resistance which can reduce damage to the container during transport. In one embodiment, a protective layer of foam may increase the shock or impact resistance of the container and thus prevent or reduce breakage of the container. Furthermore, in another embodiment foam can provide a comfortable gripping surface and/or enhance the aesthetics or appeal of the container.

In one embodiment, foam material comprises a foaming or blowing agent and a carrier material. In one preferred embodiment, the foaming agent comprises expandable structures (e.g., microspheres) that can be expanded and cooperate with the carrier material to produce foam. For example, the foaming agent can be thermoplastic microspheres, such as EXPANCEL® microspheres sold by Akzo Nobel. In one embodiment, microspheres can be thermoplastic hollow spheres comprising thermoplastic shells that encapsulate gas. Preferably, when the microspheres are heated, the thermoplastic shell softens and the gas increases its pressure causing the expansion of the microspheres from an initial position to an expanded position. The expanded microspheres and at least a portion of the carrier material can form the foam portion of the articles described herein. The foam material can form a layer that comprises a single material (e.g., a generally homogenous mixture of the foaming agent and the carrier material), a mix or blend of materials, a matrix formed of two or more materials, two or more layers, or a plurality of microlayers (lamellae) preferably including at least two different materials. Alternatively, the microspheres can be any other suitable controllably expandable material. For example, the microspheres can be structures comprising materials that can produce gas within or from the structures. In one embodiment, the microspheres are hollow structures containing chemicals which produce or contain gas wherein an increase in gas pressure causes the structures to expand and/or burst. In another embodiment, the microspheres are structures made from and/or containing one or more materials which decompose or react to produce gas thereby expanding and/or bursting the microspheres. Optionally, the microsphere may be generally solid structures. Optionally, the microspheres can be shells filled with solids, liquids, and/or gases. The microspheres can have any configuration and shape suitable for forming foam. For example, the microspheres can be generally spherical. Optionally, the microspheres can be elongated or oblique spheroids. Optionally, the microspheres can comprise any gas or blends of gases suitable for expanding the microspheres. In one embodiment, the gas can comprise an inert gas, such as nitrogen. In one embodiment, the gas is generally non-flammable. However, in certain embodiments non-inert gas and/or flammable gas can fill the shells of the microspheres. In some embodiments, the foam material may comprise foaming or blowing agents as are known in the art. Additionally, the foam material may be mostly or entirely foaming agent.

Although some preferred embodiments contain microspheres that generally do not break or burst, other embodiments comprise microspheres that may break, burst, fracture, and/or the like. Optionally, a portion of the microspheres may break while the remaining portion of the microspheres do not break. In some embodiments up to about 0.5%, 1%, 2%, 3%, 4%, 5%, 10%, 20%, 30%, 40%, 50%, 60% 70%, 80%, 90% by weight of microspheres, and ranges encompassing these amounts, break. In one embodiment, for example, a substantial portion of the microspheres may burst and/or fracture when they are expanded. Additionally, various blends and mixtures of microspheres can be used to form foam material.

The microspheres can be formed of any material suitable for causing expansion. In one embodiment, the microspheres can have a shell comprising a polymer, resin, thermoplastic, thermoset, or the like as described herein. The microsphere shell may comprise a single material or a blend of two or more different materials. For example, the microspheres can have an outer shell comprising ethylene vinyl acetate (“EVA”), polyethylene terephthalate (“PET”), polyamides (e.g. Nylon 6 and Nylon 66) polyethylene terephthalate glycol (PETG), PEN, PET copolymers, and combinations thereof. In one embodiment a PET copolymer comprises CHDM comonomer at a level between what is commonly called PETG and PET. In another embodiment, comonomers such as DEG and IPA are added to PET to form miscrosphere shells. The appropriate combination of material type, size, and inner gas can be selected to achieve the desired expansion of the microspheres. In one embodiment, the microspheres comprise shells formed of a high temperature material (e.g., PETG or similar material) that is capable of expanding when subject to high temperatures, preferably without causing the microspheres to burst. If the microspheres have a shell made of low temperature material (e.g., as EVA), the microspheres may break when subjected to high temperatures that are suitable for processing certain carrier materials (e.g., PET or polypropylene having a high melt point). In some circumstances, for example, EXPANCEL® microspheres may be break when processed at relatively high temperatures. Advantageously, mid or high temperature microspheres can be used with a carrier material having a relatively high melt point to produce controllably, expandable foam material without breaking the microspheres. For example, microspheres can comprise a mid temperature material (e.g., PETG) or a high temperature material (e.g., acrylonitrile) and may be suitable for relatively high temperature applications. Thus, a blowing agent for foaming polymers can be selected based on the processing temperatures employed.

The foam material can be a matrix comprising a carrier material, preferably a material that can be mixed with a blowing agent (e.g., microspheres) to form an expandable material. The carrier material can be a thermoplastic, thermoset, or polymeric material, such as ethylene acrylic acid (“EAA”), ethylene vinyl acetate (“EVA”), linear low density polyethylene (“LLDPE”), polyethylene terephthalate glycol (PETG), poly(hydroxyamino ethers) (“PHAE”), PET, polyethylene, polypropylene, polystyrene (“PS”), pulp (e.g., wood or paper pulp of fibers, or pulp mixed with one or more polymers), mixtures thereof, and the like. However, other materials suitable for carrying the foaming agent can be used to achieve one or more of the desired thermal, structural, optical, and/or other characteristics of the foam. In some embodiments, the carrier material has properties (e.g., a high melt index) for easier and rapid expansion of the microspheres, thus reducing cycle time thereby resulting in increased production.

In preferred embodiments, the formable material may comprise two or more components including a plurality of components each having different processing windows and/or physical properties. The components can be combined such that the formable material has one or more desired characteristics. The proportion of components can be varied to produce a desired processing window and/or physical properties. For example, the first material may have a processing window that is similar to or different than the processing window of the second material. The processing window may be based on, for example, pressure, temperature, viscosity, or the like. Thus, components of the formable material can be mixed to achieve a desired, for example, pressure or temperature range for shaping the material.

In one embodiment, the combination of a first material and a second material may result in a material having a processing window that is more desirable than the processing window of the second material. For example, the first material may be suitable for processing over a wide range of temperatures, and the second material may be suitable for processing over a narrow range of temperatures. A material having a portion formed of the first material and another portion formed of the second material may be suitable for processing over a range of temperatures that is wider than the narrow range of processing temperatures of the second material. In one embodiment, the processing window of a multi-component material is similar to the processing window of the first material. In one embodiment, the formable material comprises a multilayer sheet or tube comprising a layer comprising PET and a layer comprising polypropylene. The material formed from both PET and polypropylene can be processed (e.g., extruded) within a wide temperature range similar to the processing temperature range suitable for PET. The processing window may be for one or more parameters, such as pressure, temperature, viscosity, and/or the like.

Optionally, the amount of each component of the material can be varied to achieve the desired processing window. Optionally, the materials can be combined to produce a formable material suitable for processing over a desired range of pressure, temperature, viscosity, and/or the like. For example, the proportion of the material having a more desirable processing window can be increased and the proportion of material having a less undesirable processing window can be decreased to result in a material having a processing window that is very similar to or is substantially the same as the processing window of the first material. Of course, if the more desired processing window is between a first processing window of a first material and the second processing window of a second material, the proportion of the first and the second material can be chosen to achieve a desired processing window of the formable material.

Optionally, a plurality of materials each having similar or different processing windows can be combined to obtain a desired processing window for the resultant material.

In one embodiment, the Theological characteristics of a formable material can be altered by varying one or more of its components having different Theological characteristics. For example, a substrate (e.g., PP) may have a high melt strength and is amenable to extrusion. PP can be combined with another material, such as PET which has a low melt strength making it difficult to extrude, to form a material suitable for extrusion processes. For example, a layer of PP or other strong material may support a layer of PET during co-extrusion (e.g., horizontal or vertical co-extrusion). Thus, formable material formed of PET and polypropylene can be processed, e.g., extruded, in a temperature range generally suitable for PP and not generally suitable for PET.

In some embodiments, the composition of the formable material may be selected to affect one or more properties of the articles. For example, the thermal properties, structural properties, barrier properties, optical properties, Theological properties, favorable flavor properties, and/or other properties or characteristics disclosed herein can be obtained by using formable materials described herein.

The various methods and techniques described above provide a number of ways to carry out the invention. Of course, it is to be understood that not necessarily all objectives or advantages described may be achieved in accordance with any particular embodiment described herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A mold apparatus configured to thermoform a cup, the apparatus comprising:
a mold section having at least one mold surface, the mold surface defining a cavity, the mold section comprising at least one cavity fluid channel in fluid communication with the cavity; and
a mandrel having a longitudinal axis and an exterior surface, the mandrel being configured to be moved at least partially within the cavity of the mold section along the longitudinal axis, the mandrel comprising:
an outer casing forming at least a portion of the exterior surface of the mandrel, the outer casing comprising at least one mandrel fluid channel and a groove, the groove being in fluid communication with the mandrel fluid channel and extending to the exterior surface of the mandrel, wherein the outer casing is configured to be selectively extended to a first distance within the cavity; and
a mandrel rod being positioned at least partially within the outer casing and being selectively movable relative to the outer casing in a direction generally parallel to the longitudinal axis, the mandrel rod being configured to be selectively extended to a second distance within the cavity, the second distance being greater than the first distance;
wherein the mandrel rod is configured to urge a sheet positioned generally over the mold section at least partially into the cavity;
wherein the cavity fluid channel is configured to be selectively placed in fluid communication with a vacuum source; and
wherein the groove is configured to be selectively placed in fluid communication with a vacuum source and a fluid supply source.

2. The apparatus of claim 1, wherein the mold surface comprises at least one depression extending outwardly away from the cavity and being configured to produce a corresponding coupling structure on a thermoformed sheet.

3. The apparatus of claim 1, wherein the mold surface comprises at least one projection extending inwardly toward the cavity and being configured to produce a corresponding coupling structure on a thermoformed sheet.

4. The apparatus of claim 3, wherein the projection comprises an annular ring.

5. The apparatus of claim 1, wherein at least one of the mold section and the mandrel comprises a high heat transfer material.

6. The apparatus of claim 1, wherein the outer casing of the mandrel comprises at least one depression extending inwardly toward the mandrel rod, the depression being configured to produce a corresponding coupling structure on a thermoformed sheet.

7. The apparatus of claim 1, wherein the mandrel comprises a cutting ring, the cutting ring comprising a cutting member and being configured to facilitate the removal of a thermoformed sheet from the mandrel.

8. The apparatus of claim 7, wherein the cutting ring extends generally around a perimeter of the mandrel.

9. A mold apparatus configured to thermoform a sheet into a cup shape, the apparatus comprising:
a mold section comprising at least one mold surface, the mold surface defining a cavity, the mold section comprising at least one cavity fluid channel in fluid communication with the cavity; and
a mandrel having a longitudinal axis and an exterior surface, the mandrel being configured to move at least partially within the cavity of the mold section along the longitudinal axis, the mandrel comprising at least one mandrel fluid channel and a groove, the groove being in fluid communication with the mandrel fluid channel and extending to the exterior surface of the mandrel;
wherein the mandrel comprises at least one depression extending inwardly away from the exterior surface of the mandrel, the depression being configured to produce a corresponding coupling structure on a thermoformed sheet; and
wherein the cavity fluid channel is configured to be selectively placed in fluid communication with a vacuum source, and the groove is configured to be selectively placed in fluid communication with a vacuum source and a fluid supply source.

10. The apparatus of claim 9, wherein at least one of the mold section and the mandrel comprises a high heat transfer material.

11. The apparatus of claim 9, wherein the mandrel further comprises a cutting ring, the cutting ring configured to facilitate the removal of a thermoformed sheet from the mandrel.

12. The apparatus of claim 10, wherein the cutting ring extends generally around a perimeter of the mandrel.

13. The apparatus of claim 12, wherein the cavity of the mold section comprises a generally cylindrical shape.

14. The apparatus of claim 12, wherein the mold surface is configured to produce a draft angle in a thermoformed cup thermoformed using the mold apparatus.

15. The apparatus of claim 12, wherein at least one of the mold section and the mandrel comprises lightweight aluminum.

16. The apparatus of claim 12, further comprising a heating device, the heating device being configured to heat a sheet before it is thermoformed.

17. The apparatus of claim 12, wherein at least one of the mold section and the mandrel comprises a hardened material configured to reduce wear along a friction surface.

18. The apparatus of claim 12, wherein at least one of the mold section and the mandrel comprises a cooling channel, the cooling channel being configured to receive a fluid to transfer heat away from a thermoformed sheet.

19. The apparatus of claim 12, wherein the mold section comprises a split mold design.

20. A method of thermoforming a sheet into a cup shape, the method comprising:
providing a mold section having at least one mold cavity, the mold cavity comprising a mold surface, the mold section comprising a plurality of cavity fluid channels in fluid communication with the mold cavity;
providing a mandrel having a longitudinal axis and an exterior surface, the mandrel being configured to be moved at least partially within the mold cavity in a direction generally parallel with the longitudinal axis, the mandrel comprising:
an outer casing forming at least a portion of the exterior surface of the mandrel, the outer casing comprising at least one mandrel fluid channel and a groove, the groove being in fluid communication with the mandrel fluid channel and extending to the exterior surface of the mandrel; and
a mandrel rod being positioned at least partially within the outer casing and being selectively movable relative to the outer casing in a direction generally parallel with the longitudinal axis;
positioning a sheet configured to be thermoformed over the mold section;
moving the mandrel rod toward the mold section to urge the sheet at least partially into the mold cavity;
producing a vacuum in the cavity fluid channels to draw the sheet toward the mold surface;
retracting the mandrel rod away from the mold section;
moving the outer casing at least partially within the mold cavity;
producing a vacuum in the groove of the outer casing to draw the thermoformed sheet at least partially toward the exterior surface of the mandrel; and
retracing the mandrel casing and the thermoformed sheet positioned thereon away from the mold section.

21. The method of claim 20, further comprising forming at least one coupling structure in the thermoformed sheet.

22. The method of claim 21, wherein forming the coupling structure comprises using a corresponding projection or depression in the mold surface of the mold section.

23. The method of claim 21, wherein forming the coupling structure comprises using a corresponding projection or depression in the exterior surface of the madrel.

24. The method of claim 20, further comprising delivering a volume of fluid through the cavity fluid channels prior to moving the mandrel rod toward the mold section, the volume of fluid configured to pre-stretch the sheet.

25. The method of claim 20, further comprising removing the thermoformed sheet from the mandrel after retracing the mandrel casing from the mold section.

26. The method of claim 25, wherein removing the thermoformed sheet from the mandrel comprises providing a volume of fluid through the fluid channel and the groove towards the thermoformed sheet positioned around the outer casing.

27. The method of claim 25, wherein removing the thermoformed sheet from the mandrel comprises moving the mandrel rod relative to the outer casing to urge the thermoformed sheet away from the outer casing.

28. The method of claim 20, further comprising heating the sheet prior to moving the mandrel rod toward the mold section.

29. The method of claim 20, further comprising cooling the thermoformed sheet.

30. The method of claim 29, wherein cooling the thermoformed sheet comprises providing at least one cooling channel in at least one of the mold section and the mandrel.

31. The method of claim 20, wherein at least one of the mold section and the mandrel comprises a high heat transfer material.

32. A container for storing a beverage, the container comprising:
a cup portion comprising:
a cup bottom;
a sidewall having an upper portion ending at a top edge, the top edge defining an opening to an interior of the cup portion; and
at least one coupling structure positioned along the upper portion of the sidewall;
wherein, the cup portion comprises a polymeric material; and
a closure portion comprising:
a lower closure portion configured to engage the coupling structure of the cup portion in order to secure the closure portion to the cup portion; and
an upper closure portion comprising at least one movable section, the movable section configured to selectively expose and hide an aperture;
wherein the aperture provides access to the interior of the cup portion.

33. The container of claim 32, wherein the container further comprises a removable seal member being positioned underneath the aperture, the seal member being a fluid barrier which prevents fluid communication between the aperture and the interior of the cup portion.

34. The container of claim 33, wherein the seal member is a membrane, the membrane being configured to be compromised in order to place the aperture in fluid communication with the interior of the cup portion.

35. The container of claim 34, wherein the seal member is adhered to the top edge of the sidewall.

36. The container of claim 32, wherein the cup portion is manufactured using a thermoforming process.

37. The container of claim 32, wherein the cup portion comprises polyethylene terephthalate (PET).

38. The container of claim 32, wherein the cup portion comprises at least two layers.

39. The container of claim 32, wherein the coupling structure comprises a positive feature which projects outwardly from the sidewall.

40. The container of claim 32, wherein the coupling structure comprises a negative feature which projects inwardly from the sidewall, toward the interior of the cup portion.

41. The container of claim 32, wherein the coupling structure is configured to selectively attach to and detach from the cup portion using a snap connection.

42. The container of claim 32, wherein the coupling structure is fixedly attached to the cup portion.

43. The container of claim 32, wherein the lower closure portion and the upper closure portion are a unitary member.

44. The container of claim 32, wherein the movable section is selected from a group consisting of caps, snap closures, removable film seals, spout tops, lids and multi-piece closures.

45. The container of claim 32, wherein the closure member further comprises a cover, the cover being configured to be selectively positioned over the upper closure portion.

46. The container of claim 45, wherein the cover is hingedly attached to the closure member.

47. The container of claim 32, wherein the container is generally air-tight.

48. The container of claim 32, wherein the cup portion comprises a generally cylindrical shape.

49. The container of claim 32, wherein the cup portion comprises a draft angle.

50. The container of claim 32, wherein the cup portion is manufactured using an extrusion blow molding process.

51. The container of claim 32, wherein the cup portion is manufactured using stretch blow molding process.

52. The container of claim 32, wherein the cup portion is manufactured using an injection stretch blow molding process.
